(19) United States
(12) Patent Application Publication
(10) Pub. No.: US 2006/0065989 A1
(43) Pub. Date: Mar. 30, 2006

(54) Lens forming systems and methods

(76) Inventors: Thad Druffel, Louisville, KY (US); Xiaodong Sun, Louisville, KY (US); Kevin Krogman, Cambridge, MA (US); Mahendra Sunkara, Louisville, KY (US); Matthew C. Lattis, Louisville, KY (US); John T. Foreman, Delaware, OH (US); Omar M. Buazza, Louisville, KY (US); Loren C. Lossman, Louisville, KY (US); Galen Powers, Louisville, KY (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/203,422

(22) Filed: Aug. 12, 2005

Related U.S. Application Data
(60) Provisional application No. 60/614,446, filed on Sep. 29, 2004.
(60) Provisional application No. 60/653,892, filed on Feb. 17, 2005.

(51) Int. Cl. B29D 11/00

(52) U.S. Cl. 264/1.32; 264/1.7

(57) ABSTRACT

Described herein are methods and systems for forming lenses. In one embodiment, systems for use in forming eyeglass lenses are described that include one or more LED lights. The LED lights may be used to cure lens forming compositions and coating compositions. In other embodiments, methods of determining an appropriate spacing for mold members are described. In other embodiments, methods of forming anti-reflective coatings, photochromic coatings, hardcoat coatings, and combinations thereof, on eyeglass lenses, are described.

### PRIORITY CLAIM

This patent application claims priority to U.S. Provisional Patent Application No. 60/600,063 entitled “In-Mold Photochromic Coatings”; U.S. Provisional Patent Application No. 60/614,446 entitled “Anti-Reflective Optical Coatings Incorporating Nanoparticles”, and U.S. Provisional Patent Application No. 60/653,892 entitled “Lens Forming Systems and Methods”.

### BACKGROUND OF THE INVENTION

1. Field of the Invention

The present invention relates generally to eyeglass lenses. More particularly, the invention relates to systems and methods for preparing eyeglass lenses.

2. Description of the Relevant Art

The traditional manufacturing and distribution chain for a lens used in consumer eyeglasses generally includes a lens manufacturer, an optical laboratory, and a retail outlet. The lens manufacturer may make a semi-finished lens blank and then ship the blank to the optical laboratory. The laboratory may then grind and polish, e.g., surface, the concave surface of the semi-finished lens in the appropriate fashion to form a lens with a desired eyeglass lens prescription and then ship the lens to the retail outlet. The retail outlet may then cut and fit the lens to the appropriate frame. The retail outlet is generally a doctor or an eye care outlet. The retail outlet may both order the lens from the laboratory or the manufacturer and then fit the lens and the frame as appropriate for the consumer.

Any of the parties in the manufacturing and distribution chain may stockpile certain types of lenses. Certain common prescriptions may be manufactured in bulk and kept in supply; these are typically referred to as stock lenses.

In most cases, these stock lenses are single vision lenses, i.e., lenses with only one viewing power. In the case of polymeric stock lenses, they may be cast or molded using mold assemblies where the curvatures of the molds used will create a lens of the desired prescription power. Other types of prescriptions, however, may not be as common and may be made using a different production process, e.g. a surfacing process. In a surfacing process, a semi-finished lens blank may have at least one surface, usually the concave surface, ground and polished to a desired curvature to provide a lens with the desired prescription power. Such surfaced lenses may include either single vision and/or multifocal lenses, e.g. flattop lenses and progressive addition lenses. These surfaced lenses generally are more expensive in that such a manufacturing process is both time and labor intensive.

The above-described multifocal lenses tend to be difficult to inventory because of the very large number of permutations of lens prescriptions possible. This is particularly due to the large number of permutations necessary to cover different degrees of astigmatism. The large numbers of permutations is due to the need to correct for combinations of: various degrees of astigmatism correction; various degrees of corrections for nearsightedness and farsightedness; various degrees of correction for presbyopia; and various multifocal types and designs. Further, astigmatism requires the proper orientation of a toric curve on the back of the lens relative to the multifocal lenses' front surface topography thereby increasing the number of permutations. Because of the large number of lens prescriptions possible, it is not practical to maintain an inventory of all possible multi-focal lenses. Multi-focal lenses, therefore, are generally produced by grinding and polishing a semi-finished blank on an as-needed basis.

It may be possible to cast or mold multifocal lenses, as well as single vision lenses, from monomers and/or polymers directly to the desired prescription by forming a mold assembly composed of mold members of the proper curvatures by assembling the mold members with an appropriate gasket. The mold assembly is then filled with the appropriate lens curing composition and cured. In recent years, the development of rapid radiation curing systems has made casting both single vision and multifocal lenses directly to a desired prescription commercially feasible.

In addition to having the ability to provide the large number of prescriptions requested by the consumers, most retail outlets for eyeglass lenses also offer many enhanced eyeglass lenses. Enhancements to lenses include features such as anti-scratch or hardcoatings, anti-reflective coatings, and photochromic eyeglass lenses. In order to offer these services, many retail outlets may require the assistance of multiple suppliers and/or lens manufacturers. This may cause a substantial increase in the time and cost for producing an eyeglass lens for a consumer. To minimize time and cost for consumers, it would be desirable to produce enhanced lenses in a more efficient and cost effective manner.

### SUMMARY

In an embodiment, an apparatus for making an eyeglass lens may use a mold assembly for curing a lens forming composition with activating light, heat or both activating light and heat. A mold assembly may include a first mold member having a casting face and a non-casting face and a second mold member having a casting face and a non-casting face. The first and second mold members may be coupled together in a spaced apart arrangement during use such that the casting faces of the first mold member and the second mold member at least partially define a mold cavity for holding a lens forming composition. A plurality of light emitting diodes may be arranged to direct activating light toward the mold cavity of the mold assembly. The apparatus may also include one or more other sources of activating light in addition to the plurality of light emitting diodes. A controller may be coupled to the apparatus. The controller may be configured to independently control two or more light emitting diodes of the plurality of light emitting diodes and/or one more other light sources.

The controller may be configured to control one or more of the light emitting diodes to generate one or more pulses of activating light and/or one or more patterns of activating light. The light emitting diodes may also be configured to produce activating light continuously. A light sensor may measure the intensity of activating light directed toward the mold assembly and/or the mold cavity by the plurality of light emitting diodes. The light sensor may provide feedback to the controller.

In certain embodiments, an apparatus for coating an eyeglass lens or a mold member may include a plurality of light emitting diodes. For example, such an apparatus may include a substrate holder, a dispenser for applying a coating material to a substrate (e.g., an eyeglass lens or a mold member) positioned on the holder; and a plurality of light emitting diodes configured to direct activating light towards the coating material on the substrate during use. The holder may be configured to rotate during use. The coating apparatus may also include an air distribution system for passing air over at least the plurality of light emitting diodes during use. The light emitting diodes may be arranged, configured, controlled, etc. as previously described. The coating apparatus (or a controller coupled to the coating apparatus) may be configured to receive input from an operator, and to determine one or more operating parameters of the coating apparatus based on the received input.

In an embodiment, a method of forming an eyeglass lens may include providing a curable lens forming composition disposed in a mold cavity of a mold assembly, providing a plurality of light emitting diodes; and directing activating light toward the mold cavity using one or more light emitting diodes of the plurality of light emitting diodes.

In some embodiments, a method for determining the mold spacing for forming a lens may include providing at least a prescription, a center thickness, and/or an edge thickness for a lens to a computer system. The method may include selecting mold members. The mold members may be selected using the provided prescription. The method may include creating a computer model of a reference lens that would be formed using a predetermined reference spacing and the selected mold members. The method may include using the computer model of the reference lens to determine the mold spacing that will produce a lens that has at least one of the provided center thickness or edge thickness.

In some embodiments, a method for determining the mold spacing for forming a lens may include providing at least a prescription, a center thickness, and/or an edge thickness for a lens to a computer system. The method may include assessing a first lens using a reference mold spacing, selected mold members, and/or the computer system. The method may include optimizing the first lens using the provided center thickness and the computer system to select a first mold spacing. The method may include assessing a minimum thickness of the optimized first lens using the computer system. In some embodiments, a method may include selecting a second mold spacing using the minimum thickness and the provided edge thickness. The method may include comparing the first mold spacing and the second mold spacing using the computer system to select an optimized mold spacing.

In some embodiments, a computer model of a reference lens may be created. The computer model may be created using a predetermined reference mold spacing and selected mold members. The computer model of the reference lens may be used to determine the properties of a first mold spacing that will produce a lens that has the provided center thickness. The method may include creating a computer model of a first lens. The first lens may include a lens that would be formed using a first mold spacing and the selected mold members. In some embodiments, a computer model of a reference lens may be used to determine the properties of a second mold spacing that will produce a lens that has the provided edge thickness. The method may include creating a computer model of a second lens. The second lens may include a lens that would be formed using a second mold spacing and the selected mold members. In some embodiments, a method may include comparing the first mold spacing and the second mold spacing using the computer system to select an optimized mold spacing.

In some embodiments, a method of forming a lens, includes: applying a coating composition to a casting face of a mold member, the coating composition comprising nanoparticles, one or more initiators, and one or more monomers; assembling a mold assembly, the mold assembly comprising the coated mold member, wherein the mold assembly comprises a mold cavity at least partially defined by the coated mold member; placing a liquid lens forming composition in the mold cavity, the liquid lens forming composition comprising one or more monomers and one or more initiators; curing the lens forming composition; and demolding the formed lens from the mold assembly, wherein a hardcoat layer is formed on an outer surface of the formed lens.

In some embodiments, a method of forming a lens includes: applying one or more antireflective coating compositions to a casting face of a mold member, at least one of the antireflective coating compositions comprising nanomaterials, one or more initiators, and one or more monomers; assembling a mold assembly, the mold assembly comprising the coated mold member, wherein the mold assembly comprises a mold cavity at least partially defined by the coated mold member; placing a liquid lens forming composition in the mold cavity, the liquid lens forming composition comprising one or more monomers and one or more initiators; curing the lens forming composition; and demolding the formed lens from the mold assembly, wherein the formed lens comprises one or more antireflective coating layers on an outer surface of the lens, and wherein each of the antireflective coating layers has a thickness of less than about 500 nm, and wherein an outer antireflective coating layer may have an index of refraction that is less than the index of refraction of the formed lens.

In some embodiments, a method of forming a lens includes: applying an antireflective coating composition to a lens, the antireflective coating composition comprising nanoparticles, one or more initiators, and one or more monomers; at least partially curing the antireflective coating composition to form an antireflective coating layer on the lens, wherein the antireflective coating layer has a thickness of less than about 500 nm, and wherein the antireflective coating layer has an index of refraction that is less than the index of refraction of the formed lens.

In some embodiments, a method of forming a lens includes: applying one or more antireflective coating compositions to a lens, at least one of the antireflective coating compositions comprising nanomaterials, one or more initiators, and one or more monomers; at least partially curing the antireflective coating composition to form one or more antireflective coating layers on the lens, wherein each of the antireflective coating layers has a thickness of less than about 500 nm, and wherein an outer antireflective coating layer has an index of refraction that may be less than the index of refraction of the formed lens.

In some embodiments, a method of forming a lens includes: applying a photochromic coating composition to a casting face of a mold member, the photochromic coating composition comprising one or more photochromic compounds, one or more initiators, and one or more monomers; assembling a mold assembly, the mold assembly comprising the coated mold member, wherein the mold assembly comprises a mold cavity at least partially defined by the coated mold member; placing a liquid lens forming composition in the mold cavity, the liquid lens forming composition comprising one or more monomers and one or more initiators; curing the lens forming composition; and demolding the formed lens from the mold assembly, wherein a photochromic coating layer is formed on an outer surface of the formed lens.

Lenses that include combinations of hardcoat layers, anti-reflective coating layers, and photochromic coating layers are also described herein.

### BRIEF DESCRIPTION OF THE DRAWINGS

The above brief description as well as further objects, features and advantages of the methods and apparatus of the present invention will be more fully appreciated by reference to the following detailed description of presently preferred but nonetheless illustrative embodiments in accordance with the present invention when taken in conjunction with the accompanying drawings.

FIG. 1 depicts an embodiment of a light emitting diode.

FIGS. 2A and 2B depict an embodiment of a light emitting diode device.

FIG. 3A depicts an embodiment of a light emitting diode device including seven LEDs.

FIG. 3B depicts an embodiment of a light emitting diode device with an elevated light emitting diode.

FIG. 3C depicts an embodiment of a light emitting diode device with a collar positioned about a light emitting diode.

FIGS. 4A and 4B depict an embodiment of a light emitting diode device and an associated reflector.

FIGS. 5A and 5B depict embodiments of a light emitting diode with an adjustable lens.

FIG. 6 depicts an embodiment of a light intensity distribution for a light emitting diode.

FIG. 7 illustrates the viewing angle of a light emitting diode.

FIG. 8 depicts two light intensity distributions for light emitting diodes.

FIG. 9 depicts several wavelength distributions for light emitting diodes.

FIG. 10 depicts an embodiment of a plurality of light emitting diode devices arranged to form a light source.

FIG. 11 depicts an embodiment of a circuit layout for an LED light source.

FIG. 12 depicts an embodiment of a circuit layout for an LED light source.

FIG. 13 depicts a cross-sectional side view of a high-volume lens curing apparatus.

FIG. 14 depicts a top view of a processing area of a coating apparatus.

FIG. 15 depicts a perspective view of an air distribution system.

FIG. 16 depicts a perspective view of a spin coating unit.

FIG. 17 depicts a cut-away side view of a spin coating unit.

FIG. 18 depicts a perspective view of a plastic lens forming apparatus.

FIG. 19 depicts a network diagram of an embodiment of a wide area network that may be suitable for implementing various embodiments.

FIG. 20 depicts an illustration of an embodiment of a computer system that may be suitable for implementing various embodiments.

FIG. 21 depicts a mold assembly.

FIG. 22 depicts an isometric view of an embodiment of a gasket.

FIG. 23 depicts a top view of the gasket of FIG. 22.

FIG. 24 depicts a cross-sectional view of an embodiment of a mold/gasket assembly.

FIG. 25 depicts a flowchart of an embodiment of a method for determining an optimized mold spacing for a mold assembly used to form a lens.

FIG. 26 depicts a conceptual illustration of a three-dimensional model of a lens.

FIG. 27 depicts an illustration of an embodiment of a method of systematically mapping a surface of a lens.

FIG. 28 depicts a flowchart of an embodiment of lens manufacturing system.

FIG. 29 depicts a flowchart of an embodiment of data flow based on a method of manufacturing lenses.

FIG. 30 depicts refractive index of ceria nanocomposite thin films versus weight percentage of ceria nanoparticles in the films.

FIG. 31 depicts film thickness versus weight percentage of ceria particles in the film for various ceria nanocomposite thin films with 3 weight percent solids.

FIG. 32 depicts percent haze added by the tumble abrasion test versus weight percentage of ceria nanoparticles in ceria nanocomposite films.

FIG. 33 depicts percent reflected intensity versus wavelength for two acrylic substrates with antireflective coating layers with different thickness and refractive indices.

FIG. 34 depicts reflectance versus wavelength for a lens coated with a two layer antireflective coatings and a hardcoat coating.

FIG. 35 depicts reflectance versus wavelength for a lens coated with a three layer antireflective coatings and a hardcoat coating.

FIG. 36 depicts reflectance versus wavelength for a lens coated with a three layer antireflective coatings.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

Methods and apparatus of various embodiments will be described generally with reference to the drawings for the purpose of illustrating the particular embodiments only, and not for purposes of limiting the same.

Apparatus, operating procedures, equipment, systems, methods, and compositions for lens coating and curing using activating light are available from Optical Dynamics Corporation in Louisville, Ky.

Polymeric lenses may be produced from lens forming compositions that include monomers and polymerization initiators. Polymeric lenses may be formed by curing a lens forming composition in a mold assembly. A mold assembly may include two mold members that are coupled together to define a mold cavity. The lens forming composition is placed within the mold cavity. Curing of the lens forming composition may be achieved with heat, light, or other methods and/or a combination thereof. Systems and methods for preparing optical lenses using radiation curing techniques and coatings applied to eyeglass lens molds are described in U.S. Pat. No. 3,494,326 to Upton; U.S. Pat. No. 4,544,572 to Sandvig et al.; U.S. Pat. No. 4,728,469 to Danner et al.; U.S. Pat. No. 4,758,448 to Sandvig et al.; U.S. Pat. No. 4,879,318 to Lipscomb et al.; U.S. Pat. No. 4,895,102 to Kachel et al.; U.S. Pat. No. 5,364,256 to Lipscomb et al.; U.S. Pat. No. 5,415,816 to Buazza et al.; U.S. Pat. No. 5,514,214 to Joel et al.; U.S. Pat. No. 5,516,468 to Lipscomb, et al.; U.S. Pat. No. 5,529,728 to Buazza et al.; U.S. Pat. No. 5,689,324 to Lossman et al.; U.S. Pat. No. 5,928,575 to Buazza; U.S. Pat. No. 5,976,423 to Buazza; U.S. Pat. No. 5,989,462 to Buazza et al.; U.S. Pat. No. 6,022,498 to Buazza et al.; U.S. Pat. No. 6,086,799 to Buazza et al.; U.S. Pat. No. 6,105,925 to Lossman et al.; U.S. Pat. No. 6,171,528 to Buazza et al.; U.S. Pat. No. 6,174,155 to Buazza et al.; U.S. Pat. No. 6,174,463 to Buazza et al.; U.S. Pat. No. 6,200,124 to Buazza et al.; U.S. Pat. No. 6,201,037 to Lipscomb et al.; U.S. Pat. No. 6,206,673 to Lipscomb et al.; U.S. Pat. No. 6,228,289 to Powers et al.; U.S. Pat. No. 6,241,505 to Buazza et al.; U.S. Pat. No. 6,280,171 to Buazza; U.S. Pat. No. 6,284,159 to Lossman et al.; U.S. Pat. No. 6,331,058 to Lipscomb et al.; U.S. Pat. No. 6,328,445 to Buazza; U.S. Pat. No. 6,367,928 to Buazza et al.; U.S. Pat. No. 6,367,928 to Buazza et al.; U.S. Pat. No. 6,416,307 to Buazza et al.; U.S. Pat. No. 6,419,873 to Buazza et al.; U.S. Pat. No. 6,451,226 to Buazza et al.; U.S. Pat. No. 6,464,484 to Powers et al.; U.S. Pat. No. 6,478,990 to Powers et al.; U.S. Pat. No. 6,494,702 to Buazza et al.; U.S. Pat. No. 6,528,955 to Powers et al.; U.S. Pat. No. 6,557,734 to Buazza et al.; U.S. Pat. No. 6,576,167 to Buazza et al.; U.S. Pat. No. 6,579,478 to Lossman et al.; U.S. Pat. No. 6,612,828 to Powers et al.; U.S. Pat. No. 6,632,535 to Buazza et al.; U.S. Pat. No. 6,634,879 to Buazza et al.; U.S. Pat. No. 6,655,946 to Foreman et al.; U.S. Pat. No. 6,673,278 to Buazza et al.; U.S. Pat. No. 6,676,398 to Foreman et al.; U.S. Pat. No. 6,676,399 to Foreman; U.S. Pat. No. 6,698,708 to Powers et al.; U.S. Pat. No. 6,702,564 to Foreman et al.; U.S. Pat. No. 6,709,257 to Foreman et al.; U.S. Pat. No. 6,712,331 to Foreman et al.; U.S. Pat. No. 6,712,596 to Buazza et al.; U.S. Pat. No. 6,716,375 to Powers et al.; U.S. Pat. No. 6,729,866 to Buazza et al.; U.S. Pat. No. 6,730,244 to Lipscomb et al.; U.S. Pat. No. 6,723,260 to Powers et al.; U.S. Pat. No. 6,726,463 to Foreman; U.S. Pat. No. 6,752,613 to Foreman; U.S. Pat. No. 6,758,663 to Foreman et al.; U.S. Pat. No. 6,786,598 to Buazza; U.S. Pat. No. 6,790,022 to Foreman; U.S. Pat. No. 6,790,024 to Foreman; U.S. Pat. No. 6,808,381 to Foreman et al.; U.S. Pat. No. 6,840,752 to Foreman; U.S. Pat. No. 6,863,518 to Powers; U.S. Pat. No. 6,875,005 to Foreman; U.S. Pat. No. 6,895,458 to Foreman et al.; U.S. Pat. No. 6,899,831 to Foreman; U.S. Pat. No. 6,926,510 to Buazza et al.; U.S. Pat. No. D467,948 to Powers; U.S. Pat. No. D460,468 to Powers et al.; U.S. patent application Publication Nos. 2001-0038890 to Buazza et al.; 2001-0047217 to Buazza et al.; 2002-0166944 to Foreman et al.; 2002-0167097 to Foreman et al.; 2002-0167098 to Foreman et al.; 2002-0167099 to Foreman et al.; 2002-0168439 to Foreman et al.; 2002-0168440 to Foreman; 2003-0003176 to Foreman et al.; 2003-0042633 to Foreman et al.; 2003-0042635 to Foreman; 2003-0111748 to Foreman; 2003-0146527 to Powers et al.; 2002-0158354 to Foreman et al.; 2003-0169400 to Buazza et al.; 2002-0185761 to Lattis et al.; 2003-0203065 to Buazza et al.; 2005-0077639 to Foreman et al.; and U.S. patent application Ser. Nos. 09/539,211 to Powers et al. filed Mar. 30, 2000; and Ser. No. 10/098,736 to Foreman et al. filed Mar. 15, 2002, all of which are incorporated herein by reference. In addition, systems and methods for generating and reading data codes are described in U.S. Pat. No. 4,939,354 to Priddy et al.; U.S. Pat. No. 5,053,609 to Priddy et al.; and U.S. Pat. No. 5,124,536 to Priddy et al., all of which are incorporated herein by reference.

In some embodiments, one or more light emitting diodes (LEDs) may be used to cure a lens forming composition and/or a coating composition. As used herein, “LED” generally refers to a semiconductor device made from materials including, but not limited to, inorganic semiconductors and semiconducting inorganic polymers, that emits incoherent monochromatic ultraviolet, visible, or infrared light (e.g., photons of electromagnetic radiation) when electrically biased in the forward direction. In certain embodiments, “LED” may refer to a semiconductor chip (or die) including at least one diode configured to emit light. In certain embodiments, “LED” may refer to an electronic component (e.g., board-level component) including at least one diode configured to emit light. In some embodiments, a light source including one or more LEDs may be used in conjunction with or in place of other light sources and lamps described in any of the embodiments described in any of the patents incorporated herein by reference to cure a lens forming composition and/or a coating composition.

LEDs may be characterized in terms of mechanical, optical, and/or electrical properties. Mechanical properties used to characterize LEDs may include size, thermal characteristics, packaging, etc. LEDs may be packaged individually or in arrays. An array of LEDs may refer to multiple diodes on a single chip, multiple chips in a single electronic component, multiple electronic components on a board, etc. Some LED packages include multiple chips packaged on a board. LEDs packaged in such a chip-on-board (COB) package are commercially available from NorLux Corporation of Carol Stream, Ill. and Opto Technology Inc., Wheeling Ill. As used herein, “LED light source” is intended to include each of the above-described devices and variations thereof. The various devices described by the term LED light source are differentiated herein only where such differentiation may be desirable to add clarity to the description.

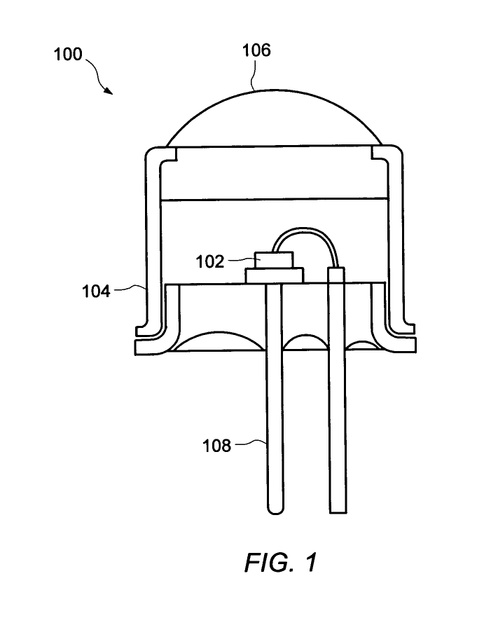

FIG. 1 depicts an embodiment of an LED device 100 with LED chip 102 packaged to form an LED electronic component. LED chip 102 may be enclosed in casing 104. Additionally, LED chip 102 may be covered by encasing material 106. Encasing material 106 may be selected to be substantially transparent to light emitted by LED chip 102 during use. In some embodiments, encasing material 106 may be selected to filter light emitted by LED chip 102 such that the range of wavelengths of light emitted by LED device 100 is limited or narrowed. Encasing material 106 may physically stabilize and protect LED chip 102. Additionally, encasing material 106 may be shaped to focus light emitted by LED chip 102. Leads 108 may by coupled to LED chip 102 via electrical junctions. During use, LED chip 102 may be electrically coupled to a power source via leads 108. LED chip 102 and/or LED device 100 may include other features not depicted or described here. LEDs have predictable aging and/or degradation properties, and therefore a control system may be programmed for adjusting current flow to the LED to ensure repeatability and accuracy of the dosage of activating light.

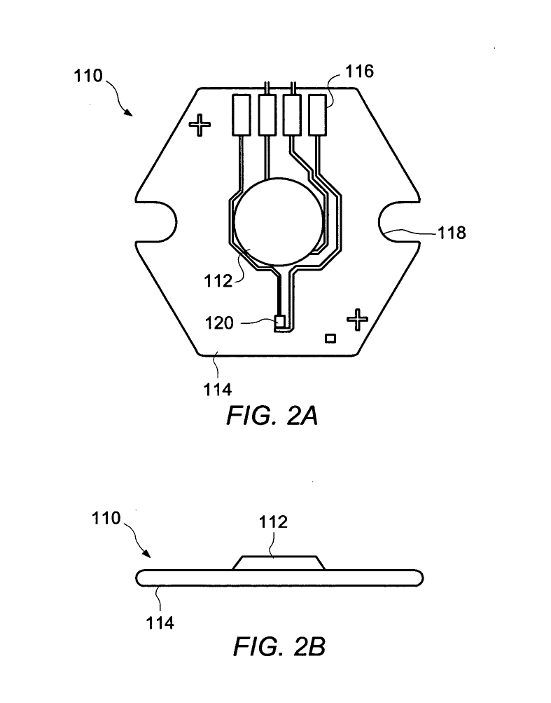

FIGS. 2A and 2B depict an embodiment of an LED device including one or more LEDs coupled to a substrate. LED device 110 may include one or more LEDs 112. LEDs 112 may be coupled to substrate 114. LEDs 112 may include one or more LED chips or one or more LED electronic components. Substrate 114 may provide electrical connections 116 for coupling LED device 110 to a power source. Substrate 114 may also provide structural support for LEDs 112. Substrate 114 may also include one or more coupling areas 118 for physically coupling LED device 110 to another such device and to heat sinks for those devices.

In some embodiments, LED device 110 may be coupled to a support structure configured to arrange one or more LED devices with respect to a mold assembly used for curing a lens forming composition. In such a case, the support structure may be selected to be thermally conductive. Selecting a thermally conductive support structure may allow the support structure to act as a heat sink to facilitate removal of heat from the LED devices. Heat sinks also allow higher current (and therefore higher output) thru the LED (for example, up to 2×, 3×, or potentially more).

LED device 110 may also include heat sensor 120. Heat sensor 120 may be used to determine operating temperature information regarding LED device 110. In some embodiments, heat sensor 120 may be coupled to a controller via one or more electrical connections 116. Heat sensor 120 may provide the controller with information used to determine electrical operating parameters for LED device 110. For example, the maximum forward current rating of LED device 110 may vary depending on a temperature associated with the LED device. A controller receiving temperature information from heat sensor 120 may vary electrical operating parameters of LED device 110 based on the temperature information to extend the useful life of the LED device and/or to ensure that a desired light output is generated by the LED device. As a temperature of LED device 110 increases, light output from the LED device decreases. Thus, a temperature of LED device 110 and/or a temperature of the heat sink may be monitored, and the current may be adjusted to compensate for decreased light output due to a temperature increase.

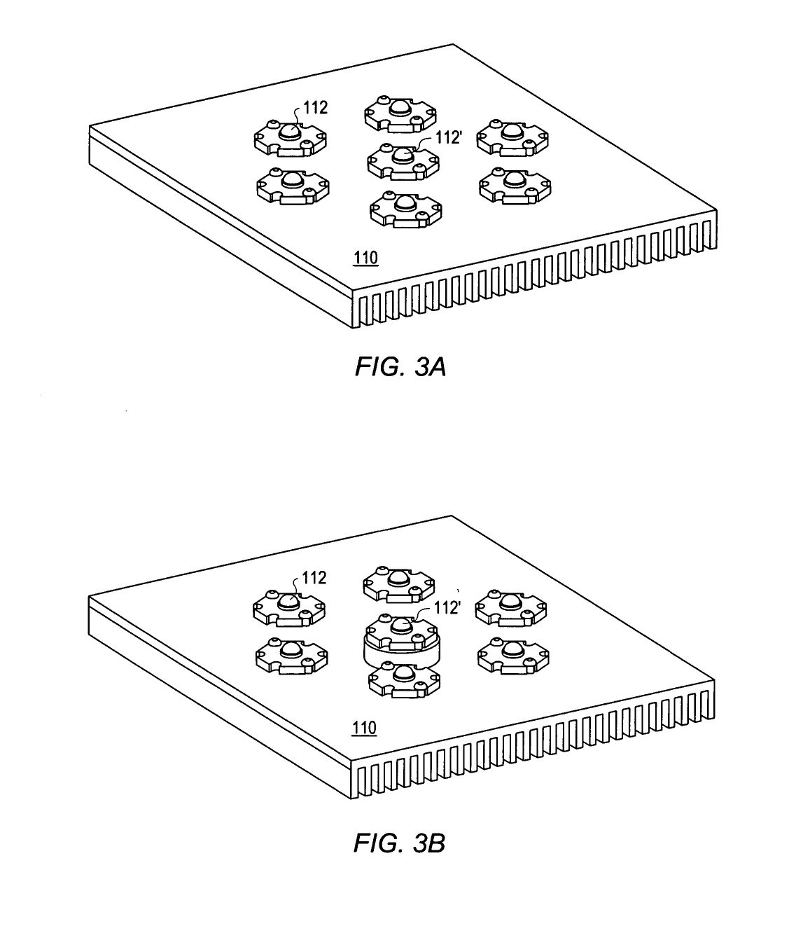

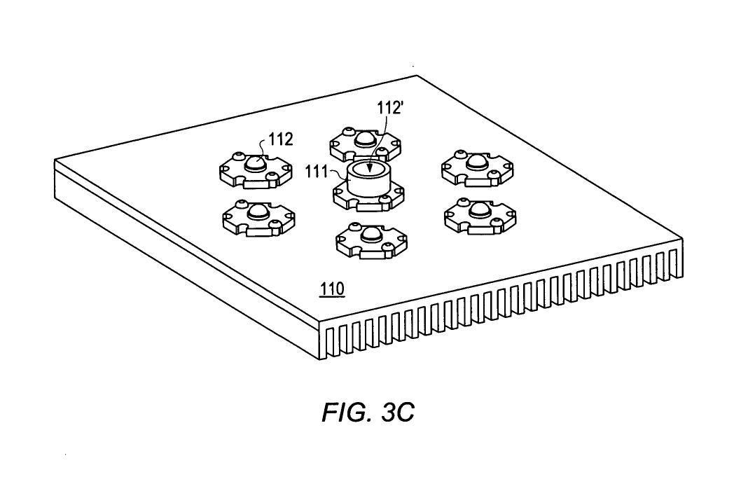

A decrease in light output from an LED device may also be attributed to aging of the LED device and/or ambient temperature at which the LED device is operated. Curing of a lens forming composition may be affected by dimming of light output from an LED over the lifetime of the LED. Dimming over the lifetime of an LED device may be compensated for by assessing light output from the LED device (e.g., with a light sensor or by measuring the amount of time one or more LED devices have been used). Additionally, the temperature of the LED or ambient air in the proximity of the LED may be monitored (e.g., with a temperature sensor). The light output of the LED may be adjusted by altering the current applied to the LED to compensate for changes in light output due to the age of the LED and/or the temperature of the LED. In some embodiments, current to an LED device may be automatically adjusted over time to account for hours of use of the LED device. In some embodiments, an LED device may include two or more LEDs. For example, FIG. 3A depicts a perspective view of an embodiment of LED device 110 with six LEDs 112 arranged about central LED 112′. LEDs used may include Luxeon® Emitter or Star LEDs (e.g., LXHL-LR5C) obtainable from, for example, Lumileds, Inc. (San Jose, Calif.) and Opto Technology, Inc. (Chicago, Ill.).

In certain embodiments, LEDs of an LED device may be positioned at various heights on the LED device. For example, one or more LEDs may be elevated relative to one or more other LEDs of an LED device. An LED device with one or more elevated LEDs may be used to provide a desired distribution of light intensity to a mold assembly. For example, LEDs of an LED device may be elevated to provide more light intensity to a region of a mold cavity with a greater thickness of lens forming composition and less light intensity to a region of the mold cavity with a lesser thickness of lens forming composition. As depicted in FIG. 3B, central LED 112′ of LED device 110 is elevated (e.g., positioned on a pedestal) relative to LEDs 112. An LED device with an elevated central LED array may provide more light intensity to a central portion of a mold assembly, and thus the mold cavity. In some embodiments, peripheral LED arrays may be elevated to provide more light intensity to a peripheral portion of a mold assembly.

In some embodiments, an LED device may include a member (e.g., a collar) designed to restrict the light emitted from an LED. FIG. 3C depicts an embodiment of LED device 110 with collar 111 positioned about central LED 112′.

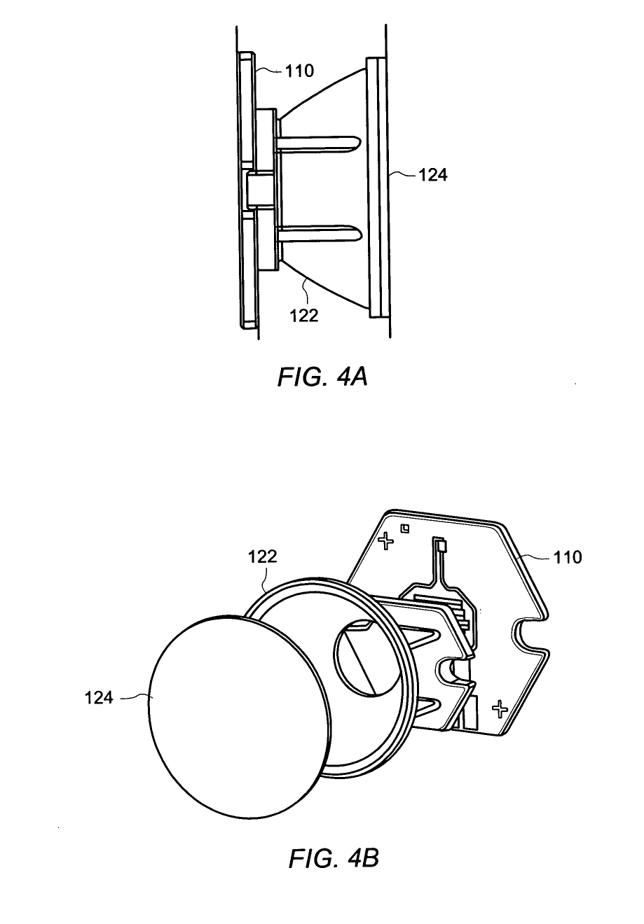

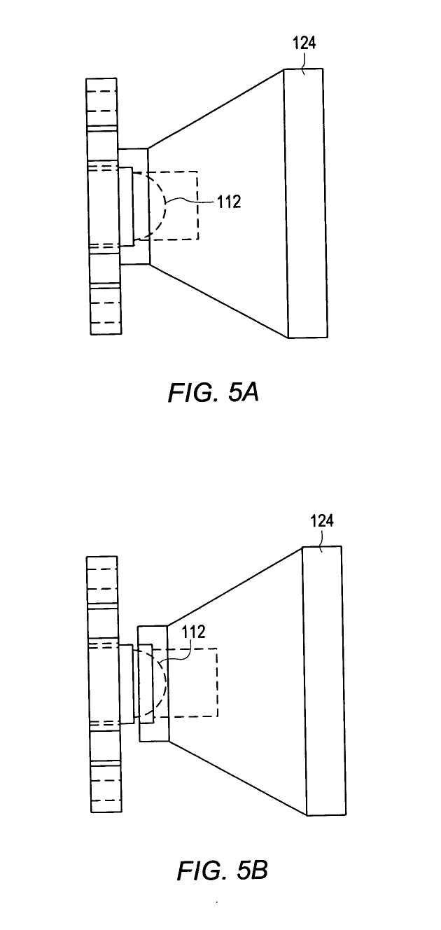

In certain embodiments, an LED device may be associated with or include a reflecting device for directing light emitted by one or more LEDs in a desired manner. FIGS. 4A and 4B depict an embodiment of LED device 110 with associated reflector 122. Lens 124 may be coupled to reflector 122. Lens 124 may focus or diffuse light from LED device 110. In certain embodiments, as shown schematically in the side views depicted in FIGS. 5A and 5B, a distance of lens 124 from LED 112 may be adjustable. For example, lens 124 may be translated and/or rotated toward or away from LED 112 to focus or disperse light from the LED on a mold assembly to achieve a desired distribution of light on the mold cavity.

Adjusting a position of a lens from an LED device may allow selected portions of a lens forming composition in a mold cavity to receive more or less light than other portions of the lens forming composition. For example, light from an LED device may be focused by a lens such that a lens forming composition in a center of a mold cavity receives more light intensity than the lens forming composition near the periphery of the mold cavity. In some embodiments, it may be desirable for lens forming composition in a peripheral region of the mold cavity to receive more or less light intensity than lens forming composition in the center of the mold cavity. Portions of lens forming composition receiving more or less light intensity may be symmetrical or asymmetrical. A lens may be any type of lens including, but not limited to, convex or concave. In certain embodiments, a lens may filter light from an LED device to limit a range of wavelengths emitted by the device to a desired wavelength range.

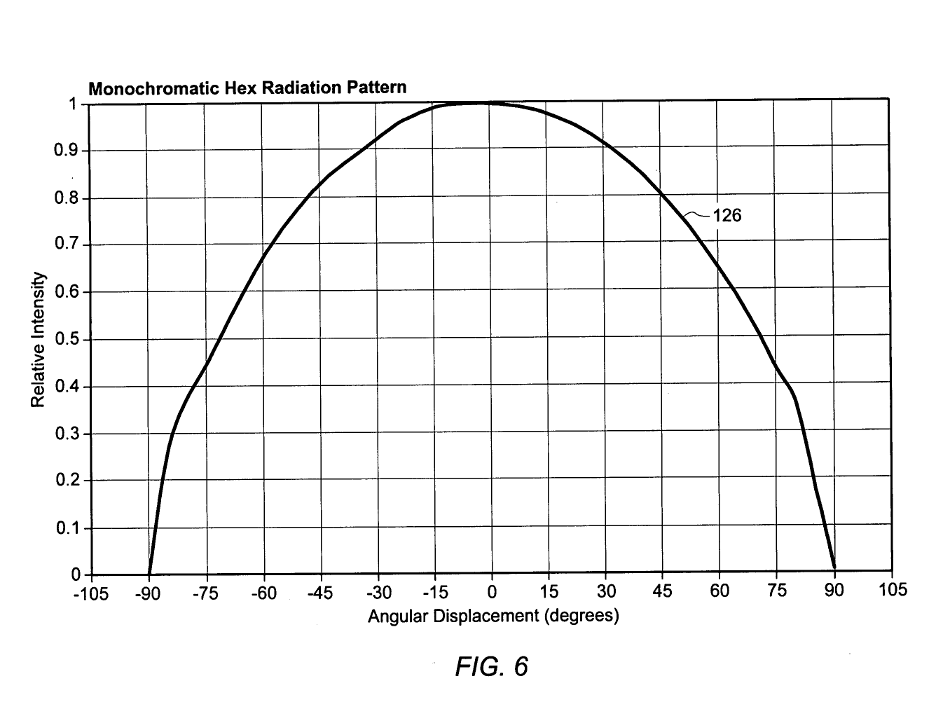

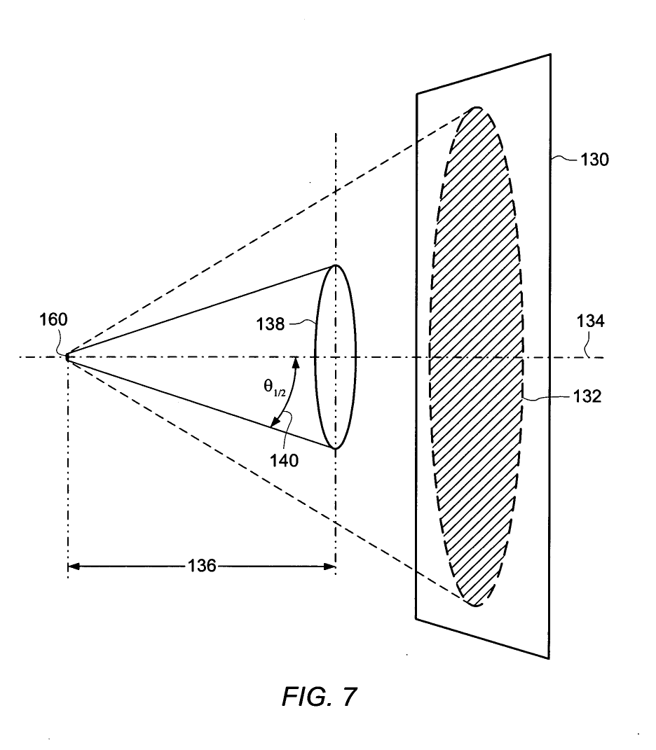

FIG. 6 depicts an embodiment of a light intensity distribution curve for an LED device. Intensity distribution curve 126 depicted in FIG. 6 is for a particular LED device commercially available from Norlux Corporation (Carol Stream, Ill.) under the manufacturer's name of “monochromatic Hex.” Although light intensity curve 126 is for a particular LED device, it illustrates a common light intensity distribution for certain LED devices. The intensity distribution of light generated by an LED is commonly described in terms of radiant intensity and/or viewing angle. Radiant intensity describes the radiant flux per unit solid angle emitted by the LED in a given direction.

FIG. 7 illustrates the viewing angle associated with the intensity distribution depicted in FIG. 6. As light source 160 emits light toward surface 130, a portion of the surface is irradiated (e.g., illuminated if the light emitted is visible light). Irradiated area 132 and light source 160 may be considered to define the base and apex of a cone, respectively. As such, centerline 134 of the cone may be identified. The viewing angle of an LED is commonly provided in terms of θ_{1/2}. θ_{1/2} is the angle formed by centerline 134 and a line from the light source to a point at which the radiant intensity is half of the radiant intensity at a point along the centerline. For example, at a selected distance 136 from the light source, the radiant intensity along centerline 134 may have a value X. At a certain radial distance from centerline 134, the luminous intensity may have a value of ½X. In FIG. 7, circumference 138 illustrates the radius having a radiant intensity of ½X. The angle formed by centerline 134, light source 160, and a point on circumference 138 is θ_{1/2} of the light source. The viewing angle of a light source may also be expressed as 2 θ_{1/2}. Commercially available discrete LEDs with integrated optics or reflectors (e.g., a T−1 or T−1¾) typically have a relatively narrow viewing angle, but the individual die of the LED is wide angle. Viewing angle of an LED device may be modified by grouping two or more individual LEDs together, by using reflectors, and/or by using diffusers, etc.

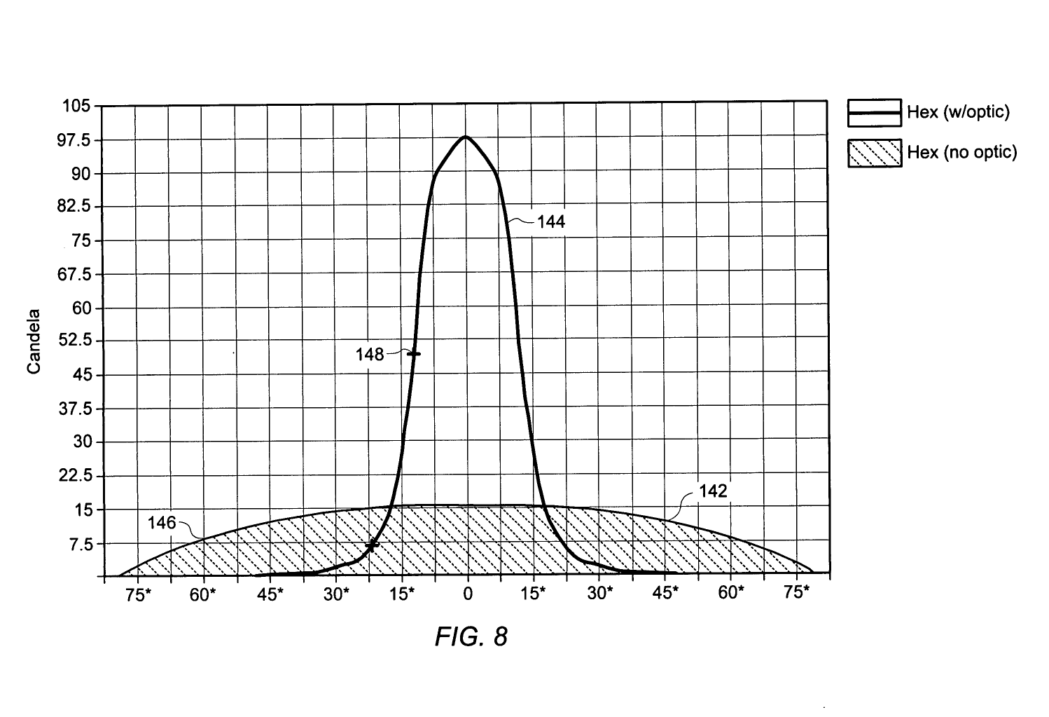

FIG. 8 depicts intensity of light emitted by an LED device at various angles around a primary axis of the device. The primary axis is depicted as an angle of 0 degrees. Curve 142 shows an example of a light intensity distribution that may be associated with an LED device without a reflector. Curve 144 shows an example of a light intensity distribution that may be associated with the LED device with a reflector. Comparison of curve 142 and curve 144 indicates that the presence of a reflector may narrow the viewing angle of the LED device. For example, curve 142 has a θ_{1/2} 146 of about 60 degrees; however, curve 144 has a θ_{1/2} 148 of about 12 degrees. Adding a reflector may also increase the axial (or peak) intensity. For example, the axial intensity of curve 142 is about 16 candela; whereas the axial intensity of curve 144 is about 98 candela.

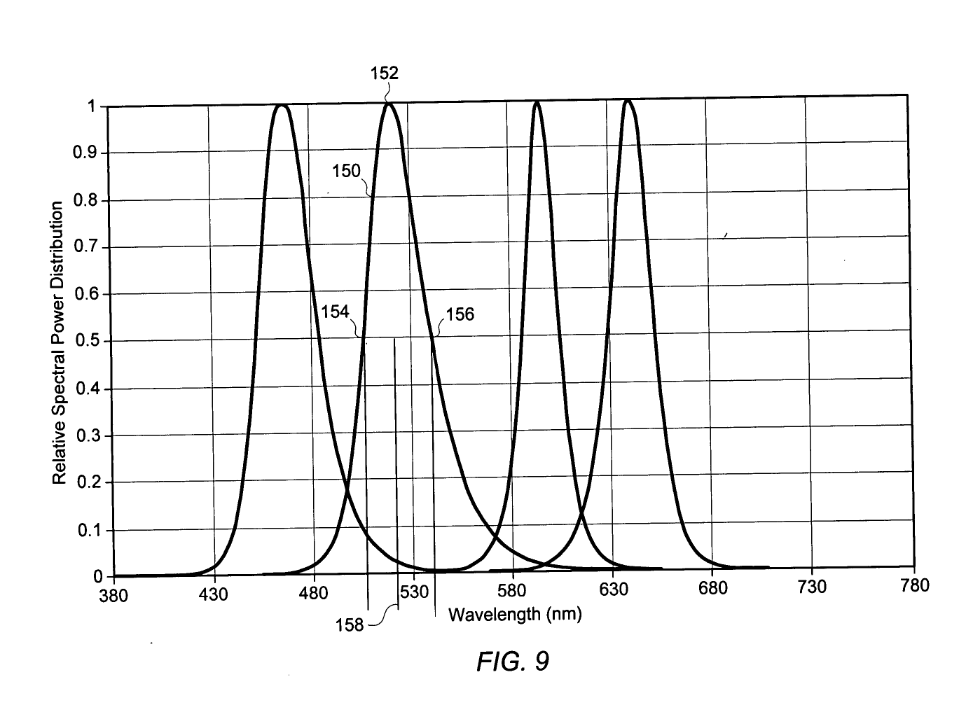

In addition to light intensity distribution, an LED device may be characterized in terms of a wavelength distribution of the light emitted by the LED device. For example, FIG. 9 depicts several wavelength distribution curves for different LED devices. The wavelength distribution of light emitted by an LED device may be described in a number of ways. For example, the entire wavelength distribution curve of the LED device may be provided as in FIG. 9. Alternately, a numerical description of the wavelength distribution may be provided. A numerical wavelength distribution description may include peak wavelength and/or center wavelength. Peak wavelength commonly refers to the wavelength with the highest intensity (or power). For example, referring to curve 150 of FIG. 9, peak wavelength 152 is about 520.5 nm. However, a wavelength distribution curve (such as curve 150) may not be symmetrical. Therefore, peak wavelength 152 may not provide a good description of the distribution as a whole.

Center wavelength 158 may provide a more general description of the entire wavelength distribution. Center wavelength 158 may be determined by first determining the two half peak wavelengths. A half peak wavelength is the wavelength at which the intensity is half of the intensity of the peak wavelength. Since curve 150 is described in terms of relative intensity, the half peak wavelengths coincide with the 0.5 line of the relative power distribution. Thus, the half peak wavelengths occur at about 505 nm and 539.5 nm, as indicated by points 154 and 156 respectively. Center wavelength 158 may then be determined by finding the center point between the two half peak wavelengths (e.g., about 522.3 μm). The wavelength distribution of an individual LED is largely dependent upon the materials with which the LED is constructed. However, the wavelength distribution may be modified by use of filters to inhibit transmission of one or more wavelengths. Additionally, the wavelength distribution of an LED device may be modified by including two or more LEDs having different wavelength distributions. In such an instance, the LED device may be configured to activate one or more LEDs to generate a desired wavelength distribution.

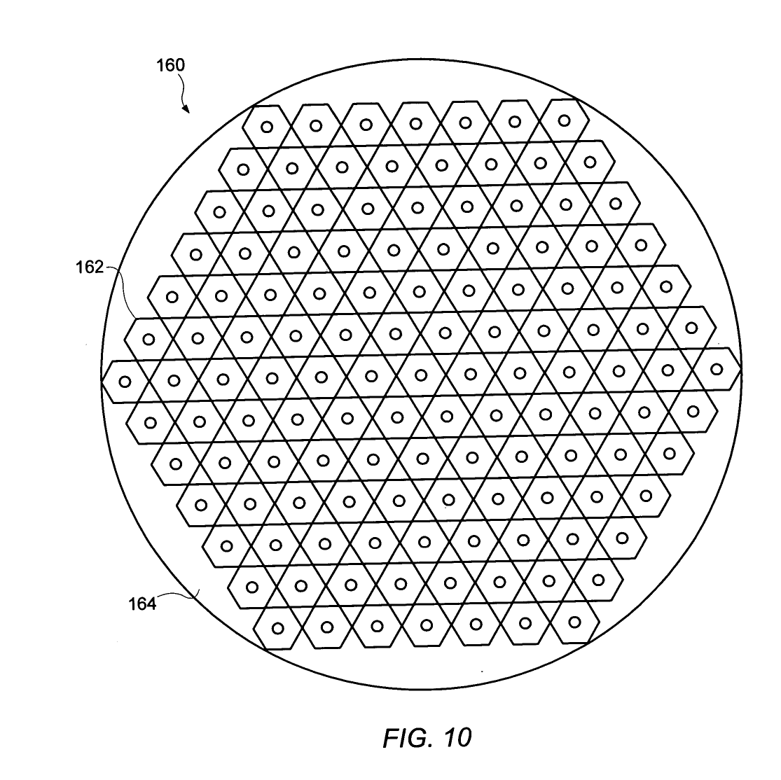

In an embodiment, a lens forming apparatus may include a light source including one or more LED devices. FIG. 10 depicts an embodiment of light source 160 including a plurality of LED devices 162 which may be used to cure a curable lens forming composition disposed in a mold cavity. Light source 160 may have a size sufficient to simultaneously direct activating light toward an entire mold cavity of a mold assembly. In some embodiments, a plurality of LED devices 162 may be distributed over light source 160, as depicted in FIG. 10. LED devices included in light source 160 may be individual LEDs or groups of LEDs. For example, groups of LEDs combined on an LED device (e.g., LED device 110 depicted in FIGS. 2A and 2B) may be used.

In an embodiment, LED devices 162 may be coupled to a substrate 164. Substrate 164 may provide structural support for LED devices 162. Additionally, in certain embodiments, substrate 164 may be thermally conductive. A thermally conductive substrate may act as a heat sink to remove heat from one or more of LED devices 162. Additionally, in certain embodiments, heat may be removed from the LED devices using fans or other cooling apparatus.

A barrier may be disposed between the light source and the material to be cured (e.g., a lens forming composition or lens coating composition). For example, the barrier may include a heat barrier to insulate the light source from a curing chamber. In another example, the barrier may include a drip barrier to prevent a lens forming composition from dripping onto the light source during curing of the lens forming composition. In either case, the barrier may be substantially transparent to activating light generated by the light source. In one embodiment, the barrier may include a borosilicate plate of glass (e.g., PYREX glass) disposed between the light sources and the material to be cured. In one embodiment, a pair of borosilicate glass plates, with an intervening air gap between the plates may serve as a heat barrier. The use of borosilicate glass allows the activating radiation to pass from the light source to the material to be cured without any significant reduction in intensity. In some embodiments, a barrier (e.g., frosted barrier glass) may also serve as a diffuser.

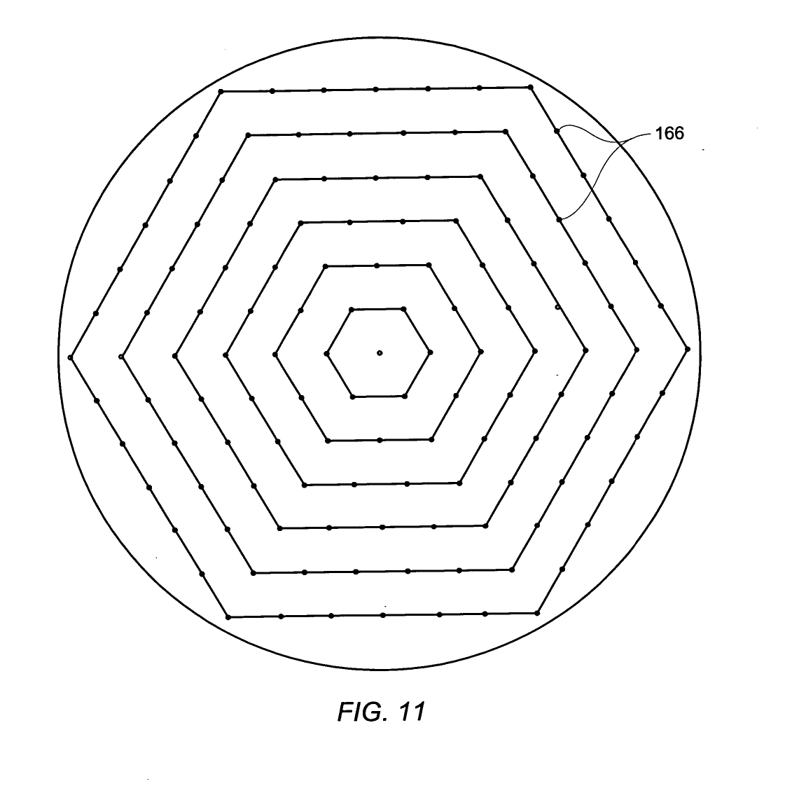

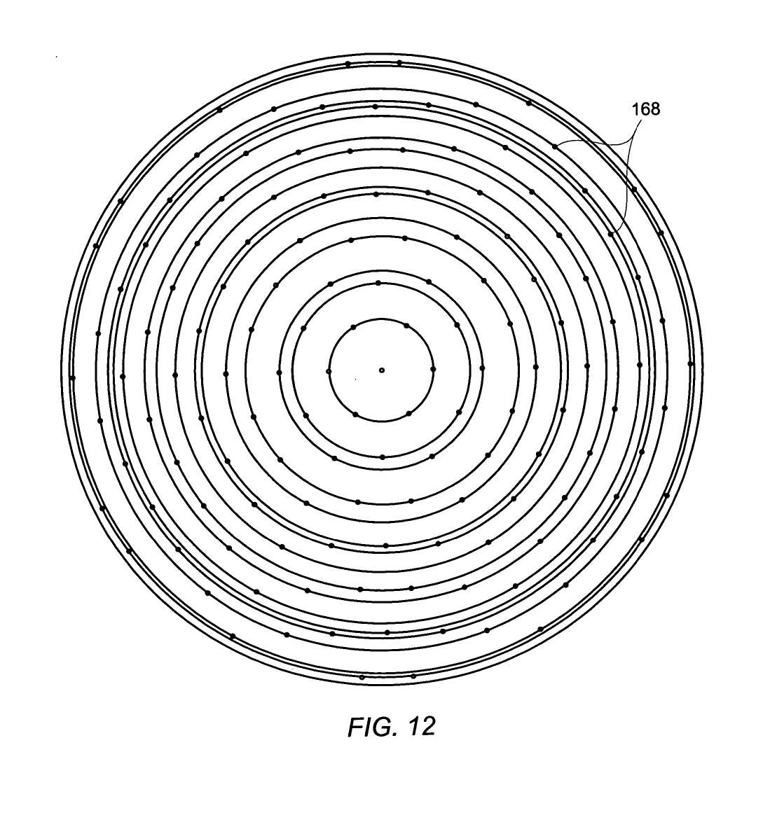

In some embodiments, substrate 164 may provide routing for electrical circuit paths to provide electrical connections to LED devices 162. In certain embodiments, two or more LED devices may be electrically connected. Such configurations may allow the LED devices to be simultaneously controlled. For example, one or more LEDs may be connected in a series circuit or in a parallel circuit. The LED devices may be coupled in a manner that allows a predetermined pattern(s) to be formed. For example, FIGS. 11 and 12 depict circuit arrangements that may allow desired patterns to be formed. In FIG. 11, the LED devices are connected in series to form a number of substantially uniformly spaced concentric geometric shapes 166 (e.g., hexagons). In FIG. 12, the LED devices are connected in series to form a number of nonuniformly spaced concentric geometric shapes 168 (e.g., concentric circles).

In some embodiments, a light source may include LED devices arranged along a substantially linear transport device (e.g., a conveyor belt). For example, LEDs may be used as a light source for a high-volume lens curing apparatus as described in U.S. Pat. No. 6,464,484 to Powers et al. In such an embodiment, each LED or LED device may be independently controllable. In certain embodiments, two or more LEDs may be controlled as a group. For example, two or more LEDs forming a line orthogonal to the transport device may be controlled together. In such an arrangement, LEDs may be activated and deactivated to follow a mold assembly moving down the transport device. That is, as the mold assembly moves down the transport device, activating light, a light pattern, and/or light pulses may move with the mold assembly to cure the lens forming composition as the mold assembly moves. In such an embodiment, LEDs on different sides of the transport device may operate independently such that two mold assemblies moving down the transport device together (e.g., a right lens mold assembly and a left lens mold assembly) may be irradiated with appropriate doses of activating light.

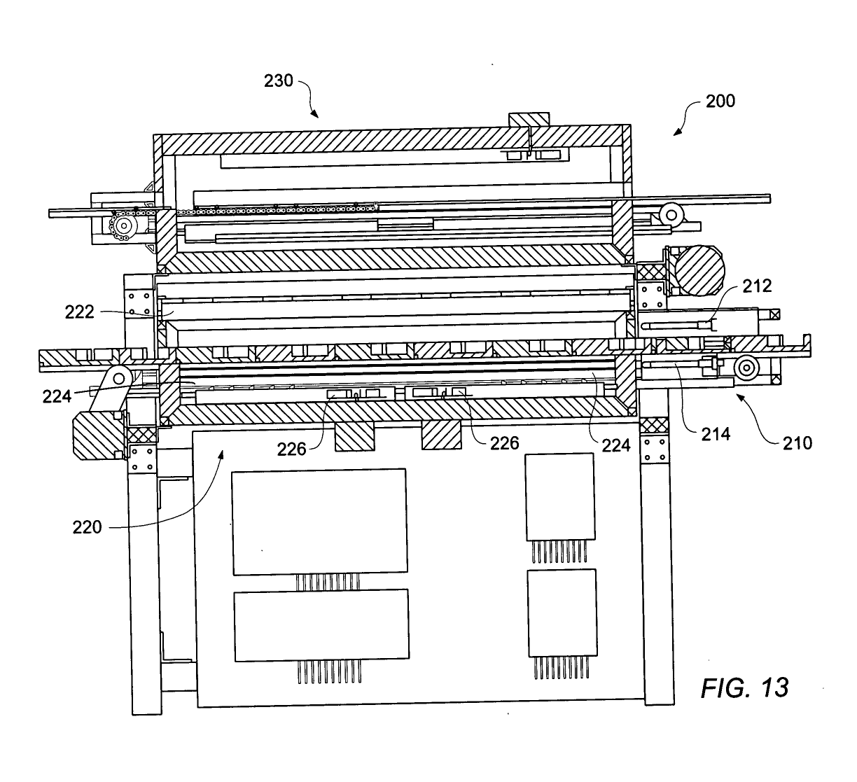

Referring now to FIG. 13, a high-volume lens curing apparatus is generally indicated by reference numeral 200. As shown in FIG. 13, lens forming apparatus 200 includes at least a first lens curing unit 210 and a second lens curing unit 220. The lens forming apparatus may, optionally, include an anneal unit 230. In other embodiments, a post cure unit may be a separate apparatus which is not an integral part of the lens curing apparatus. A conveyance system may be positioned within the first and/or second lens curing units. The conveyance system may be configured to allow a mold assembly to be transported from the first lens curing unit 210 to and through the second lens curing unit 220.

Lens curing units 210 and 220 include an activating light source for producing activating light. The activating light sources disposed in units 210 and 220 are preferably configured to direct light toward a mold assembly. Anneal unit 230 may be configured to apply heat to at least partially relieve or relax the stresses caused during the polymerization of the lens forming material. Anneal unit 230, in one embodiment, includes a heat source. A controller may be coupled to lens curing units 210 and 220 and, if present, an anneal unit 230, such that the controller is capable of substantially simultaneously operating the three units 210, 220, and 230.

As shown in FIG. 13, the first curing unit 210 may include an upper light source 212 and a lower light source 214. In one embodiment, light sources 212 and 214 are LED light sources. LED light sources 212 and 214 of the first curing unit 210 may include a plurality of LED light sources. In one embodiment, the LED light sources are oriented proximate to each other to form a row. In one embodiment, three or four LED light sources are positioned to provide substantially uniform radiation over the entire surface of the mold assembly to be cured. The LED light sources may generate activating light.

The LED light sources may be supported by and electrically connected to suitable fixtures. LED light sources 212 and 214 may generate either ultraviolet light, actinic light, visible light, and/or infrared light. The choice of LED light sources is preferably based on the monomers and/or initiators used in the lens forming composition.

In some embodiments, at least four independently controllable LED light sources or sets of LED light sources may be disposed in the first curing unit. The LED light sources may be disposed in left and right top positions and left and right bottom positions. A variety of different initial curing conditions may be required depending on the prescription. In some instances the left eyeglass lens may require initial curing conditions that are substantially different from the initial curing conditions of the right eyeglass lens. To allow both lenses to be cured substantially simultaneously, the four sets of LED light sources may be independently controlled. For example, the right set of LED light sources may be activated to apply light to the back face of the mold assembly only, while, at the same time, the left set of LED light sources may be activated to apply light to both sides of the mold assembly. In this manner a pair of eyeglass lenses whose left and right eyeglass prescriptions require different initial curing conditions may be cured at substantially the same time. Since the lenses may thus advantageously remain together in the same mold assembly holder throughout the process, the production process is simpler with minimized job tracking and handling requirements.

The second curing unit may be configured to apply heat and activating light to a mold assembly as it passes through the second curing unit. The second curing unit may be configured to apply activating light to the top, bottom, or both top and bottom of the mold assemblies. As depicted in FIG. 13, the second curing unit may include a bank of activating light producing LED light sources 222 and heating systems 224. The LED light sources in the second curing unit may produce light having the same spectral output as the LED light sources in the first curing unit.

The spectral output refers to the wavelength range of light produced by an LED light source, and the relative intensity of the light at the specific wavelengths produced. Alternatively, a series of LED light sources may be disposed within the curing unit. In either case, the LED light sources are positioned such that the mold assemblies will receive activating light as they pass through the second curing unit. The heating unit may be a resistive heater, hot air system, hot water systems, or infrared heating systems. An air distributor 226 (e.g., a fan) may be disposed within the heating system to aid in air circulation within the second curing unit. By circulating the air within the second curing unit, the temperature within the second curing unit may be more homogenous. Further details regarding the high volume lens curing systems depicted in FIG. 13 can be found in U.S. Pat. No. 6,464,484 to Powers et al.

In certain embodiments, one or more of the LED devices may be independently controllable. In such an embodiment, the independently controllable LED devices may be controlled by a controller to form a desired light pattern. Such embodiments may allow greater flexibility in the light patterns formed than static filters inserted between a light source and a mold assembly.

Differing rates of reaction among various regions of the mold assembly may be achieved by applying a differential light distribution across the mold face(s). For example, light distributions where the intensity of light reaching the edges of the mold cavity is greater than the intensity of light reaching the center of the mold cavity may cause the edge of the lens forming material to begin reacting before the center of the material. Such light distributions have been formed in other embodiments using filters. In the present embodiment, a controller may determine an appropriate light distribution depending on prescription data or other information including, but not limited to, ambient room temperature, initial temperature of the lens forming composition, temperature response of the lens forming composition after reaction is initiated, etc. As used herein, a “light distribution” or “light pattern” may be used broadly to refer to a light intensity distribution, a wavelength distribution or combinations thereof.

A desired light distribution from an LED device may be achieved by adjusting current supplied to one or more LEDs of the LED device. In some embodiments, current supplied to an LED may be pulsed to provide pulsed light output from the LED. In certain embodiments, LEDs may be dimmed using methods and components commonly known in the art to reduce the intensity of light output from the LED. Advantageously, light output from LEDs may be dimmed to low levels without pulsing or flickering, allowing constant levels of low intensity light as needed during curing of all or portions of a lens forming composition.

In some embodiments, light distribution from one or more LED devices may be actively adjusted during a curing cycle. For example, the pattern of light and dark regions may be manipulated such that a lens forming composition is initially cured from the center of the lens and then gradually expanded toward the outer edges of the lens. This type of curing pattern may allow a more uniformly cured lens to be formed. In some instances, curing in this manner may also be used to alter the final power of the formed lens.

In another embodiment, an LED light source may be used to allow different light distributions to reach two separate mold assemblies simultaneously. For example, a lens-curing unit may be configured to substantially simultaneously irradiate two mold assemblies. If the mold assemblies are being used to create lenses having the same power, the light irradiation pattern and/or intensity may be substantially the same for each mold assembly. If the mold assemblies are being used to create lenses having significantly different powers, each mold assembly may require a significantly different light distribution. The use of an LED light source may allow the irradiation of each of the mold assemblies to be controlled individually. For example, a first mold assembly may require a pulsed curing scheme, while the other mold assembly may require a continuous irradiation pattern. Additionally, one lens may require a different dosage of light in the center than the other lens in the chamber (e.g., when curing a plus lens and a minus lens in the same curing unit). LED light sources may therefore be used to create different light distributions across the mold assembly. Such a system minimizes the need for human intervention, since a controller may be programmed for a desired pattern, rather than the operator having to choose among a “library” of filters, etc.

In some embodiments, each LED device included in a light source may be substantially identical. That is, each LED device may be selected to emit light having substantially the same wavelength distribution and substantially the same intensity distribution as other LED devices included in the light source. In certain embodiments, one or more LED devices may be selected to emit light having a substantially different wavelength distribution and/or a substantially different intensity distribution than one or more other LED devices included in the light source. In still other embodiments, an LED device may include a plurality of individual LEDs. In such cases, the individual LEDs of the LED device may be substantially identical or different, as described above. Different light distributions may be used for different purposes and/or in different locations for forming a lens. An advantage of a light source having LEDs capable of generating different light distributions may be that such differential curing schemes may be readily achieved. For example, light having a first wavelength distribution may be used to initiate curing and light having a second wavelength distribution may be used to complete curing. In another example, a method of forming a lens may include curing of a lens forming composition using activating light having a first intensity distribution and completing curing using activating light having a second intensity distribution. Such methods may be carried out by activating LEDs that emit light having the first wavelength distribution and/or first intensity distribution and simultaneously or subsequently activating LEDs that emit light having the second wavelength distribution and/or second light intensity distribution.

In some embodiments LED devices used to form a light source may be physically and electrically configured to allow a desired light pattern to be formed. In such an embodiment, a pattern may vary spatially and/or temporally. That is, the intensity and/or wavelength of the light may vary as a function of time and/or as a function of position on a support. For example, as previously described, LED devices oriented over a transport device may “follow” a lens mold along the transport device to cure the lens forming composition. In another example, LEDs may be activated so as to forms rings, lines, or other geometric patterns of activating light. Additionally, such patterns may vary over time. For example, rings of activating light may move outward from the center of a mold cavity to the outer edge of the mold cavity in order to achieve a desired curing rate in each area.

In certain embodiments, LED devices may be distributed over a substrate such that a relatively even light distribution is formed. As used herein, a “relatively even light distribution” may refer to a light distribution that is relatively consistent in intensity and/or wavelength, a light distribution that allows relatively even irradiation of a material to be cured and/or a light distribution that allows substantially even curing of the material to be cured. In an embodiment, a relatively even light distribution may be formed by positioning two or more adjacent LED devices such that light emitted by the devices overlaps at a surface of and/or within the bulk of the material to be cured. In another embodiment, a relatively even light distribution may be formed by positioning two or more non-adjacent LED devices such that light emitted by the devices overlaps at a surface of and/or within the bulk of the material to be cured.

In some embodiments, a desired light pattern may include an uneven light distribution. As used herein, an “uneven light distribution” may refer to a light distribution that is relatively uneven in intensity and/or wavelength, a light distribution that allows relatively uneven irradiation of a material to be cured and/or a light distribution that allows substantially uneven curing of the material to be cured. For example, in some embodiments, it may be desirable to cure or partially cure a portion of the lens forming composition before curing the remainder of the lens forming composition. An uneven light distribution may be formed by positioning one or more LED devices in a non-uniform manner. In certain embodiments, an uneven light distribution may be formed by a light source in which one or more LED are uniformly positioned, but non-uniformly powered. For example, one or more LED devices may not be activated while other LED devices are activated. In some embodiments, two or more LED devices may be activated at different power levels. An uneven light distribution may also be formed by a light source including two or more different types of LED devices. For example, a light source may include a first type of LED device configured to emit light having a first light distribution and a second type of LED device configured to emit light having a second light distribution. In such a case, an uneven light distribution may be formed by powering one or more first LED devices and one or more second LED devices such that the desired light pattern is formed.

In some embodiments, it may be desirable to direct activating light toward a mold assembly in more than one light distribution pattern. For example, light having a first intensity and/or wavelength distribution may be used to initiate curing of a lens forming composition disposed in the mold cavity of the mold assembly, and light having a second intensity and/or wavelength distribution may be used to complete curing of the lens forming composition. To achieve multiple light distribution patterns, two or more different types of LED devices may be used to form the light source. For example, a light source may be formed using a plurality of first LED devices and a plurality of second LED devices. The first and second LED devices may be configured to emit light having different wavelength distributions and/or intensity distributions. Thus, by powering the first LED devices, light having a first wavelength and/or intensity distribution may be generated. By powering the second LED devices, light having a second wavelength and/or intensity distribution may be generated. In an embodiment, the first and second LED devices may be distributed over the light source such that either may irradiate substantially an entire surface of and/or the bulk of the material to be cured simultaneously.

Curing with one or more LED light sources may provide unexpected advantages. For example, in some embodiments, curing with one or more LED light sources may be used to inhibit premature release of bifocal lenses (e.g., flat-top bifocal lenses) from molds during curing. In certain embodiments, polymerization of a lens forming composition in a first portion of a mold assembly (e.g., the front portion of a near vision correction zone of a bifocal lens) is initiated before a lens forming composition in a second portion of the mold assembly (e.g., the back portion of a far vision correction zone of the bifocal lens proximate the back mold member) is substantially gelled. For example, this may be achieved by irradiating the front mold with activating light prior to irradiating the back mold with activating light, causing the polymerization reaction to begin proximate the front mold and progress toward the back mold. It is believed that irradiation in this manner causes the lens forming composition in the front portion of the near vision correction zone to gel before the lens forming composition proximate the back mold gels. After the polymerization is initiated, activating light may be directed at either mold or both molds to complete the polymerization of the lens forming composition.

In some embodiments, the incidence of premature release of bifocal lenses may be reduced if a front portion of a near vision correction zone is gelled before gelation of the lens forming composition extends from a back mold member to a front mold member. In certain embodiments, polymerization of a lens forming composition may be initiated by irradiation of a back mold, causing gelation to begin proximate the back mold and progress toward the front mold. To reduce the incidence of premature release, the front mold may be irradiated with activating light before the gelation of the lens forming composition in the far vision correction zone reaches the back mold. After polymerization is initiated in the front portion of the near vision correction zone, activating light and/or heat may be directed at either mold or both molds to complete the polymerization of the lens forming composition.

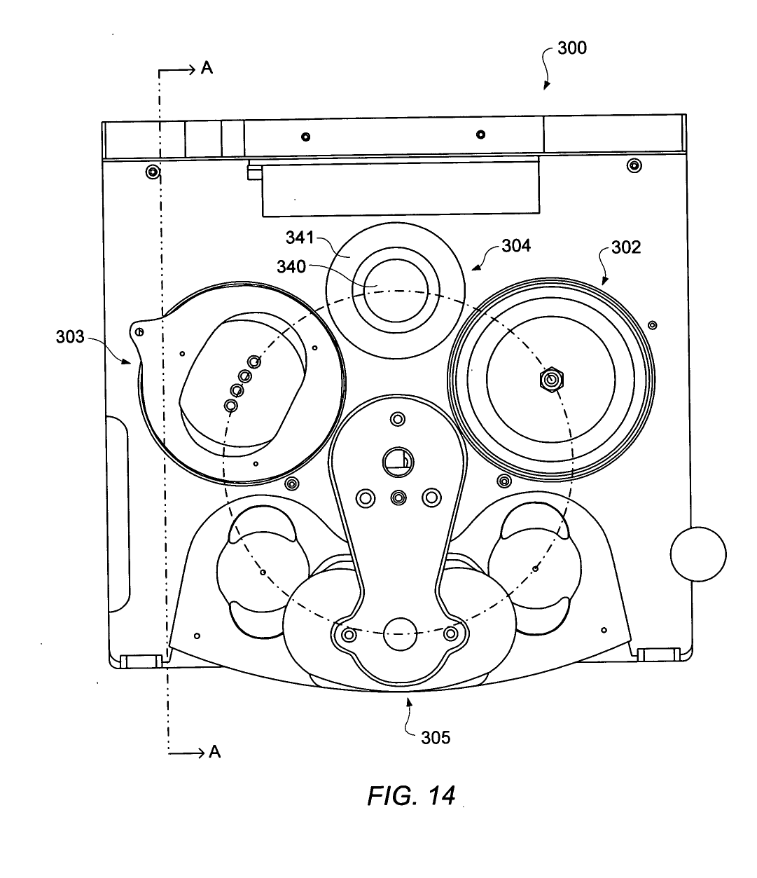

An embodiment of a coating apparatus is shown and described with reference to FIG. 14. In general, a coating apparatus may be configured to apply one or more coating compositions to a lens mold or an eyeglass lens. As used herein, a “coating composition” refers to a polymerizable composition used to form a coating layer on a substrate. As used herein the term “substrate” refers to a material to which a polymerized coating is applied. Examples of substrates include, but are not limited to, eyeglass lenses, eyeglass blanks, and mold members. A coating apparatus may include a plurality of process units and at least one transport device. Operation of the process units and at least one transport device may be controlled by a controller. The plurality of process units may include at least one coating process unit and at least one curing process unit. In addition, the process units may include one or more cleaning process units. A transport device may include a rotation device. The rotation device may be configured to rotate a substrate holder coupled thereto.

Turning to FIG. 14, a perspective side view of an embodiment of a coating apparatus is depicted, and generally referenced by numeral 300. Coating apparatus 300 includes a transport device 305, a coating process unit 303, and a curing process unit 304. Additionally, coating apparatus 300 may include a cleaning process unit 302.

In an embodiment, as depicted in FIG. 14, a curing process unit 304 of coating apparatus 300 may include at least one activating light source 340. Activating light source 340 may be an LED light source as described above. In an embodiment, LED light source may be configured to produce either continuous activating light or pulses of activating light. The activating light dosage used to cure the coating composition may be controlled by controlling the intensity of light applied, the wavelength of light applied and/or the duration of the light applied by the LED light source. For curing using pulses of activating light the frequency of activating light flashes, the duration of activating light flashes and/or the number of activating light flashes collectively produced by the LED light source may be controlled to cure the coating composition. In an embodiment, a curing process unit may also include an enclosure 341. In an embodiment, enclosure 341 may be configured to shield at least a portion of the activating light from coating process unit 303. Additionally, enclosure 341 may shield at least a portion of the activating light from an operator using coating apparatus 300. In some embodiments, transport device 305 may be configured to rotate a substrate disposed in the curing process unit while it is exposed to activating light. Rotating the substrate during curing may help to ensure even exposure of the substrate to the activating light produced by the LED. In an embodiment, where the LED light source is configured to produce flashes of activating light, transport device 305 may be configured to rotate the substrate between flashes of activating light. For example, the substrate may be rotated up to 180 degrees between activating light flashes to ensure even exposure of the coating composition. Further details regarding the operation and use of a coating apparatus may be found in U.S. patent application Ser. No. 10/098,736.

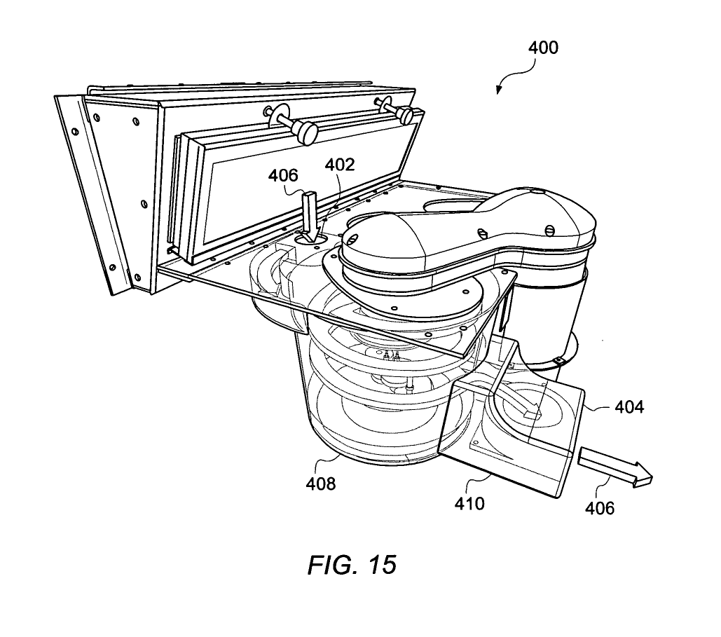

FIG. 15 depicts a perspective view of air distribution system 400 for a spin coating unit. Air distribution system 400 may be used to pass air over the mold members and or lenses during a coating process. As shown in FIG. 15, air distribution system 400 may include opening 402 for air intake. Air pulled into opening 402 may be circulated through air distribution system 400 by, for example, a fan. Arrows 406 indicate airflow in air distribution system 400. As indicated by arrows 406, air may flow through chamber 408 of air distribution system 400 in a spiral pattern and flow through tapered portion 410 before exiting from opening 404. Opening 404 may be directed toward mold members or lenses during a coating process.

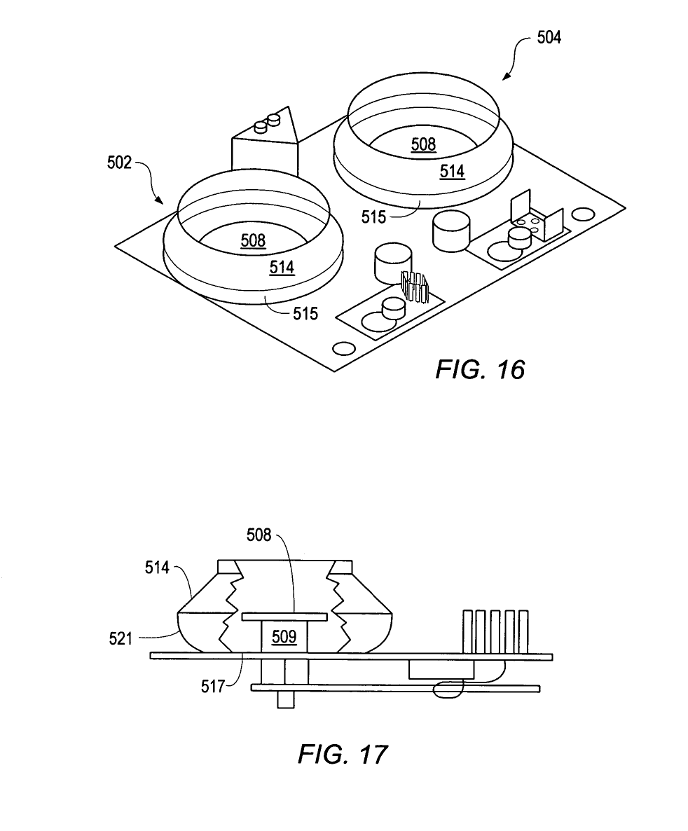

FIGS. 16 and 17 depict a pair of spin coating units 502 and 504. These spin coating units may be used to apply a coating to a substrate (e.g., an eyeglass lens or a mold member). Each of the coating units includes an opening through which an operator may apply lenses and lens mold assemblies to a holder 508. Holder 508 may be partially surrounded by barrier 514. Barrier 514 may be coupled to a dish 515. As shown in FIG. 17, the dish edges may be inclined to form a peripheral sidewall 521 that merges with barrier 514. The bottom 517 of the dish may be substantially flat. The flat bottom may have a circular opening that allows an elongated member 509 coupled to lens holder 508 to extend through the dish 515.

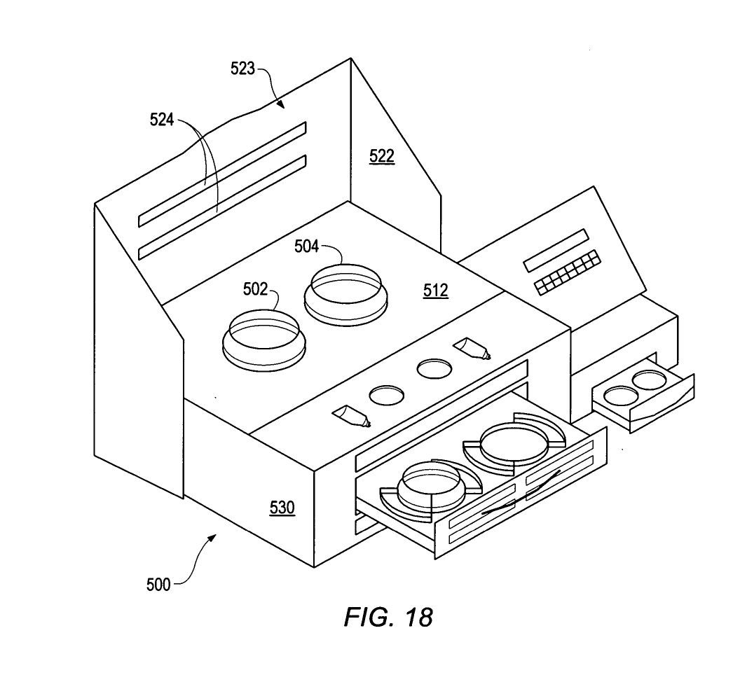

Coating units 502, 504, in one embodiment, are positioned in a top portion 512 of a lens forming apparatus 500, as depicted in FIG. 18. A cover 522 may be coupled to body 530 of the lens forming apparatus to allow top portion 512 to be covered during use. A light source 523 may be positioned on an inner surface of cover 522. The light source may include at least one LED light source 524, preferably two or more LED light sources, positioned on the inner surface of cover 522. LED light sources 524 may be positioned such that the LED light sources are oriented above the coating units 502, 504 when cover 522 is closed. LED light sources 524 emit activating light upon the substrate positioned within coating units 520. LED light sources may have a variety of shapes including, but not limited to, linear (as depicted in FIG. 18), square, rectangular, circular, or oval. LED light sources are selected to emit light having a wavelength that will initiate curing of various coating materials. For example, most currently used coating materials may be curable by activating light having wavelengths in the ultraviolet region, therefore the LED light sources should exhibit strong ultraviolet light emission. Further details regarding spin coating units that may incorporate LED light sources can be found in U.S. Pat. No. 6,416,307 to Buazza et al.

One advantage of lenses which are surfaced from semi-finished lens blanks is that the lens thickness can be readily adjusted by controlling the amount of lens material that is ground and polished away during the surfacing operation. In the case of lenses formed directly to a desired prescription during the lens casting or lens molding operation, the thickness of the resultant lens is controlled by the spacing between the front and back molds. The spacing between the two molds may be controlled by the mold spacing features of a gasket used to form the mold assembly or by other means such as a mold taping system.

Such systems wherein lenses are cast directly to a desired prescription may utilize lookup charts to determine the appropriate molds and gaskets to form a mold assembly based upon a desired lens prescription. Such systems may use a series of gaskets with various mold spacing geometries to control the spacing between the front and back molds and thereby control the thickness of the resultant lens. Such lookup charts may be stored in a computer database or they may be manually accessed.

A disadvantage of using lookup charts is that the lookup charts may only provide a single gasket selection or mold spacing for a particular lens prescription. Another disadvantage of using look-up charts, is that look-up charts cannot allow for variation in the sagittal height of individual concave molds of the same target specification due to mold manufacturing tolerances. The gasket selection used for a particular lens prescription determines the spacing between the two molds called for and thereby controls the thickness of the lens produced from the mold assembly. However, the mold spacing of such a system is constrained by certain physical and spatial limitations such as that the two molds used cannot occupy the same space and generally should not contact one another. Also, the prescribed axis of a particular prescription may affect the mold spacing required to inhibit front and back molds from contacting each other. In certain cases, it may be desirable to alter the mold spacing and thereby increase or decrease the thickness of the resultant lens. For example, certain rimless frame styles utilize a nylon monofilament mounting system wherein the lens is attached to the frame via the use of a monofilament attached to the frame at two points that pass through a groove cut into the outer circumference of the lens. Sufficient lens edge thickness must be provided to allow the formation of this groove. Further, some rimless frame styles may utilize a drill-mount system wherein holes are drilled through the lens and the lens is mounted to the frame using screws and nuts. Lenses mounted in such drill-mount frame styles must possess sufficient thickness at the hole positions to provide enough mechanical strength such that the lens will not crack at the mounting point during normal use. In certain other cases, it may be desirable to reduce the mold spacing to provide a lens that is thinner, lighter, and more cosmetically attractive. In certain other cases, it may be desirable to increase the thickness of the lens to provide for increased impact resistance, e.g., in the case of lenses used for safety eyeglasses.

For lens surfacing technologies, computer software programs exist which can predict the thickness of an eyeglass lens at any point along its surface, given topographic information about the front and back surfaces of the lens. These programs may be integrated with information about the size and shape of a frame and the location of the optical axis of the eyeglass lens relative to the frame and can be used to predict the thickness of the lens at any point on the lens, along the edge of the lens, or along the edge of the lens machined to fit to the frame. This information can then be compared to a desired lens thickness criteria and the amount of lens material, e.g. lens thickness, to be removed from the semi-finished lens blank during the surfacing operation can be determined.

For lens casting technologies where the lens is cast or molded directly to its desired prescription, there is an unmet need for a system and method of variably adjusting the spacing between the molds in a mold assembly to meet various manufacturing specifications.

In some embodiments, a substantially automated method for determining the appropriate mold members and an appropriate mold member spacing based on a provided prescription information and lens criteria is described. Forming a lens that is substantially closer to a final desired product may reduce time spent and costs associated with using a technician to finish the lens. A system and/or method that determine the appropriate mold members and spacing to produce a lens that more closely resembles the desired final product may be advantageous by saving time and overhead.

In some embodiments, a method may include using a computer system to perform at least a portion of the described method. A computer system performing a portion of the method may facilitate substantially automating at least a portion of the method. Automating portions of the method may increase the reproducibility and reliability of selecting an appropriate mold member spacing and/or mold members for manufacturing a specific lens. In some embodiments, a computer system capable of carrying out the described method may include software written for such a purpose. A computer system may be a local computer system, including, but not limited to, a personal computer. Other embodiments may include remote systems or two or more computers connected over a network.

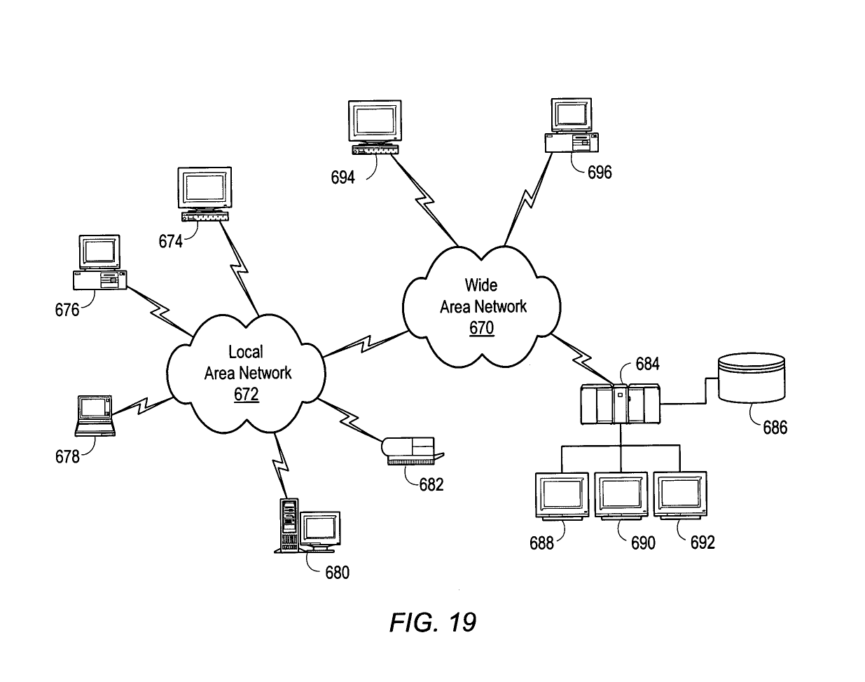

FIG. 19 illustrates a wide area network (“WAN”) according to one embodiment. WAN 670 may be a network that spans a relatively large geographical area. The Internet is an example of a WAN. WAN 670 typically includes a plurality of computer systems that may be interconnected through one or more networks. Although one particular configuration is shown in FIG. 19, WAN 670 may include a variety of heterogeneous computer systems and networks that may be interconnected in a variety of ways and that may run a variety of software applications.

One or more local area networks (“LANs”) 672 may be coupled to WAN 670. LAN 672 may be a network that spans a relatively small area. Typically, LAN 672 may be confined to a single building or group of buildings. Each node (i.e., individual computer system or device) on LAN 672 may have its own CPU with which it may execute programs, and each node may also be able to access data and devices anywhere on LAN 672. LAN 672, thus, may allow many users to share devices (e.g., printers) and data stored on file servers. LAN 672 may be characterized by a variety of types of topology (i.e., the geometric arrangement of devices on the network), of protocols (i.e., the rules and encoding specifications for sending data and whether the network uses a peer-to-peer or client/server architecture), and of media (e.g., twisted-pair wire, coaxial cables, fiber optic cables, and/or radio waves).

Each LAN 672 may include a plurality of interconnected computer systems and optionally one or more other devices such as one or more workstations 674, one or more personal computers 676, one or more laptop or notebook computer systems 678, one or more server computer systems 680, and one or more network printers 682. As illustrated in FIG. 19, an example of LAN 672 may include at least one of each of computer systems 674, 676, 678, and 680, and at least one printer 682. LAN 672 may be coupled to other computer systems and/or other devices and/or other LANs 672 through WAN 670.

One or more mainframe computer systems 684 may be coupled to WAN 670. As shown, mainframe 684 may be coupled to a storage device or file server 686 and mainframe terminals 688, 690, and 692. Mainframe terminals 688, 690, and 692 may access data stored in the storage device or file server 686 coupled to or included in mainframe computer system 684.

WAN 670 may also include computer systems connected to WAN 670 individually and not through LAN 672 such as, for purposes of example, workstation 694 and personal computer 696. For example, WAN 670 may include computer systems that may be geographically remote and connected to each other through the Internet.

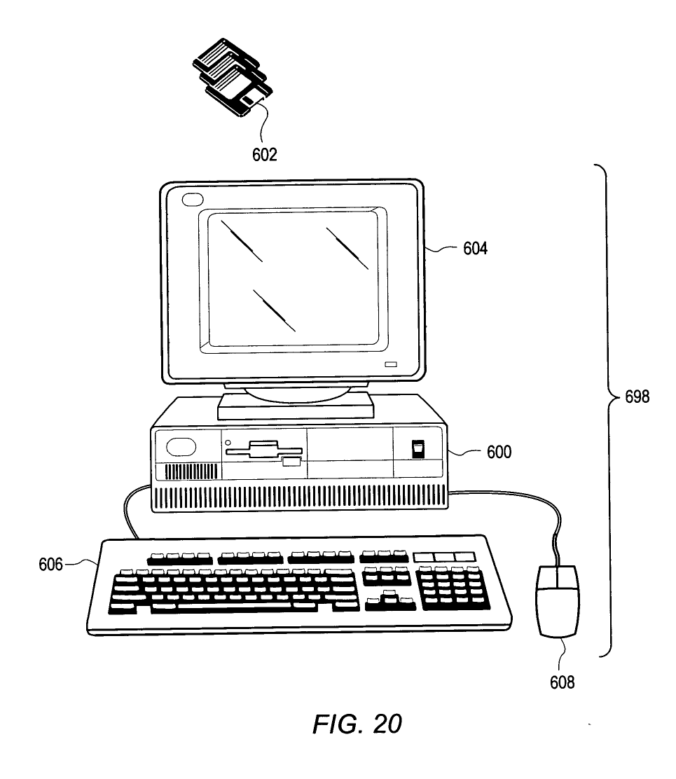

FIG. 20 illustrates an embodiment of computer system 698 that may be suitable for implementing various embodiments of a system and method for determining the appropriate mold member spacing to produce a desired lens. Each computer system 698 typically includes components such as CPU 600 with an associated memory medium such as floppy disks 602. The memory medium may store program instructions for computer programs. The program instructions may be executable by CPU 600. Computer system 698 may further include a display device such as monitor 604, an alphanumeric input device such as keyboard 606, and a directional input device such as mouse 608. Computer system 698 may be operable to execute the computer programs to implement a method for determining the appropriate mold member spacing as described herein.

Computer system 698 may include memory medium on which computer programs according to various embodiments may be stored. The term “memory medium” is intended to include an installation medium, e.g., a CD-ROM, or floppy disks 602, a computer system memory such as DRAM, SRAM, EDO RAM, Rambus RAM, etc., or a non-volatile memory such as a magnetic media (e.g., a hard drive or optical storage). The memory medium may also include other types of memory or combinations thereof. In addition, the memory medium may be located in a first computer that executes the programs or may be located in a second, different computer that connects to the first computer over a network. In the latter instance, the second computer may provide the program instructions to the first computer for execution. In addition, computer system 698 may take various forms such as a personal computer system, mainframe computer system, workstation, network appliance, Internet appliance, personal digital assistant (“PDA”), television system, or other device. In general, the term “computer system” generally refers to any device having a processor that executes instructions from a memory medium.

The memory medium may store a software program or programs operable to implement a method for optimizing a mold assembly. The software program(s) may be implemented in various ways, including, but not limited to, procedure-based techniques, component-based techniques, and/or object-oriented techniques, among others. For example, the software program(s) may be implemented using ActiveX controls, C++ objects, JavaBeans, Microsoft Foundation Classes (“MFC”), browser-based applications (e.g., Java applets), traditional programs, or other technologies or methodologies, as desired. A CPU such as host CPU 600 executing code and data from the memory medium may include a means for creating and executing the software program or programs according to the methods and/or block diagrams described herein.

In some embodiments, a method for forming a lens may include a method for selecting appropriate mold spacing for forming a lens. An appropriate mold spacing may be a spacing that results in the formation of a lens that is optimized for a specific use and/or frame.

Desired mold spacing may be achieved by using any of a number of devices known to one skilled in the art capable of effectively separating the edges of mold members used in lens formation. In some embodiments, a spacer may include a gasket. In some embodiments, a spacer may include a sleeve. In some embodiments, a spacer may include a tape system.

An embodiment of an apparatus for preparing an eyeglass lens may include a coating unit and a lens-curing unit. The coating unit may be configured to coat either mold members or lenses. In one embodiment, the coating unit is a spin coating unit. The lens-curing unit may be configured to direct activating light toward one or both mold members. The mold members are part of a mold assembly that may be placed within the lens-curing unit. Depending on the type of lens forming composition used, the apparatus may be used to form photochromic and non-photochromic lenses. The apparatus may be configured to allow the operation of both the coating unit and the lens-curing unit substantially simultaneously.

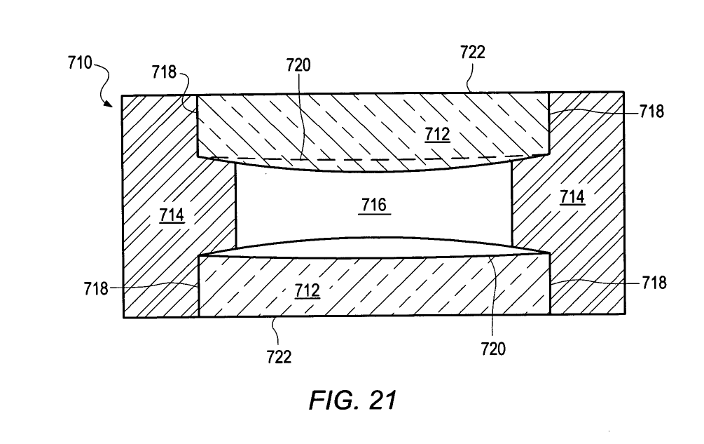

FIGS. 21-24 depict different embodiments of general mold assemblies including mold members and specifically gaskets being used as spacers. As shown in FIG. 21, the mold assembly 710 may include opposed mold members 712, separated by an annular gasket 714 to define a lens molding cavity 716. The opposed mold members 712 and the annular gasket 714 may be shaped and selected in a manner to produce a lens having a desired prescription.

Mold members 712 for use in activating light curing systems may be formed of any suitable material that will permit the passage of activating light. For example, mold members 712 may be formed of glass. Mold members may also be formed from metal. Metal mold members may be used for thermal curing systems or for activating light curing systems, where only one of the molds transmits activating light. Each mold member 712 has an outer peripheral surface 718 and a pair of opposed surfaces 720 and 722 with at least one of the surfaces 720 and 722 being precision ground. Mold members 712 may have desirable activating light transmission characteristics and both the casting surface 720 and non-casting surface 722 may have no surface aberrations, waves, scratches or other defects as these may be reproduced in the finished lens.

As noted above, the mold members 712 may be adapted to be held in spaced apart relation to define a mold cavity 716 between the casting surfaces 720 thereof. Mold members 712 may be held in a spaced apart relation by a flexible annular gasket 714 that seals the mold cavity 716 from the exterior of the mold members 712. By selecting the mold members 712 with a desired surface 720, lenses with different characteristics, such as focal lengths, may be produced.

Rays of activating light emanating from lamps may pass through the mold members 712 and act on a lens forming material disposed in the mold cavity 716 in a manner discussed below so as to form a lens. The rays of activating light may pass through a suitable filter before impinging upon the mold assembly 710.

The annular gasket 714 may be formed of vinyl material that exhibits good lip finish and maintains sufficient flexibility at conditions throughout the lens curing process. In some embodiments, the annular gasket 714 is formed of silicone rubber material such as GE SE6035 which is commercially available from General Electric. In certain embodiments, the annular gasket 714 is formed of copolymers of ethylene and vinyl acetate which are commercially available from E.I. DuPont de Nemours & Co. under the trade name ELVAX7. ELVAX7 resins may include ELVAX7 350 having a melt index of 17.3-20.9 dg/min and a vinyl acetate content of 24.3-25.7 wt. %, ELVAX7 250 having a melt index of 22.0-28.0 dg/min and a vinyl acetate content of 27.2-28.8 wt. %, ELVAX7 240 having a melt index of 38.0-48.0 dg/min and a vinyl acetate content of 27.2-28.8 wt. %, and ELVAX7 150 having a melt index of 38.0-48.0 dg/min and a vinyl acetate content of 32.0-34.0 wt. %. In some embodiments, the gasket may be made from polyethylene. In some embodiments, a gasket may be formed from a thermoplastic elastomer rubber. An example of a thermoplastic elastomer rubber that may be used is, DYNAFLEX G-2780 commercially available from GLS Corporation. Regardless of the particular material, the gaskets 714 may be prepared by conventional injection molding or compression molding techniques which are well-known by those of ordinary skill in the art.

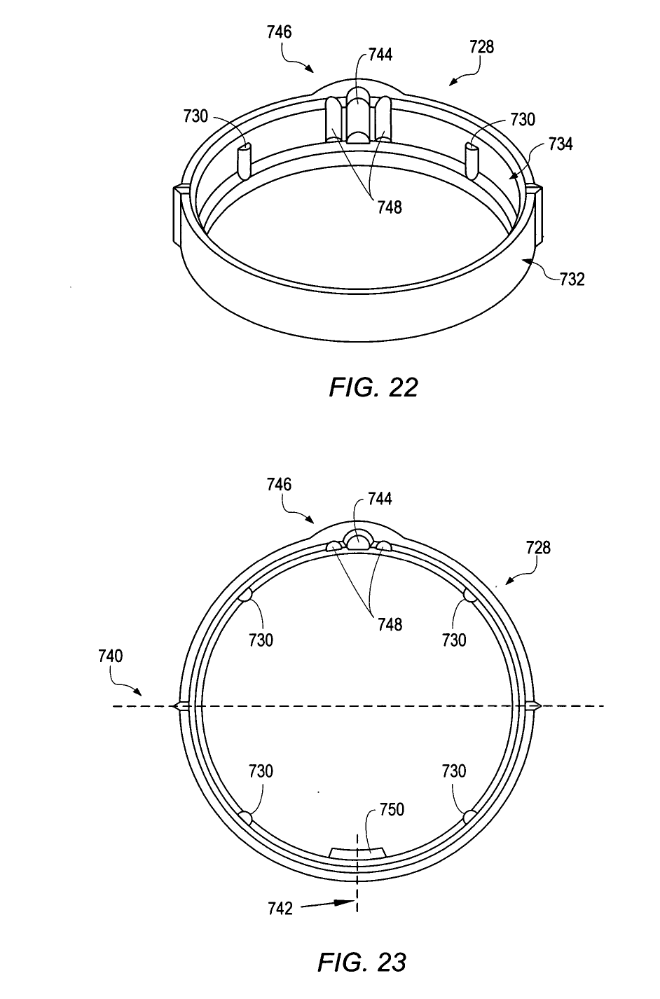

FIGS. 22 and 23 present an isometric view and a top view, respectively, of a gasket 728. Gasket 728 may be annular. Gasket 728 may be configured to engage a mold set for forming a mold assembly. Gasket 728 may be characterized by at least four discrete projections 730. Gasket 728 may have an exterior surface 732 and an interior surface 734. The projections 730 may be arranged upon inner surface 734 such that they are substantially coplanar. The projections may be evenly spaced around the interior surface of the gasket. The spacing along the interior surface of the gasket between each projection may be about 90 degrees. Although four projections are shown, it is envisioned that more than four could be incorporated. For example, a fifth projection may be incorporated into the gasket that may be configured to contact one of the mold members. Gasket 728 may also include a projection 750. Projection 750 may extend from the side of the gasket toward the interior of the mold cavity when a first and second mold are assembled with the gasket. The projection is positioned such that a groove is formed in a plastic lens formed using the mold assembly. The groove may be positioned near an outer surface of the formed lens. In this manner the groove is formed near the interface between the mold members and the formed lens.

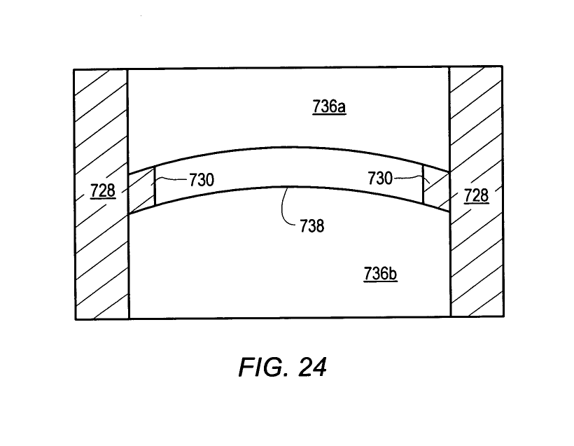

As shown in FIG. 24, projections 730 may be capable of spacing mold members 736 of a mold set. Mold members 736 may be any of the various types and sizes of mold members that are well known in the art. A mold cavity 738 at least partially defined by mold members 736 and gasket 728, may be capable of retaining a lens forming composition. The seal between gasket 728 and mold members 736 may be as complete as possible. The height of each projection 730 may control the spacing between mold members 736, and thus the thickness of the finished lens. By selecting proper gaskets and mold sets, lens cavities may be created to produce lenses of various powers. Further details regarding gaskets can be found in U.S. Pat. No. 6,478,990.

A mold assembly, in some embodiments, includes two mold members, a front mold member 736a and a back mold member 736b, as depicted in FIG. 24. The back mold member is also known as the convex mold member. The back mold member may define the concave surface of a convex lens. Referring back to FIGS. 22 and 23, locations where the steep axis 740 and the flat axis 742 of the back mold member 736b lie in relation to gasket 728 have been indicated. In conventional gaskets, a raised lip may be used to space mold members. The thickness of this lip may vary over the circumference of the lip in a manner appropriate with the type of mold set a particular gasket is designed to be used with. Gaskets such as those described in U.S. Pat. No. 6,698,708, which is incorporated herein by reference, may also be used.

Within a class of mold sets there may be points along the outer curvature of a back mold member where each member of a class of back mold members is shaped similarly. These points may be found at locations along gasket 728, oblique to the steep and flat axes of the mold members. In some embodiments, these points are at about 45 degree angles to the steep and flat axes of the mold members. By using discrete projections 730 to space the mold members at these points, an individual gasket could be used with a variety of mold sets. Therefore, the number of gaskets that would have to be kept in stock may be greatly reduced.

In addition, gasket 728 may include a recession 744 for receiving a lens forming composition. Lip 746 may be pulled back in order to allow a lens forming composition to be introduced into the cavity. Vent ports 748 may be incorporated to facilitate the escape of air from the mold cavity as a lens forming composition is introduced.

A method for making a plastic eyeglass lens using a gasket 728 is presented. The method may include engaging gasket 728 with a first mold set for forming a first lens of a first power. The first mold set may contain at least a front mold member 736a and a back mold member 736b. A mold cavity for retaining a lens forming composition may be at least partially defined by mold members 736a and 736b and gasket 728. Gasket 728 may be characterized by at least four discrete projections 730 arranged on interior surface 734 for spacing the mold members. Engaging gasket 728 with the mold set may include positioning the mold members such that each of the projections 730 forms an oblique angle with the steep and flat axis of the back mold member 736b. In some embodiments, this angle is about 45 degrees. The method may include introducing a lens forming composition into mold cavity 738 and curing the lens forming composition. Curing may include exposing the composition to activating light and/or thermal radiation. After the lens is cured, the first mold set may be removed from the gasket and the gasket may then be engaged with a second mold set for forming a second lens of a second power. The method may include introducing a lens forming composition through a fill port, wherein the first and second mold members remain fully engaged with the gasket during the introduction of the lens forming composition. The lens forming composition may then be cured by use of activating light and/or thermal radiation.

In some embodiments, a method may employ a computer system, as generally described herein, to at least assist in assessing an appropriate or optimized gasket as part of a mold assembly used to manufacture an eyeglass lens. In some embodiments, a computer system may be employed to at least assist in assessing gap shrinkage which occurs during lens formation (e.g., polymerization shrinkage of the lens forming composition).

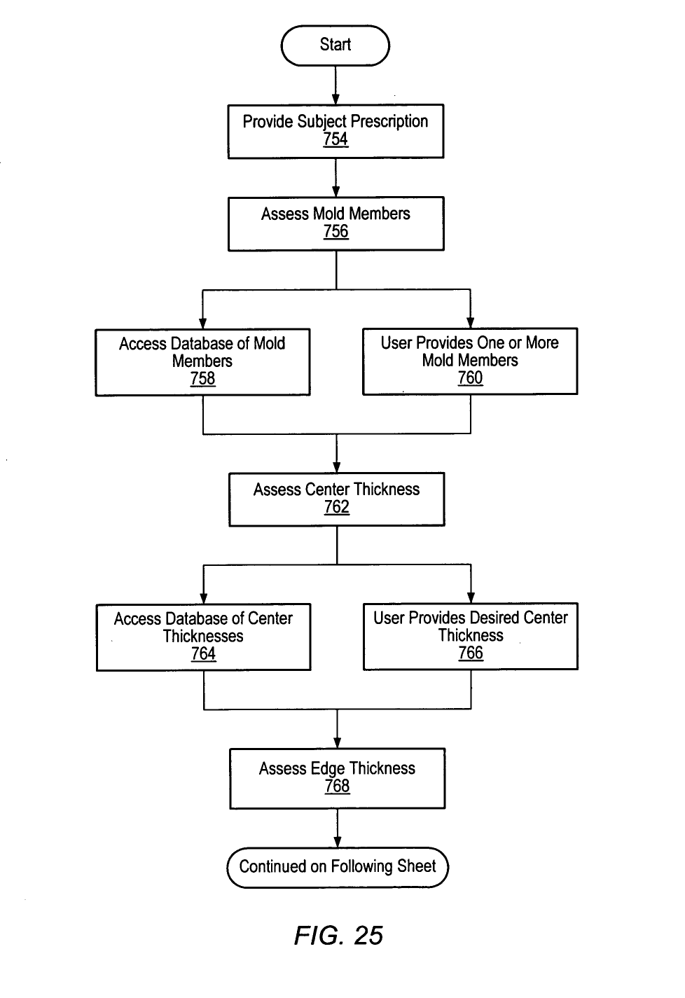

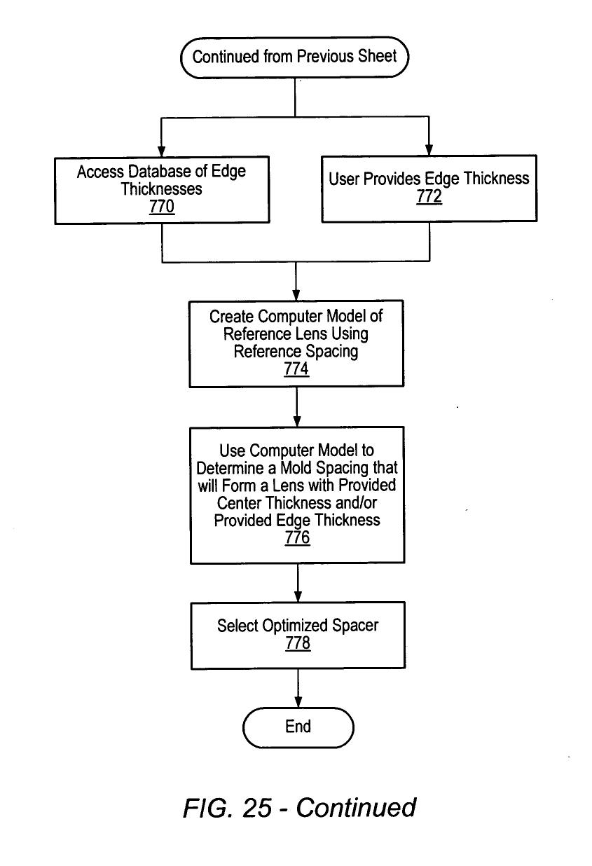

FIG. 25 depicts a flowchart of an embodiment of a method for selecting an optimized mold member spacing for a mold assembly used to form a lens. In some embodiments, a computer system is employed to assist in carrying out a method of determining an optimized mold member spacing for a mold assembly. The computer system may assist in ensuring the method for selecting an optimized mold spacing is at least partially automated. In some embodiments, a computer system may assist in ensuring the method for selecting an optimized mold spacing is fully automated, a user merely having to provide a subject's prescription and/or related data. The flowchart illustrated in FIG. 25 depicting a method for selecting an optimized mold spacing should not be seen as limiting, but merely an embodiment.

In some embodiments, a user may provide a subject's prescription 754 for an eyeglass lens to a computer system. A prescription may include data typically associated with a lens prescription known to one skilled in the art. Prescription data may be entered into the computer in any number of data entry methods associated with a computer system (e.g., keyboard, mouse, voice recognition software, barcode system).

In some embodiments, a method may include determining the appropriate mold members to obtain the inputted prescription 756. The mold members may be used to form part of a mold assembly used in forming lenses. Determining the lens molds may include a computer system accessing a database to select mold members based on a prescription provided to the computer system. The database may be stored locally on the same computer the prescription is entered into and/or the database may be stored remotely in a server where it may be maintained and updated regularly.

In some embodiments, a user may be prompted to enter the mold members. A user may be given an opportunity to select a particular set of mold members or to allow a computer system to select the molds from a database. A user upon accepting the opportunity to select mold members may then provide to the computer system one or more of a set of desired mold picks 760 or may select mold members from a list.

In some embodiments, a user may be prompted to enter a desired center thickness. A user may be given an opportunity to select a center thickness or to allow a computer system to select the center thickness from a database. A user upon accepting the opportunity to select a center thickness may then provide to the computer system a desired center thickness 766. A user may desire to provide a center thickness due to special needs or requirements for one or more lenses. For example, a special requirement may be a greater than normal center thickness for lenses designed to increase the safety factor of the lenses. The lenses may increase safety for the user by for example decreasing the likelihood of a lens shattering when a foreign object impacts said lens.

In some embodiments, a method may use a predetermined center thickness value. To determine the center thickness value, a computer system may access a database to select an appropriate center thickness 764. The database may be stored locally on the same computer the prescription is entered into and/or the database may be stored remotely in a server where it may be maintained and updated regularly. A database may be based on industrial, international, and/or government (e.g., FDA) standards or requirements.

In some embodiments, a governmental agency may dictate or provide guidelines to follow when assessing a particular feature of a lens (e.g., center thickness). For example, the FDA provides guidelines for minimum center thicknesses for lens for manufacturers who wish to sell lens in the United States of America. Other countries may have their own set of guidelines, and a software system as described herein may allow for easy updating of center thickness and other required minimums for specific features of a lens by modification of the database that includes the predetermined center thickness values.

In some embodiments, a method may include step 768 of assessing an edge thickness of the lens to be manufactured. Assessing an edge thickness may include a computer system accessing a database to determine the edge thickness of a lens that would be formed based on data provided to the computer system. Data may include, for example, information typically associated with a prescription for an eyeglass lens and/or type of eyeglass frame selected for the lens. Based on provided data, a computer system may access a database to select an appropriate edge thickness 770. The database may be stored locally on the same computer the data is entered into and/or the database may be stored remotely in a server where it may be maintained and updated regularly (e.g., to keep pace with industrial and/or international standards). Databases may be accessed which include a standardized listing of data describing common frame designs. Frame specifications may be freely shared between major manufacturers to, for example, increase convenience for lens manufacturers. In some instances, a lens manufacturer may use special equipment to measure an eyeglass lens frame three-dimensionally, substantially automatically measuring the eyeglass lens frame.

Frame data may be captured through an interface to a frame manufacturer and/or provider host system. The host system may run a VCA (Vision Council of America) interface. This interface allows for many variants for exchanging data such as binary or ASCII data, absolute or relative measurements, and equal or unequal point spacing for example.

In some embodiments, a computer system may query a user for basic information concerning the frames for a particular lens prescription. For example a frame boxing method may be employed to gather the minimum basic information required by the computer system to assist in determining an appropriate mold spacing required to produce the desired lens. Other data gathered may include, for example, pupillary distance, distance between lenses, vertical offset of multifocal segments, and/or effective blank diameter. A bounding perimeter may be created from at least some of this data.

In some embodiments, a user may be prompted to enter a desired edge thickness. A user may be given an opportunity to select an edge thickness or to allow a computer system to select the edge thickness from a database. A user upon accepting the opportunity to select an edge thickness may then provide to the computer system a desired edge thickness 772. In some embodiments, a user may enter in a desired edge thickness as opposed to a computer system accessing a database. A user may have any number of reasons for wanting to personally enter in a desired edge thickness. For example, a particular frames dimensions may not be available in any accessible databases (for example, it may be a relatively newly available frame and/or produced by relatively small manufacturer which does not provide its frames dimensions). Edge thickness may be very important depending on what types of frame the lens is being manufactured for. For example, rimless frames may require a lens with a greater edge thickness to accommodate the thin monofilaments used to secure the lens to the frame or to provide proper mechanical strength to the lens in the case of a drilled rimless mounted lens.

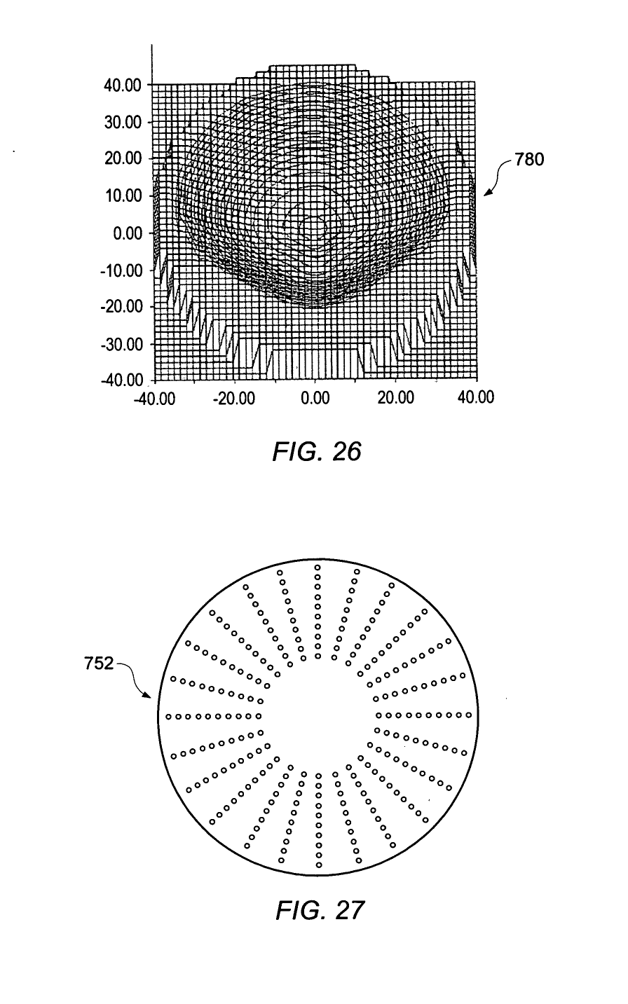

In some embodiments, a method may include assessing a virtual computer model of a lens. A computer model of the lens may be stored in a database without any display of the computer model. Alternatively, the computer model may be displayed (e.g., on a computer monitor). The displayed computer model may appear three-dimensional. The computer model may include forming a virtual data map of the proposed lens to be manufactured. The virtual computer model may be at least based in part on a provided prescription. The virtual model may be assessed based on at least selected mold members in combination with a reference spacing. The combination of the selected mold members in combination with a reference spacing may form a virtual mold assembly. The virtual mold assembly may be a virtual mold assembly from which a computer system may map a virtual lens using stored data concerning the parameters of the mold members and the reference spacing. FIG. 26 depicts a conceptual illustration of a virtual three-dimensional model of a lens 780.

When forming the virtual mold assembly, each mold member may be rendered based on standard information stored in a database. For example, for most mold members the sagittal height may be determined based on the expected curvature of the mold. In some embodiments, however, it has been found that the actual sagittal height of an individual mold member may be different from an expected sagittal height. To compensate for these differences, the sagittal height of a selected mold member may be assessed, e.g., by measuring the sagittal height of the mold member. The assessed value may be input into the computer system. The assessed value may then be used to create a virtual mold assembly.

In some embodiments, a reference spacing may be predetermined and programmed in as part of a software package. In some embodiments, a user may be allowed to select a particular reference spacing. In some embodiments, a reference spacing may be selected such that it is highly unlikely mold members will interfere with one another. A reference spacing may be used which will inhibit substantially any possible combination of mold members from touching in any manner during assembly with the reference spacer to form a virtual mold assembly.

In some embodiments, a reference spacing may be selected to maintain an edge separation between mold members of 18 mm. In some embodiments, a reference spacing may be selected to include a spacer that maintains an edge separation between mold members that is greater than 18 mm. Other reference spacings may maintain an edge separation between mold members of at least 16 mm, at least 14 mm, or at least 10 mm.

A virtual lens may include a mathematically generated thickness map. In some embodiments, to calculate the thickness of a virtual lens at any point, a position of the front mold at any point may be subtracted from the position of the back mold. Specifically, the distance between the casting surface of the front mold member and the casting surface of the back mold member may be determined at various points on the virtual lens. The thickness of a virtual lens may be calculated forming a thickness map that includes the thickness of a virtual lens at a plurality of points on the surface of the mold. The thickness of a lens may be calculated using EQN. 1.
Point Thickness=Point sagittal height of back surface−point sagittal height of front surface+center thickness of lens. (1)
In some embodiments, a standardized method for mapping a front surface of a lens may be used. For example, the VCA standard definition for mapping a front surface of a lens may be used. Mapping a surface of a lens may include starting at the center of the lens and defining this point as the origin of the map. The method may include measuring the sagittal height repeatedly along a plurality of selected lines extending from the center of the virtual lens to the edge of the virtual lens. For example, from along a selected radius, the sagittal height may be measured every 2.5 mm from the center of the virtual lens until the edge of the lens is reached. The thickness may be additionally measured along additional radii at predetermined angles with respect to the initial thickness measurement. This is merely one method that a surface of a lens may be mapped. FIG. 27 depicts an illustration of an embodiment of a method of systematically mapping a surface of a lens 752.

Back mold sagittal heights may be assessed using the radii of the two cross curves. In some embodiments, EQNS. 2 and 3 may be used to assess the sagittal height of a back mold. EQN. 2 depicts a mathematical method of calculating a radius of curvature along any meridian of a Toric Surface.
R_{θ°=(}R_{0°}R₉₀°)/(R₉₀°+(R_{0°}−R₉₀°) Sin²θ) (2)

Where R is the radius of curvature of the surface.

EQN. 3 depicts a mathematical method of calculating a sagittal height at any diameter.
S=R_{θ°}−(R_{θ°}²−(d/2)²)^{0.5} (3)
Where S is the sagital height; d is the chord diameter, and R is the radius of curvature.

In some embodiments, a method may include creating a computer model of a reference lens using a reference spacing 774. Creating a computer model may include creating a virtual data map of a lens. In some embodiments, a computer model may be used to determine the optimal mold spacing. An optimized mold spacing may produce a lens that has the provided center thickness 776. The provided center thickness may be used to appropriately determine the proper mold spacing that will adjust the center thickness of the computer model to give a lens having the desired center thickness. The computer model of the lens may be adjusted by selecting a mold spacing which provides a center thickness closest to the provided center thickness and the computer model adjusted accordingly. Based on the optimized computer model, an optimized mold spacing may be determined 778.

In some embodiments, an optimized mold spacing may produce a lens that has the provided edge thickness 776. The provided edge thickness may be used to appropriately adjust the thickness of the computer model. The thickness of the computer model may be adjusted to the edge thickness of the provided edge thickness. The entirety of the computer model of the lens may be adjusted appropriately based on the provided edge thickness. The computer model of the lens may be adjusted by using a mold spacing that provides an edge thickness closest to the provided edge thickness and the computer model adjusted accordingly. In practice a minimum thickness of the virtual computer model is determined and this is adjusted using the provided edge thickness, followed by appropriately adjusting the rest of the computer model. Based on the optimized computer model, an optimized mold spacing may be determined 778.

In some embodiments, a method may include selecting an optimized mold spacing using only a provided center thickness. In some embodiments, a method may include selecting an optimized mold spacing using only a provided edge thickness. A method may include determining which thickness (e.g., center or edge) can be used when optimizing a virtual computer model of a lens. Determining which thickness to use may be done automatically by a computer system. In some embodiments, a method may include using both a provided edge thickness and a provided center thickness. The method may include optimizing a computer model of a lens using the two provided thicknesses and the prescription information, thus providing two separately optimized computer models. The two optimized mold spacings may result from using the two provided thicknesses as described herein. In some embodiments, one of the two optimized mold spacings is selected from the two optimized mold spacings. A computer system may automatically select one of the mold spacings. In some embodiments, the larger of the two mold spacings may be selected by a computer system. Selecting the larger of the two mold spacings may ensure that the final manufactured lens has the appropriate thickness and that the mold members will not contact each other when the mold assembly is assembled.

In some embodiments, a computer model of a reference lens may be created. The computer model may be created using a predetermined reference mold spacing and selected mold members. The computer model of the reference lens may be used to determine the mold spacing that will produce a lens that has the provided center thickness. The method may include creating a computer model of a first lens. The first lens may include a lens that would be formed using a first mold spacing and the selected mold members. In some embodiments, a computer model of a reference lens may be used to determine the properties of a second mold spacing that will produce a lens that has the provided edge thickness. The method may include creating a computer model of a second lens. The second lens may include a lens that would be formed using a second mold spacing and the selected mold members. In some embodiments, a method may include comparing the first mold spacing and the second mold spacing using the computer system to select an optimized mold spacing. In some embodiments, the optimized mold spacing may be chosen based on the relative size of the first and second mold spacings. The optimized mold spacing may be chosen by selecting the larger of the first and second mold spacings.

As has been generally discussed a virtual lens created by a computer system using the selected optimized mold spacing must meet several requirements. Center thickness, edge thickness, and frame boundary have already discussed herein. In some embodiments, a method of selecting an optimized mold spacing may include assessing minimum cross sections of theoretical channels formed in a virtual mold assembly using the optimized mold spacing. The method may include automatically checking a particular cross section over a portion of a virtual mold assembly to inhibit any problems (e.g., molds physically contacting each other) from arising when the actual mold assembly is filled with monomer during formation of a lens. A minimum cross sectional area may be predetermined and set within a software program package. In some embodiments, a user may be allowed to determine what is an acceptable minimum cross sectional area. The method may include automatically compensating for any assessed cross sectional area problems by, for example, increasing the size of a selected optimized mold spacing appropriately.

In some embodiments, a method for selecting an optimized mold spacing may include compensating for shrinkage of a monomer during the actual lens manufacturing process. An air gap may be divided by a known shrinkage factor (e.g., 0.95). For different prescriptions where the thickness of the lens varies significantly, different shrinkage factors may be used for different areas of the lens.

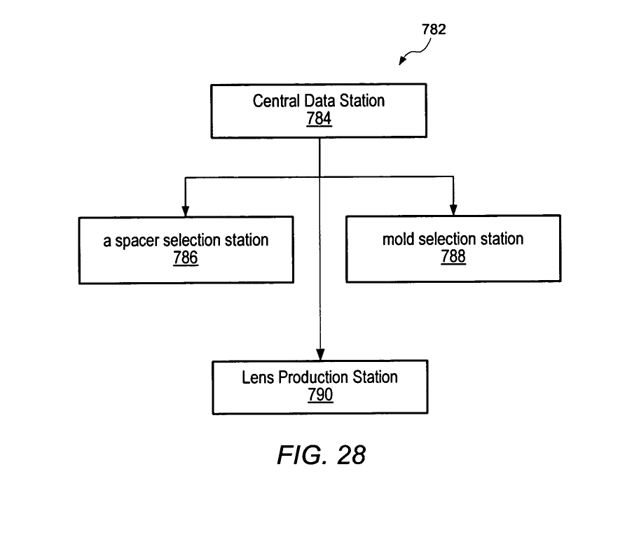

The methods and systems for optimizing mold spacing have so far been discussed in isolation from other systems. In some embodiments, the method discussed herein may be incorporated into a lens manufacturing method and system. FIG. 28 depicts a flowchart of an embodiment of lens manufacturing system 782. Lens manufacturing system 782 may include a central data station 784, a spacer selection station 786, a mold selection station 788, and a lens production station 790.

In some embodiments, two or more of the stations 784-790 of lens manufacturing system 782 may include a computer system. The computer systems may be interconnected. One or more of the computer systems of the stations 784-790 may be connected to an intranet, the Internet, and/or a laboratory network.

In some embodiments, central data station 784 may function to carry out a method as described herein for selecting a mold spacing that is appropriate for manufacturing a lens with a desired center and/or edge thickness. The central data station may be located in or near a lens manufacturing area and may receive orders for lenses based on prescriptions and derived from methods described herein. The central data station may include a printer. The central data station may include multiple input devices (e.g., keyboard, mouse, scanner). The printer may print lens orders or “job tickets” outlining one or more necessary to produce a lens based on a subject's provided prescription. Job tickets may include bar codes which may be read by a scanner increasing efficiency of lens production by reducing time required to input specifics from a job ticket into a lens production or a particular portion of a lens production system.

A spacer selection station 786 may function in combination with central data station 784. In some embodiments, a spacer selection station may include a computer system as well as a scanner. The scanner may be used to read a job ticket produced by central data station 784. Scanners are frequently used throughout the description as an input device but should not be seen as limiting, multiple input devices known to one skilled in the art may be employed to achieve similar results. Prescription information from a job ticket in combination with mold sag gages may be used to determine an appropriate mold spacing. In some embodiments, a spacer selection station may merely direct a user to an appropriate spacer based on the job ticket, the spacer determined using databases (e.g., VCA databases) in combination with methods described herein.

A mold selection station 788 may include a computer system, a scanner, and/or a mold reader. The mold selection station may function to direct a user to one or more appropriate mold members (typically two mold members) based on the job ticket and the spacer determined using databases (e.g., VCA databases) in combination with methods described herein. The scanner may read a job ticket, alerting the computer system which mold members are necessary to complete the order. A mold storage system, as described in U.S. patent application Ser. No. 10/098,736, may then direct a user to the appropriate mold members. In some embodiments, a mold selection station may include a mold reader with which to confirm the chosen mold members are the appropriate choice.

A lens production station 790 may include a computer system, a scanner, and/or a curing unit (e.g., a high volume curing unit). The scanner may read a job ticket, alerting the computer system which curing unit should be used and/or what conditions are necessary to manufacture and cure one or more lenses according to a prescription. The system may then direct a user to the appropriate curing unit. The cure oven may be automatically programmed by the computer system with the appropriate conditions necessary to produce the required lens. Conditions necessary may be included in the job ticket or derived by the computer system from the job ticket.

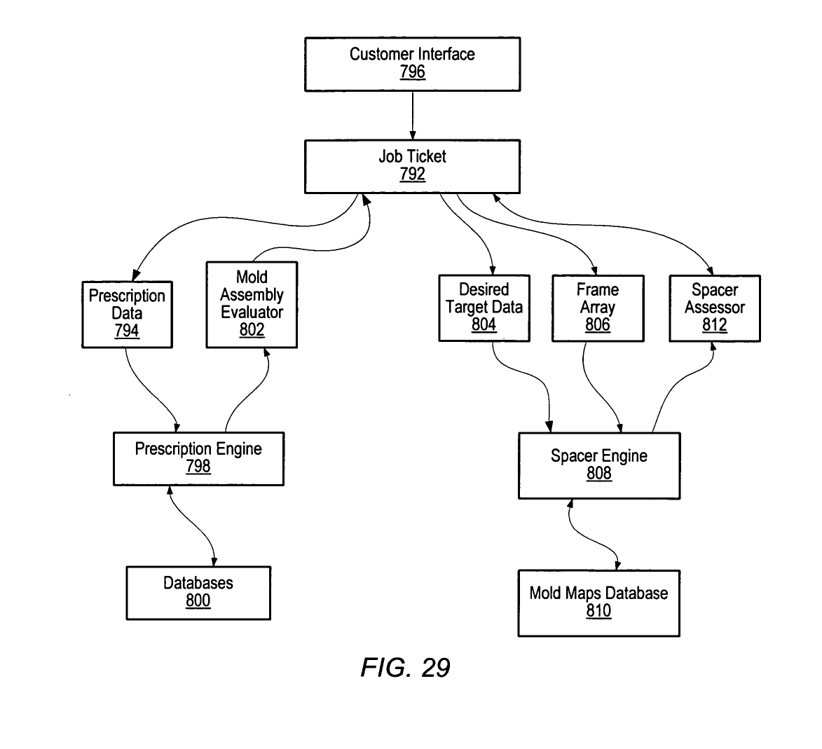

FIG. 29 depicts a flowchart of an embodiment of data flow based on a method of selecting spacers as used in manufacturing lenses. Data may be stored on a job ticket 792. A job ticket may be a printed job ticket or may be saved in an electronic form. Job ticket 792 is a non-limiting example of a data transfer mechanism, there are countless other examples know to one skilled in the art able to accomplish similar ends. In some embodiments, job ticket 792 may include prescription data 794. Prescription data 794 may be transferred from a customer through a customer interface 796. The customer interface may be based upon an industry standardized interface such as a VCA (“Vision Counsel of America) based interface. Prescription data 794 may be transferred to a prescription engine 798. A prescription engine may include a computer system or software program capable of determining mold members and/or reference spacers for example from the prescription data. The prescription engine may access one or more databases 800. Databases 800 may include mold member databases and spacer databases. Reference spacers may be determined using database 800. Mold members may be determined using databases 800 and the prescription data. Mold assembly evaluator 802 may function to assess availability of mold members and spacers within current and accessible inventory determined using databases 800. Mold and spacer status may be stored on a job ticket 292.

In some embodiments, data stored on a job ticket 792 may include a list of possible mold members (e.g., determined from mold assembly evaluator 802) as well as desired target data 804. Desired target data 804 may include, for example, a desired center and/or edge thickness provided by a user. Data stored on a job ticket 792 may include a desired frame input by a user which may be transferred to a frame array 806. Frame array 806 may include a database and/or means for access to databases containing standardized dimensions and specifications for known lens frames. Frame array 806 may include means for a user to input and determine at least basic dimensions for a frame not found in an accessible database. Data 804 and/or 806 may be transferred to a spacing engine 808. Spacing engine 808 may determine an appropriate spacer based upon provided data. Determining an appropriate spacer may include determining the properties of a spacer that will produce a lens that has at least one of a provided center thickness or edge thickness. During determination, spacer engine 808 may access a mold maps database 810 to assist in determining an appropriate spacer. A mold map may have been previously generated for the same or a similar prescription and frame. In some embodiments, a mold map generated with the spacer engine may be stored in the mold maps database for future reference.

Upon determination of an appropriate spacer, a spacer assessor 812 may function to assess availability of appropriate spacers within current and accessible inventory. In some embodiments, if an appropriate spacer is not currently available the spacer assessor may denote this fact and offer an alternative spacer that is available. Some or all of this information may be stored on job ticket 792.

Traditional plastic resins doped with a wide range of nanoparticles, wires, or tubes have been shown to form composites with modified mechanical, electrical, and optical properties. Spectral reflectance from an uncoated substrate has been lowered by coating the substrate with multi-layered thin film coatings. These antireflective coatings have applications in ophthalmic lenses, solar cells, data storage, and other optical devices that require a reduced reflectance for an increase in optical efficiency. Oliviera et al. produced an antireflective effect using a sol-gel derived coating with tunable refractive indices and improved mechanical performance. Other researchers have developed thin film coatings using nanoparticles for improved abrasion resistance. The spin coating method to deposit hybrid polymer nanoparticle composites, allowing simple, low cost deposition of thin films, has been widely studied. Yu et al. produced thin films on the order of several microns using a colloidal silica and acrylic monomer cured in the presence of heat.

In some embodiments, doping polymers (e.g., plastic resins) with a variety of nanoparticles may result in a nanocomposite having nanomaterials dispersed in a polymer matrix. As used herein “nanomaterials” refers to nanoparticles, nanospheres, nanowires, and nanotubes. As used herein, “nanoparticle” refers to a solid particle with a diameter of less than 100 nanometers (nm). As used herein, “nanosphere” refers to a substantially hollow particle with a diameter of less than 100 nm. As used herein, “nanowire” refers to a solid cylindrical structure having a diameter of less than 100 nm. As used herein, “nanotube” refers to a hollow cylindrical structure having a diameter of less than 100 nm. As used herein, “nanocomposite” refers to a material that includes nanomaterials dispersed within a polymer. Nanocomposites may exhibit modified mechanical, electrical, and optical properties. Nanocomposites may be used, for example, to form clear and/or photochromic lenses, antireflective coatings, photochromic coatings and hard coatings. Applications include control of the refractive index of thin films and lenses, as well as increased mechanical performance of thin films and lenses. For example, nanomaterials and polymers in a matrix combine to increase the strength of a plastic eyeglass lens and/or coatings for eyeglass lenses. In some embodiments, a nanocomposite including nanomaterials may be used in a lens or as a coating on a lens to increase scratch resistance of the lens.

A nanocomposite may retain the processability and low cost of the polymer at the macroscopic level while displaying advantageous properties of the nanoparticles at the microscopic level. Selection of the nanomaterial dopant may allow formation of bulk resin with desired properties including, but not limited to, mechanical strength, optical efficiency, and abrasion resistance when applied as a thin film coating to, for example, plastic eyeglass lenses. In some embodiments, a dispersion of nanomaterials in monomers (e.g., activating-light curable monomers) may be cured on a plastic substrate to form a coating on the substrate.

Nanomaterials used in coating compositions may include, for example, oxides and/or nitrides of elements from columns 2-15 of the Periodic Table. Specific compounds that may be used to form nanomaterials include, but not limited to, aluminum cerium oxide, aluminum nitride, aluminum oxide, aluminum titanate, antimony(III) oxide, antimony tin oxide, barium ferrite, barium strontium titanium oxide, barium titanate(IV), barium zirconate, bismuth cobalt zinc oxide, bismuth(III) oxide, calcium titanate, calcium zirconate, cerium(IV) oxide, cerium(IV) zirconium(IV) oxide, chromium(III) oxide, cobalt aluminum oxide, cobalt(II, III) oxide, copper aluminum oxide, copper iron oxide, copper(II) oxide, copper zinc iron oxide, dysprosium(III) oxide, erbium(m) oxide, europium(III) oxide, holmium(III) oxide, indium(III) oxide, indium tin oxide, iron(II,III) oxide, iron nickel oxide, iron(III) oxide, lanthanum(III) oxide, magnesium oxide, manganese(II) titanium oxide, nickel chromium oxide, nickel cobalt oxide, nickel(II) oxide, nickel zinc iron oxide, praseodymium(II,IV) oxide, samarium(III) oxide, silica, silicon nitride, strontium ferrite, strontium titanate, tantalum oxide, terbium (III,IV) oxide, tin(IV) oxide, titanium carbonitride, titanium(IV) oxide, titanium silicon oxide, tungsten (VI) oxide, ytterbium(III) oxide, ytterbium iron oxide, yttruium(III) oxide, zinc oxide, zinc titanate, and zirconium(IV) oxide. It should be understood that the above-listed materials may include minor amounts of contaminants and/or stabilizers (e.g., water and/or acetate) when obtained commercially or synthesized. Nanomaterials used for nanocomposites may be selected based on a variety of properties including, but not limited to, refractive index and hardness. Table 1 compares the bulk hardnesses and refractive indices of several commercially available nanomaterials.

TABLE 1

| Material | Mohs Hardness | Refractive Index | |
|---|---|---|---|
| Al₂O₃ | 9 | 1.62 | (600 nm) |
| SiO₂ | 6-7 | 1.46 | (600 nm) |
| TiO₂ | 5.5-6 | 2.2-2.7 | (550 nm) |
| ITO | | 2.05 | (550 nm) |
| ZrO₂ | 6.5 | 2.1 | (550 nm) |
| ZnO | 5 | | |
| CeO₂ | 6 | 2.2 | (550 nm) |
| Si₃N₄ | 8.5 | 2.06 | (500 nm) |
| Ta₂O₅ | | 2.16 | (550 nm) |

Commercially available nanomaterials that may be used include, but are not limited to: Nyacol Ceria (colloidal ceria oxide nanoparticles, available from Nyacol Nano Technologies, Inc.); Nanocryl XP954; Nanocryl XP596, and Nanocryl XP2357, Nanocryl XP1500, and Nanocryl XP1462 (various colloidal silica nanoparticles mixed with monomers available from Hanse Chemie).

In some embodiments, nanoparticles for use in coating compositions may be synthesized as a powder or in-situ using a sol-gel method, reverse micelle, or other liquid phase or vapor phase chemical process (e.g., plasma processes). These processes may require surface treatments to inhibit agglomeration of the nanoparticles in the monomer suspensions. In some embodiments, ultrasonication, milling, or other mechanical attrition may create a suitable particle size distribution. In certain embodiments, other materials including, but not limited to, inorganic hybrid materials such as nanomers or ceromers (including silsesquioxanes) may be added to nanomaterial coating compositions.

In some embodiments, nanoparticles may be obtained in the form of commercially available dispersions and/or powders. Many commercially available nanoparticle dispersions are dispersions of nanoparticles in water. Some aqueous dispersions of nanoparticles in water include stabilizers that inhibit agglomeration of the particles. One common stabilizer is acetic acid. In water, the acetic acid ionizes into acetate anions and hydronium cations. The acetate anions are attracted to the surface of positively charged surface of nanoparticles to create a repulsive force that allows stabilization of the colloidal suspension. In contrast, some nanoparticles have negatively charged surfaces and must be stabilized with an appropriate cation in a bulk solvent of water. The low vapor pressure of water (0.0313 atm), however, may inhibit thorough evaporation of water during use (e.g., a spin coat process), resulting in a porous film.

In some embodiments, a stabilized nanoparticle aqueous dispersion may be introduced into a solvent with a greater vapor pressure, for example, methanol (0.302 atm), ethanol (0.078 atm), n-propanol, i-propanol, or 1-methoxy-2-propanol. Introducing the colloid into a solvent with a greater vapor pressure allows the colloid particles to remain stabilized even though water is no longer the bulk solvent. Introducing another solvent into the aqueous solution, however, may “salt in” the colloid by gradually reducing the net concentration of the stabilizing ions, thus increasing the net energy barrier described by the Derjaguin, Landau, Verwey, and Overbeek Theory (DLVO). Solvents that may advantageously allow colloids to remain stable include, but are not limited to, highly polar solvents such as methanol (dipole moment=1.7 D, vapor pressure=0.128 atm), ethanol (dipole moment=1.69 D, vapor pressure=0.078), and 1-propanol (dipole moment=1.68 D, vapor pressure 0.043 atm). Some solvents, such as butanol (dipole moment=1.66 D) may require methods (e.g., ultrasonication) to inhibit agglomeration of a colloid. Other solvents, such as ethanol, are characterized by properties (e.g., availability, low toxicity) that increase desirability of their use.

If a cation stabilized nanoparticle aqueous dispersion (e.g., a silica colloidal dispersion) is dispersed into an organic alcohol, the cations may react with the alcohol to form an organic alkoxide. In ethanol, for example, sodium cations may react to form sodium ethoxide, effectively removing the stabilizing ions from solution. To inhibit reaction of the stabilizing ions with the solvent, a larger, more stable cation (e.g., ammonium cation) may be used following dilution of the dispersion with water. Dilution of the dispersion may gradually decrease the net concentration of ammonium ions in solution and increase the net energy barrier stabilizing the colloids from agglomeration. This intermediate equilibrium may allow the colloid to be introduced into the bulk solvent (e.g., ethanol) without loss of stability.

A coating composition may be formed by mixing one or more monomers with a composition that includes nanomaterials. In some embodiments, one or more ethylenically substituted monomers may be added to the colloidal dispersion to form a coating composition. The ethylenically substituted group of monomers include, but are not limited to, C₁-C₂₀ alkyl acrylates, C₁-C₂₀ alkyl methacrylates, C₂-C₂₀ alkenyl acrylates, C₂-C₂₀ alkenyl methacrylates, C₅-C₈ cycloalkyl acrylates, C₅-C₈ cycloalkyl methacrylates, phenyl acrylates, phenyl methacrylates, phenyl(C₁-C₉)alkyl acrylates, phenyl(C₁-C₉)alkyl methacrylates, substituted phenyl (C₁-C₉)alkyl acrylates, substituted phenyl(C₁-C₉)alkyl methacrylates, phenoxy(C₁-C₉)alkyl acrylates, phenoxy(C₁-C₉)alkyl methacrylates, substituted phenoxy(C₁-C₉)alkyl acrylates, substituted phenoxy(C₁-C₉)alkyl methacrylates, C₁-C₄ alkoxy(C₂-C₄)alkyl acrylates, C₁-C₄ alkoxy (C₂-C₄)alkyl methacrylates, C₁-C₄ alkoxy(C₁-C₄)alkoxy(C₂-C₄)alkyl acrylates, C₁-C₄ alkoxy(C₁-C₄)alkoxy(C₂-C₄)alkyl methacrylates, C₂-C₄ oxiranyl acrylates, C₂-C₄ oxiranyl methacrylates, copolymerizable di-, tri- or tetra-acrylate monomers, copolymerizable di-, tri-, or tetra-methacrylate monomers. In some embodiments, a coating composition may include up to about 5% by weight of an ethylenically substituted monomer.

Examples of such monomers include methyl methacrylate, ethyl methacrylate, propyl methacrylate, isopropyl methacrylate, butyl methacrylate, isobutyl methacrylate, hexyl methacrylate, 2-ethylhexyl methacrylate, nonyl methacrylate, lauryl methacrylate, stearyl methacrylate, isodecyl methacrylate, ethyl acrylate, methyl acrylate, propyl acrylate, isopropyl acrylate, butyl acrylate, isobutyl acrylate, hexyl acrylate, 2-ethylhexyl acrylate, nonyl acrylate, lauryl acrylate, stearyl acrylate, isodecyl acrylate, ethylene methacrylate, propylene methacrylate, isopropylene methacrylate, butane methacrylate, isobutylene methacrylate, hexene methacrylate, 2-ethylhexene methacrylate, nonene methacrylate, isodecene methacrylate, ethylene acrylate, propylene acrylate, isopropylene, hexene acrylate, 2-ethylhexene acrylate, nonene acrylate, isodecene acrylate, cyclopentyl methacrylate, 4-methyl cyclohexyl acrylate, benzyl methacrylate, o-bromobenzyl methacrylate, phenyl methacrylate, nonylphenyl methacrylate, benzyl acrylate, o-bromobenzyl phenyl acrylate, nonylphenyl acrylate, phenethyl methacrylate, phenoxy methacrylate, phenylpropyl methacrylate, nonylphenylethyl methacrylate, phenethyl acrylate, phenoxy acrylate, phenylpropyl acrylate, nonylphenylethyl acrylate, 2-ethoxyethoxymethyl acrylate, ethoxyethoxyethyl methacrylate, 2-ethoxyethoxymethyl acrylate, ethoxyethoxyethyl acrylate (SR-256), glycidyl methacrylate, glycidyl acrylate, 2,3-epoxybutyl methacrylate, 2,3-epoxybutyl acrylate, 3,4-epoxybutyl acrylate, 3,4-epoxybutyl methacrylate, 2,3-epoxypropyl methacrylate, 2,3-epoxypropyl acrylate 2-methoxyethyl methacrylate, 2-ethoxyethyl methacrylate, 2-butoxyethyl methacrylate, 2-methoxyethyl acrylate, 2-ethoxyethyl acrylate, 2-butoxyethyl acrylate, tetrahydrofurfuryl acrylate, tetrahydrofurfuryl methacrylate, ethoxylated bisphenol-A-dimethacrylate, ethylene glycol diacrylate, 1,2-propane diol diacrylate, 1,3-propane diol diacrylate, 1,2-propane diol dimethacrylate, 1,3-propane diol dimethacrylate, 1,4-butane diol diacrylate, 1,3-butane diol dimethacrylate, 1,4-butane diol dimethacrylate, 1,5 pentane diol diacrylate, 2,5-dimethyl-1,6-hexane diol dimethacrylate, diethylene glycol diacrylate, polyethylene glycol (400) diacrylate (SR-344), diethylene glycol dimethacrylate (SR-231), trimethylolpropane trimethacrylate, tetraethylene glycol diacrylate (SR-306), tetraethylene glycol dimethacrylate, dipropylene glycol dimethacrylate, trimethylolpropane triacrylate (SR-351), glycerol triacrylate, glycerol trimethacrylate, pentaerythritol triacrylate, pentaerythritol dimethacrylate, pentaerythritol tetracrylate, pentaerythritol tetramethacrylate, dipentaerythritol pentaacrylate (SR-399), ethoxylated₄ bisphenol A dimethacrylate (SR-540), ethoxylated₂ bisphenol A dimethacrylate (SR-348), tris (2 hydroxyethyl) isocyanurate triacrylate (SR-368), ethoxylated₄ bisphenol A diacrylate (SR-601), ethoxylated₁₀ bisphenol A dimethacrylate (SR-480), ethoxylated₃ trimethylopropane triacrylate (SR454), ethoxylated₄ pentaerithritol tetraacrylate (SR494), tridecyl acrylate (SR-489), 3-(trimethoxysilyl) propyl methacrylate (PMATMS), 3-glycidoxypropyltrimethoxysilane (GMPTMS), neopentyl glycol diacrylate (SR-247), isobornyl methacrylate (SR-243), tripropylene glycol diacrylate (SR-306), aromatic monoacrylate (CN-131), vinyl containing monomers such as vinyl acetate and 1-vinyl-2 pyrrolidone, epoxy acrylates such as CN 104 and CN 120 which are commercially available from Sartomer Company, and various urethane acrylates such as CN-962, CN-964, CN-980, and CN-965 all commercially available from Sartomer Company

Mixing nanomaterials with one or more monomers creates a coating composition that may be cured to form a nanocomposite coating layer. Curing of a coating composition may be performed using thermal curing, using activating light or both. As used herein “activating light” means light that may affect a chemical change. Activating light may include ultraviolet light (e.g., light having a wavelength between about 180 nm to about 400 nm), actinic light, visible light or infrared light. Generally, any wavelength of light capable of affecting a chemical change may be classified as activating. Chemical changes may be manifested in a number of forms. A chemical change may include, but is not limited to, any chemical reaction that causes a polymerization to take place. Preferably the chemical change causes the formation of an initiator species within the lens forming composition, the initiator species being capable of initiating a chemical polymerization reaction. In order to cure a coating composition, one or more polymerization initiators may be added to the composition.

In one embodiment, a coating composition that includes nanomaterials may also include a photoinitiator and/or a co-initiator. Photoinitiators that may be used include α-hydroxy ketones, α-diketones, acylphosphine oxides, bis-acylphosphine oxides or mixtures thereof. Examples of photoinitiators that may be used include, but are not limited to phenyl bis(2,4,6-trimethylbenzoyl)phenylphosphine oxide, commercially available from Ciba Additives in Tarrytown, N.Y. under the trade name of Irgacure 819, a mixture of phenyl bis(2,4,6-trimethylbenzoyl)phenylphosphine oxide and 1-hydroxycyclohexylphenyl ketone, commercially available from Ciba Additives under the trade name of Irgacure 184, 2-hydroxy-2-methyl-1-phenylpropane-1-one commercially available from Ciba Additives under the trade name of Darocur 1173, and benzophenone.

A coating composition that includes nanomaterials may also include coinitiators. In some embodiments, coinitiators include amines. Examples of amines suitable for incorporation into a coating composition include tertiary amines and acrylated amines. The presence of an amine tends to stabilize the antireflective coating composition during storage. The coating composition may be prepared and stored prior to using. Additionally, the presence of oxygen in the coating composition may inhibit curing of the composition. Amines and/or thiols may be added to the composition to overcome inhibition of curing by oxygen present in the coating composition. In some embodiments, the coating composition may slowly gel due to the interaction of the various components in the composition. The addition of amines tends to slow down the rate of gelation without significantly affecting the physical and/or antireflective properties of subsequently formed coatings. In some embodiments, a coating composition may include up to about 5% by weight of amines.

Example of coinitiators include reactive amine co-initiators commercially available from Sartomer Company under the trade names of CN-381, CN-383, CN-384, and CN-386, where these co-initiators are monoacrylic amines, diacrylic amines, or mixtures thereof.

A coating composition that includes nanomaterials may also include a fluorinated ethylenically substituted monomer. Fluorinated ethylenically substituted monomers have the general structure:
CH₂═CR¹CO—O—(CH₂)ₚ—CₙF₂ₙ₊₁,
in which R¹ is H or —CH₃; p is 1 or 2; and n is an integer from 1 to 40. Examples of fluorinated ethylenically substituted monomers include, but are not limited to, trihydroperfluoroheptyl acrylate and trihydroperfluoroheptyl acrylate. The addition of a fluorinated ethylenically substituted monomer to a composition to be applied to a plastic lens may increase the hydrophobicity of the coating. Hydrophobicity refers to the ability of a substrate to repel water. The addition of a fluorinated ethylenically substituted monomer to the composition may increase the ability of the coated substrate to resist degradation due to exposure to water and/or humidity.

A hydrophobic layer may be formed on the lens to protect the lens from water and/or humidity. A hydrophobic layer may also fill in surface defects in the lens or in another layers applied to the lens. Hydrophobic layers may be formed using an in-mold or out of mold process. In some embodiments, a hydrophobic layer may have a thickness of at least 1 nm, at least 2 nm, at least 5 nm, at least 10 nm and at most 200 μm, at most 100 nm, at most 50 nm, at most 25 nm, or at most 10 nm. Hydrophobic coating layers may include monomers, initiators, and optionally, nanomaterials.

Conventionally antireflective coatings formed by a vacuum deposition process require a hydrophobic top coat layer to enhance the ability to cleanabililty of a lens. Antireflective coatings formed by the methods described herein typically do not require the presence of a hydrophobic top coat to provide cleanability. Optionally, however, hydrophobic top coats may be applied to antireflective coatings that include nanomaterials by means well know in the art including, but not limited to spin coating methods, dip methods, flow methods, spray methods, or vacuum deposition. Such top coats may include fluorinated compounds. Examples of fluorinated compounds that may be used to for a hydrophobic layer include, but are not limited to Clarity Ultrseal—Nanofilm Co. Alternately, hydrophobic coating compositions may be formed from materials such as FSD-2500—polymeric perfluoroetherdisilane, FSD4500 and FSQ-3000 both available from Cytonix Co., Beltsville Md.; polymeric fluoropolysilane; typically such compounds are diluted in fluorinated solvents such as HFE-7100EL available from 3M and applied to an antireflective coating stack.

Coating compositions that include nanomaterials may be cured to form a nanocomposite coating on a substrate. For example, to improve the properties of polymeric lenses, one or more nanocomposite coatings may be formed on the outer surface of a polymeric lens. Nanocomposite coatings that may be formed on the outer surface of a polymeric lens may include, but are not limited to, hardcoat (e.g., scratch resistant) coatings, anti-reflective coatings, and photochromic coatings. In some embodiments, these coatings may be formed on the lens by applying the appropriate coating composition to a formed polymeric lens. The coating composition is then cured (either thermally or by use of activating light) to form a nanocomposite coating layer on the outer surface of the lens. This process is herein referred to as an “out-of-mold process.”

Alternatively, these coatings may be formed using an in-mold process. An in-mold process involves forming one or more coating layers on a casting surface of one or more mold member. The mold members are then assembled to form a mold assembly and a lens forming composition is placed in a mold cavity defined by the mold assembly. Subsequent curing of the lens forming composition (using activating light, heat or both) will form a polymeric lens within the mold assembly. When the polymeric lens is removed from the mold assembly, the coating layer or layers that were applied to the mold member(s) will adhere to the surface of the formed polymeric lens. This in-mold method is advantageous to “out-of-mold” methods since the in-mold method exhibits less occurrences of coating defects manifested as irregularities on the anterior surface of the coating. Further, in-mold coatings will tend to further react during the polymerization process of the lens forming composition. In some embodiments, the coating composition may react with the lens forming composition as the lens forming composition is cured. Further reaction of the coating composition may improve adhesion between the coating composition and the lens. Such in-mold coatings, therefore, do not have to be brought to the same level of cure during the initial curing step as they would be if they were applied to the lens after the lens was formed. Using the in-mold method produces a coating layer on the surface of a substrate that replicates the topography and smoothness of the mold casting face.

Properties of coating compositions may be discussed in terms of parameters indicative of composition viscosity and layer thickness to facilitate characterization of optical properties of the layers. Percent solids, as used herein, is the total weight of nanomaterials and monomer divided by total weight of the coating composition, or the ratio of nonvolatile substances to total weight of the coating composition. Weight ratio, as used herein refers to the weight ratio of nanomaterials to total nonvolatile substances in the coating composition. For example, for a colloidal ceria coating composition, weight ratio of ceria refers to the weight of ceria nanoparticles divided by the weight of all nonvolatile solids (e.g., nanomaterials, monomer, and photoinitiator) present after spin coating. This weight ratio can be related to optical and mechanical properties of the nanocomposite coating layer and is directly related to refractive index of the film.

One property of a nanocomposite coating is that the index of refraction of the material may be tuned by varying the weight ratio of the nanoparticles. Generally, adding nanomaterials having an index of refraction that is greater than the index of refraction of the monomer(s) used to form the coating composition may increase an index of refraction of a coating layer formed from the coating composition. As the weight ratio of nanomaterials is varied the index of refraction of the polymer will change as a function of the weight ratio of the nanomaterials to the non-volatile components.

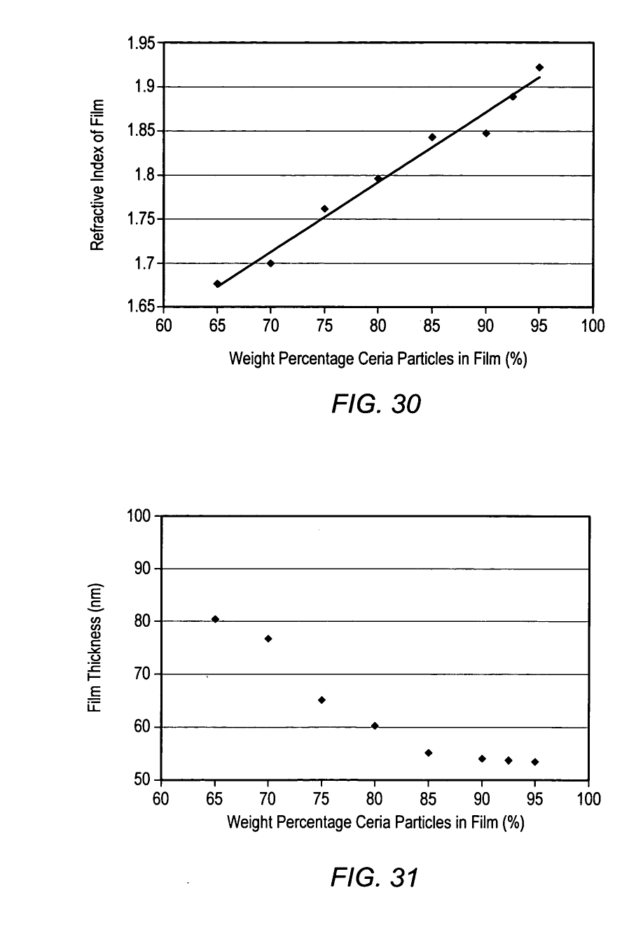

FIG. 30 depicts refractive index of ceria antireflective coating films versus weight percentage of ceria nanoparticles in the films. Each point on the graph corresponds to a film prepared with 65-95 wt % percent ceria in the composition with a constant solids content of 3 wt %. Each of the various compositions was deposited on a three-inch silicon wafer and cured with ultraviolet radiation. Film thickness was measured using a Dektak Profilometer (Veeco; Woodbury, N.Y.). Measured film thickness was then used together with a reflectance spectrum measured by a Filmetrics F20 Spectrometer (Filmetrics, Inc., San Diego, Calif.) at 550 nm to calculate a refractive index of the film. Haze of films formed from these compositions was tested by measuring haze of optically clear lenses with a Haze Gard (Byk-Gardner; Columbia, Md.) before and after coating with each of these compositions. Haze of the substrate appeared to be substantially the same before and after coating. When the above-described composition was used to form a film on a transparent substrate, the applied film does not substantially alter the haze, as measured with a Haze Gard, (i.e., the films are non-hazy).

Extrapolation of the linear relationship between refractive index and weight percentage of ceria particles depicted in FIG. 30 to 100 wt % ceria particles in the film (“100% loading”) would correspond to a refractive index of 1.95. While the refractive index of bulk cerium dioxide is greater than 1.95, it is believed that treatment of the ceria compositions depicted in FIG. 30 with a mild (organic) acid may have affected surface properties of the ceria nanoparticles. Even with the residual organic acid present, the refractive index of the antireflective coating film may be continuously tunable from the refractive index of the pure polymer (1.54) to the refractive index of the treated ceria nanoparticles (1.95).

Altering the refractive index by varying the amount of nanomaterials in the composition offers an advantage over conventional anti-reflective coating methods that cannot alter the refractive index of the material they are using. Such conventional methods tend to rely on thickness control to achieve the desired antireflective effects. Thickness control used by such methods tends to be difficult to obtain and involve expensive equipment. By having the ability to alter the refractive index of the material, antireflective coatings may be more readily produced on a variety of substrates.

FIG. 31 depicts the observed influence of ceria loading on the thickness of coating layers. The percent solids in each of the compositions was held constant at 3 wt %. Therefore, an increase in the loading of the nanoparticles in the film is accompanied by a decrease in monomer(s) added to the solution. The exchange of nanoparticles for monomer(s) may affect the viscosity of the solution. As the viscosity of the solution increased (i.e., at lower nanoparticle loadings and higher monomer loadings), the deposited film was thicker.

In some embodiments, an increase of nanomaterial loading in the composition may increase mechanical strength of the film. For example, introducing more ceria nanoparticles (Mohs' scale hardness of 6) within a polymer matrix may increase the abrasion resistance of the film. Six of the compositions indicated on the graph in FIG. 30 were coated onto acrylic substrates and subjected to the tumble test, a physical abrasion test used in the optical industry. The tumble test simulates abrasive wear on antireflective coated samples and measures an increase in haze (light scatter caused by scratches on the surface). Lenses exhibiting more scratches may have a higher haze value. This test method is described in Colts Laboratory SOP number L-11-13-06 available from Colts Laboratory (Clearwater Florida), which is incorporated herein by reference.

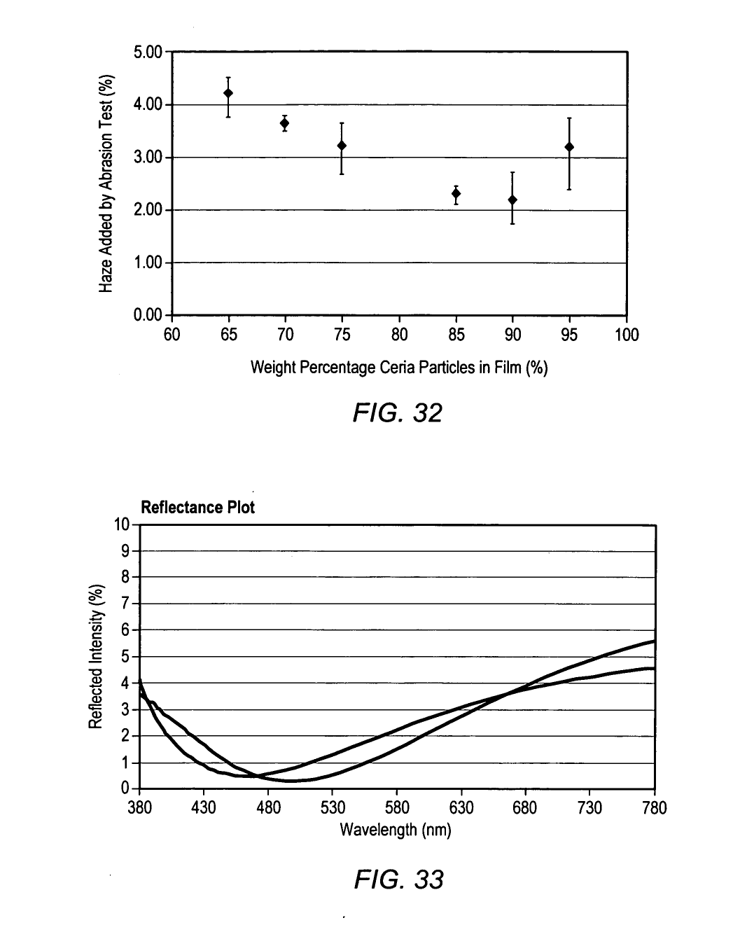

A BYK-Gardener Haze Gard was used to measure light scattered from an incident beam before and after the tumble test was administered. The increase in scattered light, measured in the form of haze, was then recorded. FIG. 32 depicts haze added by the abrasion test versus weight percentage of ceria particles in film. As indicated in FIG. 32, abrasion resistance increases (added haze decreases) up to about 90 wt % loading of ceria in the film. With increased addition of nanoparticles, there is an insufficient amount of monomer available with which to form a continuous matrix around the nanoparticles. Thus, above about 90 wt % loading, a decrease in mechanical strength tends to occur as nanocomposite properties of the film are lost.

In one embodiment, a hardcoat nanocomposite composition may be applied to the polymeric lens using either an “in-mold” or an “out-of-mold” process. Forming a hardcoat nanocomposite layer may create a protective layer on the outer surface of the polymeric lens. Hardcoat nanocomposite coating layers may be resistant to abrasive forces that would otherwise scratch or mar the surface of the polymeric lens.

In one embodiment, a hardcoat composition may include an ethylenically substituted monomer, nanomaterials and one or more photoinitiators and/or co-initiators. Such compositions have been described above and may include nanomaterials that are oxides and/or nitrides of Col 2-15 elements as described previously. In one embodiment, silica and/or ceria nanomaterials are used to form a hardcoat coating layer. A hardcoat composition may be applied to a substrate using an out-of-mold process or an in-mold process. In an embodiment, the substrate is a semi-finished lens blank or a finished lens.

Nanocomposite hardcoat layers may be formed on a polymeric lens using an out-of mold process. In an out-of-mold process, a polymeric lens is formed by curing a lens forming composition with activating light and/or heat. The polymeric lens is coated with a hardcoat composition that includes nanomaterials. The coating composition is cured to form a nanocomposite coating composition on a surface of the polymeric lens. Alternatively, a nanocomposite hardcoat layer may be formed using an in-mold process. During an in-mold process, a hardcoat composition, that includes nanomaterials, is applied to a casting surface of a mold member. The coating composition is at least partially cured using activating light and/or heat to form a hardcoat layer on an inner surface of the mold member. The mold member is used to form a mold assembly, a lens forming composition is introduced into the mold assembly and the lens forming composition is cured. Alternatively, the coating composition may be applied to a mold member and the mold member may be used to form a mold assembly without any substantial curing of the coating composition. For example, after applying the coating composition to a mold member, the coated mold member may be exposed to air in the absence of activating light and heat, then placed in a mold assembly.

Coating compositions that include nanomaterials may also be used to form antireflective coatings. The use of coating compositions for forming antireflective coatings on substrates offers a number of advantages. For example, the coating compositions as described above may be cured in a time of less than about 10 minutes. Also, the coating compositions described herein may be applied to a variety of visible light transmitting substrates. Such substrates may be composed of glass or plastic. It should be understood that the liquid compositions for forming an antireflective coating described herein may be applied to a number of visible light transmitting substrates including windows and the outer glass surface of television screens. computer monitors, CDs, DVDs, photovoltaic devices, mirrors and other substrates where an increase in optical efficiency is desirable. The coating compositions may be used to form an antireflective coating on a lens (e.g., a plastic eyeglass lens).

Antireflective coatings may reduce the reflectance of visible light from a surface of an eyeglass lens (i.e., increase light transmittance through the film/substrate interface). The visible spectrum for an average human eye is between about 380-780 μm, with a peak at about 555 μm. An uncoated plastic lens may reflect about 4.8% of incident light at one interface. An antireflective coating may suppress reflection of light in at least a portion of the visible spectrum. The color of light reflected from an antireflective coating may be related to the inability of the antireflective coating to suppress reflection from that portion of the visible spectrum. In certain embodiments, an antireflective nanocomposite coating may be formed as a thin film on a plastic substrate using, for example, a spin coating method, followed by polymerization using activating light (e.g., a UV light source) and/or heat. The resulting nanocomposite coating layer may be formed of nanomaterials embedded in a polymer matrix.

Antireflective coatings are thin films that are formed upon the surface of the eyeglass lens. Such films have an optical thickness that is herein defined as the index of refraction of the film times the mechanical thickness of the film. The most effective films typically have an optical thickness that is a fraction of a wavelength of incident light. Typically, the optical thickness is one-quarter to one-half the wavelength. Thus for visible light (having wavelengths approximately between 400 nm and 700 μm) an antireflective coating layer may have a thickness between about 100 and 200 μm. Thicknesses that are less than 100 nm or greater than 200 nm may also be used. In the embodiments cited herein, the combined optical thickness of the coating material may be up to about 1000 nm, more particularly up to about 500 nm.

The ideal thickness of an antireflective coating should be about one-quarter the wavelength of the incident light. For light entering the film at normal incidence, the light reflected from the second surface of the film will be exactly one-half a wavelength out of phase with the light reflected from the first surface, resulting in destructive interference. If the amount of light reflected from each surface is the same, a complete cancellation will occur and no light will be reflected. This is the basis of the “quarter-wave” low-reflectance coatings that are used to increase transmission of optical components. Such coatings also tend to eliminate ghost images as well as stray reflected light.

Although visible light includes a range of wavelengths from about 400 nm to about 700 nm, a quarter-wave coating can only be optimized for one wavelength of light. For the other wavelengths of light, the antireflective coating may be either too thick or too thin. Thus, more of the light having these wavelengths may be reflected. In one embodiment, the thickness of the antireflective coating layers of an eyeglass lens may be varied or the indices of refraction may be altered to produce lenses that have different visible light reflective characteristics. Both of these variations will alter the optical thickness of the coating layers and change the optimal effective wavelength of light that is transmitted. As the optical thickness of the coating layers is altered the reflected color of the lens will also be altered. In an iterative manner, the optimal reflected color of the coated eyeglass lens may be controlled by the manufacturer.

While single layer antireflective coatings have been described, it should be understood that multi-layer systems that include more than one layer may also be used. In a two-layer system, a substrate is coated with a high index of refraction layer. The high index of refraction layer is then coated with a low index of refraction layer. In an embodiment, a third high index of refraction (e.g., at least higher than the underlying second coating layer) may be formed on the second coating layer. A fourth low index of refraction layer (e.g., at least lower than the index of refraction of the third coating layer) may also be formed. The four-layer stack may exhibit antireflective properties. The four-layer stack may have an optical thickness of less than about 1000 nm, and more particularly less than about 500 nm. Additional layers may be formed upon the stack in a similar manner with the layers alternating between high and low index of refraction materials.

A typical antireflective coating may include two or more thin films with various (e.g., alternating) indices of refraction to increase transmission of light through the final product. Each thin film may be less than about 200 nm, less than 175 mm, less than 150 nm, or less than 100 nm; with an index of refraction ranging from about 1.4 to about 2.2. In some embodiments, an antireflective coating may include two or more discrete layers (e.g., low refractive index, mid refractive index, and/or high refractive index). For high refractive index layers and mid refractive index layers, nanomaterials of substances that exhibit a bulk index of refraction of at least 2.0 (e.g., TiO₂, CeO₂) may be used. For low refractive index layers, nanomaterials of substances that exhibit a bulk refractive index of less than about 1.5 (e.g., SiO₂) may be used. In some embodiments, a low refractive index layer may also include abrasion resistant properties. In certain embodiments, a hardcoat may be used in combination with an antireflective coating such that the hardcoat is disposed between the anti-reflective coating and the lens. Nanomaterials used in a hardcoat may be chosen for mechanical integrity. In addition, the index of refraction of the hardcoat may be favorably chosen to be near to (e.g., approximately the same as) the index of refraction of the lens material. Nanomaterials used in a hardcoat may include, but are not limited to, SiO₂ and Al₂O₃.

The use of nanomaterials may advantageously allow the same monomers to be used in each of the antireflective layers. This may be accomplished by varying the weight ratio of the nanomaterials in the monomer. As the weight ratio of nanomaterials is varied, the index of refraction of the nanocomposite coating layer will also change. The index of refraction of a resulting coating layer may, therefore, be tuned by determining the appropriate weight ratio of nanomaterials to obtain the desired index of refraction without changing the monomers used in the coating composition.

In an embodiment, a single layer coating may be formed on a plastic lens by coating the substrate with a coating composition and curing the composition. While the below described procedures refer to the coating of plastic lenses, it should be understood that the procedures may be adapted to coat any of various substrates. The cured composition may form a thin layer (e.g., less than about 500 nm, less than about 200 nm, or less than about 100 nm) on the substrate. The cured composition layer may have antireflective properties if the formed coating layer has an index of refraction that is less than the index of refraction of the substrate. This may be sufficient for many applications where a limited increase in visible light transmission is acceptable. Attempts to increase the adhesion to the plastic lens by altering the composition may cause the index of refraction of the single layer antireflective coating to increase and reduce the effectiveness of such layers.

Better antireflective properties and adhesion may be achieved by use of multi-layer antireflective coatings. In one embodiment, a two-layer stack of coating layers may be used as an anti-reflective coating. A first nanocomposite coating layer may be formed on the surface of a polymeric lens. The first nanocomposite coating layer may be formed by dispensing a first coating composition on the surface of the lens and subsequently curing the first composition. The first nanocomposite coating layer may be formed from a material that has an index of refraction that is greater than the index of refraction of the plastic lens. A nanocomposite second coating layer may be formed upon the first nanocomposite coating layer. The second nanocomposite coating layer may be formed by dispensing a second composition onto the first nanocomposite coating layer and curing the second composition. The second nanocomposite coating layer may be formed from a material that has an index of refraction that is less than the index of refraction of the first coating layer. Together the first nanocomposite coating layer and the second nanocomposite coating layer form a stack that may act as an antireflective coating. The first and second coating layers, together, may form a stack having a thickness of less than about 500 nm, less than about 400 nm, less than about 300 nm, or less than about 200 nm.

In some embodiments, coating compositions that include nanomaterials may be used to form a polymeric thin film of continuously tunable refractive index over a range related to the monomer(s) and the nanomaterials used. The index of refraction of the resulting coating layer may range from the refractive index of the undoped polymer to the index of refraction of the nanomaterials. The thickness of the film may be controlled by varying the percent solids in the coating composition. The refractive index of the film may be controlled by varying a weight ratio of nanomaterials to monomer in the solution. Antireflective coating layers deposited from coating compositions that include nanomaterials may advantageously provide an inexpensive and safe approach to antireflective coating that does not require, for example, an evacuated environment and/or high temperatures.

FIG. 33 depicts reflectance spectra of two acrylic substrates coated with a high refractive index ceria nanocomposite thin film followed by a low refractive index silica nanocomposite thin film. The high index ceria nanocomposite film was formed from a coating composition that included, by weight: 90% ethanol; 9% colloidal ceria oxide nanoparticles (Nyacol Colloidal Ceria); 0.38% dipentaerythritol pentaacrylate (Sartomer, SR-399); and 0.02% 1-hydroxy-cyclohexyl-phenyl ketone (Ciba, Irgacure 184). The low index nanocomposite film was formed from a coating composition that included, by weight: 98% 1:1:1 1-methoxy-2-propanol:isopropyl alcohol:acetone; 1.6% silica nanoparticles (XP954, Hanse Chemie); 0.34% dipentaerythritol pentaacrylate (Sartomer, SR-399), and 0.06% 1-hydroxy-cyclohexyl-phenyl ketone (Ciba, Irgacure 184). As shown in FIG. 33, minimum reflectance at a wavelength may be tuned to a desired value by varying the thickness and refractive index of the high and low refractive index layers, thus changing the reflected color and intensity of light from the lens. The samples depicted in FIG. 33 exhibit 96.3% transmission and 97.6% transmission, compared to 90% transmission shown by an uncoated acrylic substrate.

A coating composition may be applied to one or both surfaces of a substrate. The coating composition may be applied using a coating unit. The coating composition may be applied to the eyeglass lens as the lens is rotated within the coating unit. Details regarding methods of coating lenses and devices for applying coating compositions to lenses may be found in U.S. Pat. No. 6,632,535 and U.S. patent application Ser. No. 10/098,736.

In one embodiment, a hardcoat composition may be applied to the plastic lens prior to the application of the antireflective coating stack. Curing of the hardcoat composition may create a protective layer on the outer surface of the plastic lens. In one embodiment, a hardcoat layer may be formed from a coating composition that includes a nanomaterial. When cured, the formed nanocomposite hardcoat layer may be resistant to abrasive forces and also may provide additional adhesion for the antireflective coating material to the plastic lens.

In the above-described procedures, the antireflective coating may be formed onto a preformed lens. Such a method may be referred to as an out-of-mold process. An alternative to this out-of-mold process is an in-mold process for forming antireflective coatings. The “in-mold” process involves forming an antireflective coating over an polymeric lens by placing a liquid lens forming composition in a coated mold and subsequently curing the lens forming composition. The in-mold method is advantageous to “out-of-mold” methods since the in-mold method exhibits less occurrences of coating defects manifested as irregularities on the anterior surface of the coating. Using the in-mold method produces an antireflective coating that replicates the topography and smoothness of the mold casting face.

The formation of a multilayer antireflective coating to a polymeric lens using an in-mold method requires that the layers be formed onto the mold in reverse order. That is, the low index of refraction layer is formed on the casting surface of the mold member first. A high index of refraction layer is then formed on the low index of refraction layer. The molds may be assembled into a mold assembly and a lens forming composition added to the mold cavity. Curing of the lens forming composition creates a polymeric lens with an antireflective coating stack that has an inner high index of refraction layer on the lens and a low index of refraction layer on top of the high index of refraction layer.

While two layer antireflective coatings have been described for an in-mold process, it should be understood that multi-layer systems that include more than two layers may also be used. In an embodiment, a three layer stack may be formed. In one embodiment, a low index of refraction layer is formed on the casting surface of the mold member first. A high index of refraction layer is then formed on the low index of refraction layer. Finally, a third mid-index of refraction layer (e.g., at least lower than the underlying high index coating layer) may be formed on the second coating layer.

In a four layer stack, the low index of refraction layer is formed on the casting surface of the mold member first. A high index of refraction layer is then formed on the low index of refraction layer. In one embodiment, a low index of refraction layer is then formed on the second coating layer of the mold member. A high index of refraction layer is then formed on the second low index of refraction layer. The four-layer stack may exhibit antireflective properties. The four-layer stack may have an optical thickness of less than about 1000 nm, and more particularly less than about 500 nm. Additional layers may be formed upon the stack in a similar manner with the layers alternating between high and low index of refraction materials

Additional coating materials may be placed onto the antireflective coating layers in the mold. In one embodiment, a hardcoat composition may be applied to the antireflective coating layers formed on the casting surface of a mold. Curing of the hardcoat composition may create a protective layer on the outer surface of a subsequently formed plastic eyeglass lens. Hardcoat layers may be nanocomposite hardcoat layers, as described herein.

### EXAMPLE 1

### Two Layer Antireflective Coating with Hardcoat

In an embodiment, a first antireflective coating composition was prepared including the following materials by weight:

| | |
|---|---|
| 1.19% | Nanocryl XP596 |
| 0.3% | SR-399 |
| 0.025% | Irgacure 819 |
| 0.025% | benzophenone |
| 0.025% | Darocur 1173 |
| 0.00045% | BYK-333 |
| 32.8% | 1-methoxy-2-propanol |
| 32.8% | acetone |
| 32.8% | isopropanol |

BYK-333 is a polyether modified dimethylpolysiloxane copolymer (available from BYK Chemie).

A second antireflective coating composition was prepared including the following materials by weight:

| | |
|---|---|
| 12.47% | Nyacol Ceria |
| 0.11% | SR-399 |
| 0.01% | Irgacure 184 |
| 87.41% | acetone |

A hardcoat coating composition was prepared comprising the following materials by weight:

| | |
|---|---|
| 16.53%% | Nanocryl XP596 |
| 0.28%% | Irgacure 184 |
| 0.28% | benzophenone |
| 0.28% | Darocure 1173 |
| 27.5% | 1-methoxy-2-propanol |
| 27.5% | acetone |
| 27.5% | isopropanol |

An eyeglass lens coated with antireflective coating layers and a hardcoat layer was prepared by the following method. A front glass mold was cleaned by soaking it in a mixture of water, lauryl sulfate and sodium hydroxide for one minute. The mold was removed from this solution, scrubbed, and rinsed thoroughly under running tap water. The mold was sprayed with isopropyl alcohol, place on the spin stage of a Q-2100R unit, commercially available from Optical Dynamics Corporation of Louisville, Ky. The mold was allowed to spin dry and the spin was then stopped. Approximately 1 mL of the first antireflective coating composition was dispensed onto the center of the glass mold while the mold was rotating at about 1000 rpm. The rotation was stopped and the mold and the spin stage was then removed from the Q-2100R unit and the stage and mold was placed in a holder on the countertop which held the mold in a horizontal orientation with the coated mold surface facing upward. A White Lightning X-3200 photostrobe equipped with a quartz glass xenon lamp, commercially available from Paul C. Buff Inc. of Nashville, Tenn. was placed over the mold. The coating was then exposed to one flash of the strobe lamp Approximately 1.0 mL of the second antireflective coating composition was then dispensed onto the center of the glass mold while the mold was rotating at about 1000 rpm. The mold was then exposed to one flash from the strobe lamp. Approximately 1.0 mL of the hardcoat coating composition was then dispensed onto the center of the glass mold while the mold was rotating at about 1000 rpm. The mold was then exposed to one flash from the strobe lamp.

The coated mold was then assembled into a gasket along with a back mold to form an eyeglass lens mold assembly. The cavity of the mold assembly was then filled with OMB-99 Lens Monomer, commercially available from Optical Dynamics Corporation of Louisville, Ky. and the eyeglass lens monomer was polymerized using the conventional Q-2100R lens casting process as described in U.S. Pat. No. 6,712,331 which is incorporated herein by reference.

OMB-99 Lens Monomer

| | |
|---|---|
| 98.25% | Ethoxylated₍₄₎bisphenol A dimethacrylate (SR-540) |
| 0.75% | Difunctional reactive amine coinitiator (CN-384) |
| 0.75% | Monofunctional reactive amine coinitiator (CN-386) |
| 0.15% | Phenyl bis(2,4,6-trimethylbenzoyl) phosphine oxide |
| | (Irgacure-819) |
| 0.10% | 2-(2H-Benzotriazol-2-yl)-4-(1,1,3,3-tetramethylbutyl)phenol |
| 0.87 ppm | Thermoplast Blue 684 |
| 0.05 ppm | Thermoplast Red LB 454 |

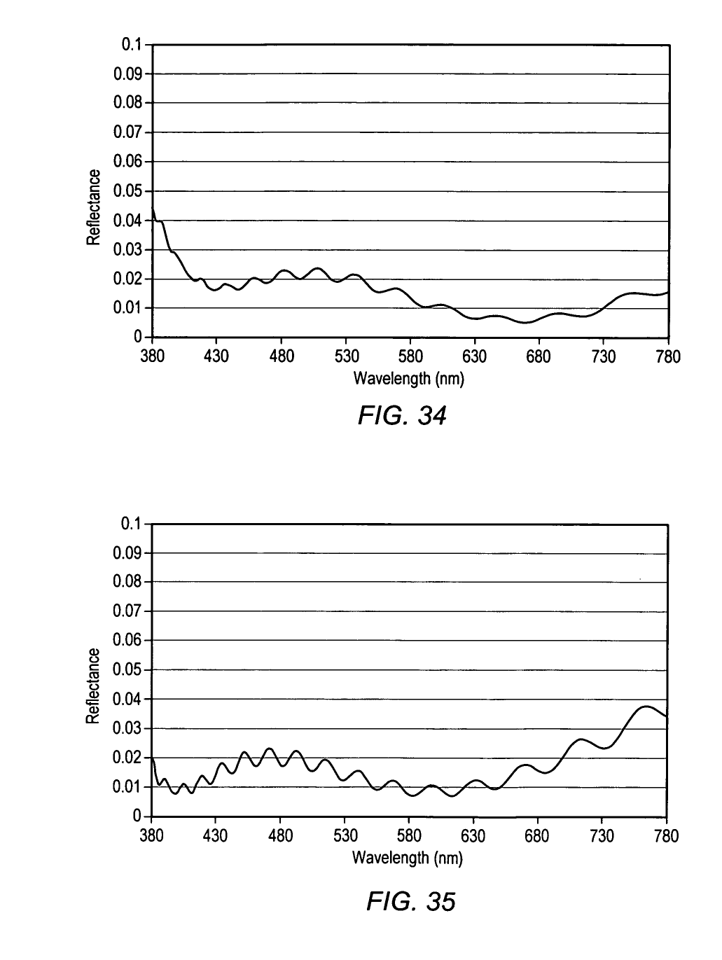

After the lens polymerization process was completed, the resultant eyeglass lens was removed from the mold assembly, cleaned, annealed for ten minutes at 100° C., and allowed to return to room temperature. The reflectance spectrum of the resulting lens was measured and is depicted in FIG. 34.

### EXAMPLE 2

### Three Layer Antireflective Coating with Hardcoat

In an embodiment, a first antireflective coating composition was prepared including the following materials by weight:

| | |
|---|---|
| 1.19% | Nanocryl XP954 |
| 0.3% | SR-399 |
| 0.025% | Irgacure 819 |
| 0.025% | benzophenone |
| 0.025% | Darocur 1173 |
| 0.00045% | BYK-333 |
| 32.8% | 1-methoxy-2-propanol |
| 32.8% | acetone |
| 32.8% | isopropanol |

A second antireflective coating composition was prepared including the following materials by weight:

| | |
|---|---|
| 9% | Nyacol Ceria |
| 0.95% | SR-399 |
| 0.05% | Irgacure 184 |
| 90% | ethanol |

A third antireflective coating composition was prepared including the following materials by weight:

| | |
|---|---|
| 22.55% | Nyacol Ceria |
| 2.25% | SR-399 |
| 0.1% | Irgacure 184 |
| 75.1% | ethanol |

A hardcoat coating composition was prepared comprising the following materials by weight:

| | |
|---|---|
| 16.53%% | Nanocryl XP596 |
| 0.28%% | Irgacure 184 |
| 0.28% | benzophenone |
| 0.28% | Darocure 1173 |
| 27.5% | 1-methoxy-2-propanol |
| 27.5% | acetone |
| 27.5% | isopropanol |

An eyeglass lens coated with antireflective coating layers and a hardcoat layer was prepared by the following method. A front glass mold was cleaned by soaking it in a mixture of water, lauryl sulfate and sodium hydroxide for one minute. The mold was removed from this solution, scrubbed, and rinsed thoroughly under running tap water. The mold was sprayed with isopropyl alcohol, place on the spin stage of a Q-2100R unit, commercially available from Optical Dynamics Corporation of Louisville, Ky. The mold was allowed to spin dry and the spin was then stopped. Approximately 1 mL of the first antireflective coating composition was dispensed onto the center of the glass mold while the mold was rotating at about 1000 rpm. The rotation was stopped and the mold and the spin stage was then removed from the Q-2100R unit and the stage and mold was placed in a holder on the countertop which held the mold in a horizontal orientation with the coated mold surface facing upward. A White Lightning X-3200 photostrobe equipped with a quartz glass xenon lamp, commercially available from Paul C. Buff Inc. of Nashville, Tenn. was placed over the mold. The coating was then exposed to one flash of the strobe lamp Approximately 1.0 mL of the second antireflective coating composition was then dispensed onto the center of the glass mold while the mold was rotating at about 1000 rpm. The mold was then exposed to one flash from the strobe lamp. Approximately 1.0 mL of the third antireflective coating composition was then dispensed onto the center of the glass mold while the mold was rotating at about 1000 rpm. The mold was then exposed to one flash from the strobe lamp. Approximately 1.0 mL of the hardcoat coating composition was then dispensed onto the center of the glass mold while the mold was rotating at about 1000 rpm. The mold was then exposed to one flash from the strobe lamp.

The coated mold was then assembled into a gasket along with a back mold to form an eyeglass lens mold assembly. The cavity of the mold assembly was then filled with OMB-99 Lens Monomer, commercially available from Optical Dynamics Corporation of Louisville, Ky. and the eyeglass lens monomer was polymerized using the conventional Q-2100R lens casting process as described in U.S. Pat. No. 6,712,331 which is incorporated herein by reference. After the lens polymerization process was completed, the resultant eyeglass lens was removed from the mold assembly, cleaned, annealed for ten minutes at 100° C., and allowed to return to room temperature. The reflectance spectrum of the resulting lens was measured and is depicted in FIG. 35.

### EXAMPLE 3

### Three Layer Antireflective Coating

In an embodiment, a first antireflective coating composition was prepared including the following materials by weight:

| | |
|---|---|
| 1.19% | Nanocryl XP1500 |
| 0.3% | Nanocryl XP1462 |
| 0.025% | Irgacure 819 |
| 0.025% | benzophenone |
| 0.025% | Darocur 1173 |
| 0.00045% | BYK-333 |
| 32.8% | 1-methoxy-2-propanol |
| 32.8% | acetone |
| 32.8% | isopropanol |

A second antireflective coating composition was prepared including the following materials by weight:

| | |
|---|---|
| 9% | Nyacol Ceria |
| 0.95% | SR-399 |
| 0.05% | Irgacure 184 |
| 90% | 1-propanol |

A third antireflective coating composition was prepared including the following materials by weight:

| | |
|---|---|
| 10.9% | Nyacol Ceria |
| 2.04% | SR-399 |
| 0.1% | Irgacure 184 |
| 86.96% | 1-propanol |

An eyeglass lens coated with antireflective coating layers and a hardcoat layer was prepared by the following method. A front glass mold was cleaned by soaking it in a mixture of water, lauryl sulfate and sodium hydroxide for one minute. The mold was removed from this solution, scrubbed, and rinsed thoroughly under running tap water. The mold was sprayed with isopropyl alcohol, place on the spin stage of a Q-2100R unit, commercially available from Optical Dynamics Corporation of Louisville, Ky. The mold was allowed to spin dry and the spin was then stopped. Approximately 1 mL of the first antireflective coating composition was dispensed onto the center of the glass mold while the mold was rotating at about 1000 rpm. The rotation was stopped and the mold and the spin stage was then removed from the Q-2100R unit and the stage and mold was placed in a holder on the countertop which held the mold in a horizontal orientation with the coated mold surface facing upward. A White Lightning X-3200 photostrobe equipped with a quartz glass xenon lamp, commercially available from Paul C. Buff Inc. of Nashville, Tenn. was placed over the mold. The coating was then exposed to one flash of the strobe lamp Approximately 1.0 mL of the second antireflective coating composition was then dispensed onto the center of the glass mold while the mold was rotating at about 1000 rpm. The mold was then exposed to one flash from the strobe lamp. Approximately 1.0 mL of the third antireflective coating composition was then dispensed onto the center of the glass mold while the mold was rotating at about 1000 rpm. The mold was then exposed to one flash from the strobe lamp.

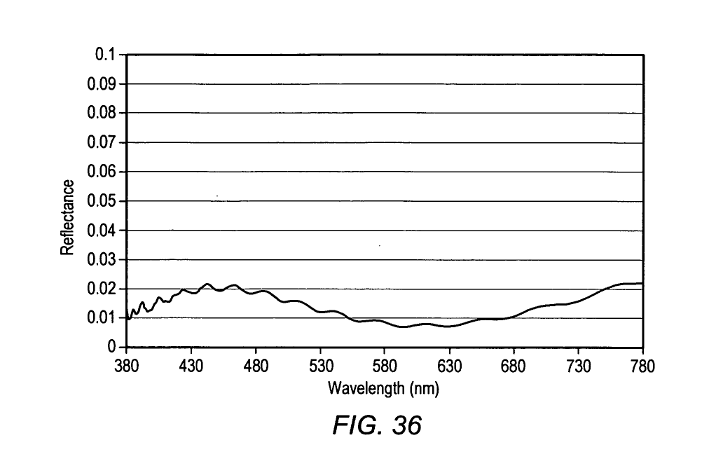

The coated mold was then assembled into a gasket along with a back mold to form an eyeglass lens mold assembly. The cavity of the mold assembly was then filled with OMB-99 Lens Monomer, commercially available from Optical Dynamics Corporation of Louisville, Ky. and the eyeglass lens monomer was polymerized using the conventional Q-2100R lens casting process as described in U.S. Pat. No. 6,712,331 which is incorporated herein by reference. After the lens polymerization process was completed, the resultant eyeglass lens was removed from the mold assembly, cleaned, annealed for ten minutes at 100° C., and allowed to return to room temperature. The reflectance spectrum of the resulting lens was measured and is depicted in FIG. 36.

In one embodiment, a semi-finished photochromic lens blank or finished photochromic lens is prepared using an in-mold coating method. Specifically, a polymerizable liquid coating composition that includes at least one photochromic compound (a “photochromic coating composition”) is applied to the casting face of a mold used to form an eyeglass lens. This applied photochromic coating composition is at least partially cured such that the formed photochromic coating layer will remain substantially intact on the surface of the mold when the mold is assembled into an eyeglass lens mold assembly and filled with a liquid lens forming composition. In an embodiment, the photochromic coating composition is cured to an extent such that the photochromic coating layer is inhibited from being washed away or substantially swollen by contact with the lens forming composition. After forming the photochromic coating layer, the mold assembly is then filled with a lens forming composition and the lens forming composition cured with activating light and/or heat. The lens forming composition is then polymerized, resulting in a semi-finished lens blank or finished lens that includes a photochromic coating layer adhering to outer surface of the lens.

In one embodiment, a photochromic composition includes a monomer, an initiator and a photochromic compound. Example of photochromic compounds include, but are not limited to: spiropyrans, spironaphthoxazines, spiropyridobenzoxazines, spirobenzoxazines, naphthopyrans, benzopyrans, spirooxazines, spironaphthopyrans, indolinospironaphthoxazines, indolinospironaphthopyrans, diarylnaphthopyrans, spiroindolinobenzopyrans, chromenes and organometallic materials. Specific examples of photochromic compounds include, but are not limited to Corn Yellow, Berry Red, Sea Green, Plum Red, Variacrol Yellow, Palatinate Purple, CH-94, Variacrol Blue D, Oxford Blue and CH-266, Corning CR-173, Corning CR-49, Corning Grey, Corning Brown and Robinson Grey 306. Preferably, a mixture of these compounds is used. Variacrol Yellow is a naphthopyran material, commercially available from Great Lakes Chemical in West Lafayette, Ind. Corn Yellow and Berry Red are naphthopyrans and Sea Green, Plum Red and Palatinate Purple are spironaphthoxazine materials commercially available from Keystone Anline Corporation in Chicago, Ill. Variacrol Blue D and Oxford Blue are spironaphthoxazine materials, commercially available from Great Lakes Chemical in West Lafayette, Ind. The photochromic coating composition may include one, two, or more photochromic compounds. Non-photochromic compounds such as Thermoplast Red and Thermoplast Blue may also be added to the photochromic coating composition to adjust the activated color of the formed coating layer, the unactivated color of the formed coating layer and/or the color of the lens when the coating layer is in its unactivated state.

The amount of total photochromic compounds in the photochromic coating composition may be at least about 0.2%, at least about 0.5%, at least about 0.75%, a t least about 1%, and at most about 5%, at most about 4%, at most about 3%, or at most about 2% of the total amount of polymerizable components of the photochromic coating composition. The concentration of each of the individual photochromic compounds in the photochromic coating composition may be at least about 0.2%, at least about 0.5%, at least about 1%, or at most about 5%, at most about 4%, at most about 3%, or at most about 2% of the total amount of polymerizable components of the photochromic coating composition. Having such levels of photochromic compounds in the photochromic coating composition may improve the absorbance of light when the photochromic coating layer is activated. Generally, higher concentrations of photochromic compounds improve the darkening effect of the lens when exposed to activating light (e.g., when the lens is exposed to sunlight). Improved absorbance of light by the photochromic coating layer in its activated state leads to more commercially acceptable products.

Monomers and/or oligomers for the photochromic coating composition may be selected from a broad range of materials including monoacrylates, diacrylates, multiacrylates, bisallyl carbonates, vinyl containing monomers, epoxy acrylates, urethane acrylates and the like. In some embodiments, monomers used in the photochromic coating composition include multiacrylate monomers. As used herein, diacrylate monomers are monomers that include two acrylate groups. As used herein, multiacrylate monomers are monomers that include three or more acrylate groups. Additionally, mixtures of multiacrylate monomers and allyl carbonates may be used. One class of polyacrylate monomers that may be used includes aromatic containing polyethylenic polyether functional monomers. Specific examples of monomers that may be used in the photochromic coating composition include, without limitation: dipentaerythritol pentaacrylate (SR-399), ethoxylated₄ bisphenol A dimethacrylate (SR-540), ethoxylated₂ bisphenol A dimethacrylate (SR-348), bisphenol A bis allyl carbonate (HiRi II), tris (2 hydroxyethyl) isocyanurate triacrylate (SR-368), polyethylene glycol (400) diacrylate (SR-344), trimethylopropane triacrylate (SR-351), ethoxylated₄ bisphenol A diacrylate (SR-601), ethoxylated₁₀ bisphenol A dimethacrylate (SR480), ethoxylated₃ trimethylopropane triacrylate (SR454), ethoxylated₄ pentaerithritol tetraacrylate (SR-494), tridecyl acrylate (SR-489), 3-(trimethoxysilyl) propyl methacrylate (PMATMS), 3-glycidoxypropyltrimethoxysilane (GMPTMS), tetraethylene glycol diacrylate (SR-268), neopentyl glycol diacrylate (SR-247), isobornyl methacrylate (SR-243), tripropylene glycol diacrylate (SR-306), diethylene glycol dimethacrylate (SR-231), 2 (2-ethoxyethoxy) ethylacrylate (SR-256), aromatic monoacrylate (CN-131), isobornyl methacrylate (SR-423), CN-262, vinyl containing monomers such as vinyl acetate and 1-vinyl-2 pyrrolidone, epoxy acrylates such as CN 104 and CN 120, and various urethane acrylates such as CN-962, CN-964, CN-980, and CN-965.

In one embodiment, a photochromic coating composition may include greater than 20% of one or more multifunctional acrylate monomers. As used herein, a multifunctional acrylate monomer is a molecule that includes three or more acrylate groups. In some embodiment, a photochromic coating composition may include at least 25% of one or more multifunctional acrylate monomers, between 20% and 85% multifunctional monomers, or between 25% and 70% multifunctional monomers. Generally, it has been found that the addition of photochromic compounds to a coating composition that is cured using activating light tends to slow down the curing time of the coating composition. It is generally known that multifunctional acrylates are more reactive, and thus cure faster, than difunctional acrylates and monofunctional acrylates. It has been found that photochromic coating compositions may be cured faster and more completely, using activating light, when the amount of multifunctional acrylate in the photochromic coating composition is greater than 20%.

The photochromic coating composition may also include one or more photoinitiators. Examples of photoinitiators that may be used include α-hydroxy ketones, α-diketones, acylphosphine oxides, and bis-acylphosphine oxide initiators. Examples of photoinitiators that may be used include, without limitation: bis(2,4,6-trimethylbenzoyl)-phenylphosphineoxide (Irgacure 819), 2-hydroxy-2-methyl-1-phenyl-propan-one-1 (Darocur 1173), 1-hydroxy-cyclohexyl-phenyl ketone (Irgacure 184), and benzophenone.

The photochromic coating composition may also include one or more co-initiators. Suitable co-initiators include amine co-initiators. Amines are defined herein as compounds of nitrogen formally derived from ammonia (NH₃) by replacement of the hydrogens of ammonia with organic substituents. Examples of co-initiators include, but are not limited to acrylyl amine co-initiators commercially available from Sartomer Company under the trade names of CN-381, CN-383, CN-384, and CN-386, where these co-initiators are monoacrylyl amines, diacrylyl amines, or mixtures thereof. Other co-initiators include ethanolamines. Examples of ethanolamines include but are not limited to N-methyldiethanolamine (NMDEA) and triethanolamine (TEA) both commercially available from Aldrich Chemicals. Aromatic amines (e.g., aniline derivatives) may also be used as co-initiators. Example of aromatic amines include, but are not limited to, ethyl-4-dimethylaminobenzoate (E-4-DMAB), ethyl-2-dimethylaminobenzoate (E-2-DMAB), n-butoxyethyl-4-dimethylaminobenzoate, p-dimethylaminobenzaldehyde, N,N-dimethyl-p-toluidine, and octyl-p-(dimethylamino)benzoate commercially available from Aldrich Chemicals or The First Chemical Group of Pascagoula, Miss.

Photochromic compounds which have utility for photochromic coating compositions may absorb activating light and change from an unactivated state to an activated state when exposed to activating light used to cure the coating composition. The presence of photochromic compounds, as well as other ultraviolet/visible light absorbing compounds within a photochromic coating composition, may not permit enough activating radiation to penetrate into the depths of the coating sufficient to cause photoinitiators to break down and initiate polymerization of the coating composition. Thus, it may be difficult to cure a photochromic coating composition using activating light (e.g., if the activating light has a wavelength in the ultraviolet or visible region). Addition of co-initiators may help to overcome the absorbance of activating light by photochromic compounds in the photochromic coating composition. It is believed that activating light which is directed toward the coating composition to activate the photoinitiator causes the photoinitiator to form a polymer chain radical. The polymer chain radical preferably reacts with the co-initiator more readily than with the monomer. The co-initiator may react with a fragment or an active species of either the photoinitiator or the polymer chain radical to produce a monomer initiating species where the level of activating light may be either relatively low or not present. The co-initiator also may help overcome oxygen inhibition of the polymerization reaction.

Other additives may be included in minor amounts to modify the stability and/or performance of the coating. Additives include compounds such as inhibitors, dyes, UV stabilizers, etc. Examples of such additives include hexamethyldisiloxane (HMDSO); bis (2,2,6,6-tetramethyl-4-piperidilyl) sebacate (Tinuvin 770); methyl (1,2,2,6,6-pentamethyl-4-piperidynyl) sebacate (Tinuvin 292); 1-decanedioic acid (Tinuvin 123); bis (2,2,6,6-tetramethyl-4-piperidinyl)ester); 2-hydroxy-4-methoxybenzophenone (Cyasorb UV-9); 2,2′-dihydroxy-4-methoxybenzophenone (Cyasorb UV-24); 2-hydroxy-4-n-octoxybenzophenone (Cyasorb UV-531); 2-(2′-hydroxy-3′,5′-di-tert-amylphenyl)benzotriazole (Cyasorb UV-2337); 2-(2′-hydroxy-5′-octylphenyl)benzotriazole (Cyasorb UV-5411); 2-(2′-hydroxy-5′-methylphenyl)benzotriazole (Cyasorb UV-5365); 2-[4,6-bis(2,4-dimethylphenyl)-1,3,5-triazin-2-yl]-5-(octyloxy) phenol (Cyasorb UV-1164); 2,2′-(1,4-phenylene)bis[4H-3,1-benzoxazin-4-one] (Cyasorb UV-3638); 3,5-di-tert-butyl-4-hydroxybenzoic acid; hexadecyl ester (Cyasorb UV-2908); [2,2-thiobis(4-tert-octylphenolato)]-n-butylamine nickel (II) (Cyasorb UV-1084); 1,6-hexanediamine, N,N′-bis(2,2,6,6-tetramethyl)-4-piperidinyl)-polymers with 2,4-dichloro-6-(4-morpholinyl)-1,3,5-triazine (Cyasorb UV-3346); 1,6-hexanediamine, N,N′-bis(1,2,2,6,6-pentamethyl-4-piperidinyl)-polymers with morpholine-2,4,6-tricholoro-1,3,5-triazine (Cyasorb UV-3529); 3-dodecyl-1-(2,2,6,6-tetramethyl-4-piperidyl)-pyrroldin-2,5-dione (Cyasorb UV-3581); hindered amine light stabilizers Cyasorb UV-3853 and Cyasorb UV-3853S commercially available from Cytec Industries, West Paterson, N.J.; bis (1,2,2,6,6-pentamethyl-4-piperidinyl)-[[3,5-bis(1,1-dimethylethyl)-4-hydroxyphenyl]methyl]butylmalonate (Tinuvin 144); 2,4-bis[N-butyl-N-(1-cyclohexyloxy-2,2,6,6-tetramethylpiperidin-4-yl)amino]-6-(2-hydroxyethylamine)-1,3,5-triazine (Tinuvin 152); bis (1,2,2,6,6-pentamethyl-4-piperidyl)sebacate and methyl (1,2,2,6,6-pentamethyl-4-piperidyl)sebacate (Tinuvin 765); Tinuvin B-75: (a mixture of 20% Irganox 1135 [benzenepropanoic acid, 3,5,-bis(1,1-dimethyl-ethyl)-4-hydroxy-, C₇, C₉ branched alkyl esters], 40% Tinuvin 571 [2-(2H-benzotriazol-2-yl)-6-dodecyl-4-methylphenol, branched and linear], and 40% Tinuvin 765; Chimassorb 944LD—light stabilizers poly [[6-[1,1,3,3-tetramethyl butyl]amino]-s-triazine-2,4-diyl][(2,6,6-tetramethyl-4-piperidyl[imino]hexamethylene[(2,2,6,6-tetrametyl-4-piperidyl]imino]]; Ferro Corp.—UV-Chek AM-340; 2,4-di-t-butylphenyl 3,5-di-t-butyl-4-hydroxybenzoate; 2(2′-hydroxy-5′methyl phenyl) benzotriazole (Tinuvin P); 2 hydroxy-4-(2-acryloyloxyethoxy) benzophenone (Cyanamid UV 2098); 2 hydroxy-4-(2 hydroxy-3-methacryloxy)propoxy benzophenone (National Starch and Chemicals Permasorb MA); 2,4 dihydroxy-benzophenone (BASF UVINUL 400); 2,2′-dihydroxy-4,4′ dimethoxy-benzophenone (BASF UVINUL D49); 2,2′, 4,4′ tetrahydroxy benzophenone (BASF UVINUL D-50); ethyl-2-cyano-3,3-diphenyl acrylate (BASF UVINUL D-35); 2-ethexyl-2-cyano-3,3-diphenyl acrylate (BASF UVINUL N-539); Tinuvin 213; bis (2,2,6,6-tetramethyl-4-piperidinyl) sebacate (Ciba Geigy 770); triethylene glycol-bis-3-(3-tertbutyl-4-hydroxy-5-methyl phenyl)propionate (Irganox 245); 2,2-bis[[3-[3,4-bis(1,1-dimethyl-ethyl)-4-hydroxyphenyl]-1-oxopropoxy]methyl]-1,3-propanediyl 3,5-bis(1,1-dimethyl ethyl)-4-hydroxy benzene propanoate Irganox (1010); octadecyl 3-(3′,5′-di-tert-butyl(4′-hydroxyphenyl) propionate (Irganox 1076); Triphenyl phosphine; 10 dihydro-9-oxa-10-phosphaphenanthrene-1-oxide; Dodecyl mercaptan; pentarythritol tetrakis (3-mercapto propionate) (TMP); Butyl mercaptan; thiophenol; methacrylic acid, maleic anhydride, acrylic acid; Sartomer 9008, Sartomer 9013, Sartomer 9015 etc.; dye-enhancing, pH-adjusting monomers like Alcolac SIPOMER 2MIM; a charge-reducing cationic monomer to render the material more antistatic, example Sipomer Q5-80 or Q9-75; and hydrophobic comonomers: Shin Nakamura NPG, P9-G etc. to reduce the water adsorption of the material. Tinuvin and Chimassorb additives are available from Ciba Specialties.

Photochromic coated lenses may be produced by using coating compositions that include a single photopolymerizable monomer, a single photochromic compound, and a suitable photoinitiator. In some embodiments, the photochromic performance of the resultant lens may be improved by use of more complex systems that include one or more photochromic compounds, one or more photopolymerizable monomers, one or more photoinitiators, and one or more co-initiators. One or more organic solvents may also be included in the photochromic coating composition. The inclusion of organic solvents may reduce the viscosity of the photochromic coating composition, thus improving the dispersion of the composition on the applied surface. Examples of organic solvents include, but are not limited to, benzene, toluene, and xylenes.

The photochromic coating composition may be applied to one or both mold members of a mold assembly. The mold members, preferably, are formed from a material that will not transmit activating light having a wavelength below approximately 300 nm. Suitable materials are Schott Crown, S-1 or S-3 glass manufactured and sold by Schott Optical Glass Inc., of Duryea, Pa. or Corning 8092 glass sold by Corning Glass of Corning, N.Y. A source of flat-top or single vision molds may be Augen Lens Co. in San Diego, Calif.

A variety of techniques may be used to apply the photochromic coating composition to a casting surface of a mold member. The photochromic coating composition may be applied to the mold member using spin, flow, spray, or dip methods. In one embodiment, a photochromic coating composition is applied using a spin coating process. The photochromic coating composition may be applied in a coat-to-waste apparatus or a suitable recirculating apparatus. A coat-to-waste system may offer advantages over other spin coating devices for product stability reasons. The photochromic coating may be applied to the front mold member, the back mold member, or both. In practice, however, the photochromic coating is normally only applied to the casting face of the front (concave) mold member. Methods of applying coatings to mold members are further described in U.S. Pat. No. 6,632,535 to Buazza et al., which is incorporated herein by reference.

After applying the photochromic coating composition to the mold member, activating light and/or heat may be directed at the mold member to cure at least partially cure the photochromic coating composition. The activating light may be directed toward either surface (i.e., the casting or non-casting faces) of the mold or both to cure the photochromic coating composition. Generally activating light sources with, at least, a spectral emission in the 200 nm to 450 nm range may be used for curing. Examples of light sources include, but are not limited to conventional mercury vapor lamps, photostrobe lamps, germicidal lamps and LED lamps.

One of the most difficult challenges to overcome when forming such photochromic coatings and at least partially curing them using photopolymerization methods prior to subsequent lens casting processes is related to difficulties in providing a desirable level and depth of cure of such coatings. It is desirable to ensure that a reasonable level and uniformity of cure throughout the entire thickness of the photochromic coating layer is achieved prior to proceeding with the lens casting process. If an acceptable level of cure is not achieved, the lens produced may exhibit waves and/or distortions caused by swelling of the coating from contact with and/or absorption of the lens forming composition. For example, the photochromic coating layer may, after attempting to cure the coating by exposing it to activating light, be reacted to dryness in the regions closest to the light source and remain either liquid or considerably less cured in the deeper regions of the coating layer. This is believed to be caused by the strong absorption of activating light by the photochromic compound, preventing enough activating light to reach the deeper regions and effect polymerization. To achieve desirable photochromic performance characteristics, for example, low activated transmission of visible light, it may be required to increase the concentration of photochromic compounds and/or the coating thickness thus creating depth of cure problems for the above-described reasons. Further, monomers which have high photochromic compound saturation points may be slow curing materials, making the efficient curing even more challenging. Attempting to overcome depth of cure issues by increasing the duration of the activating light exposure may cause undesirable effects including degradation of the photochromic compounds and/or poor adhesion with the lens forming composition. To minimize these undesirable effects, it is generally preferable to minimize the total amount of activating light directed toward the photochromic coating layer. Additionally, it is preferable to use as low a level of photoinitiator as possible because the photoinitiator also absorbs activating light strongly. Attempting to overcome depth of cure issues by the application of multiple coating layers and multiple coat curing steps of a number of relatively thinner coating layers are tedious and inefficient. Attempting to cure the photochromic coating either in an inert atmosphere environment or in a non-open casting cell environment are similarly tedious and inefficient. It is more desirable for efficiency reasons to simply apply and cure a single layer in air than overcoming the problem using these approaches.

The solutions to these level and depth of cure problems with photochromic coating layers may include 1) increasing the relative proportions of fast reacting monomers, e.g. multiacrylates, versus slower curing monomers, 2) incorporating coinitiators into the photochromic coating composition, 3) exposing the coating layer to activating light from both sides of the coating layer (e.g. directing activating light to both the casting and non-casting faces of the coated mold, 4) using activating light sources with high peak intensities and short exposure durations (e.g. photostrobe curing lamps). These solutions may be applied singly or in any combination of two or more approaches.

Some photochromic compounds may tend to degrade when exposed to high doses of activating light during curing of the photochromic coating composition. In one embodiment, filtering a portion of the activating light used to cure the photochromic coating composition may control degradation of photochromic compounds. For example, many photochromic compounds are activated by light having a wavelength of less than 400 nm (e.g., 370 mm). In an embodiment, activating light having a wavelength of less than 400 nm, or less than 370 nm, may be filtered out during curing of the photochromic coating composition. In one embodiment, a filter may be disposed between the activating light source and the mold member during curing to filter out wavelengths of light that would degrade or activate the photochromic compounds. When the spectral distribution of the activating light directed toward the photochromic coating during the coat curing process is controlled in such a way that the proportion of total energy in the longer wavelength region, e.g. greater than about 370 nm, is substantially higher than the total energy in the shorter wavelength region, e.g. less than about 370 nm, such coatings' level and depth of cure problems become easier to overcome, particularly when coinitiators are present in the coating compositions. Additionally, when the spectral distribution of the activating light directed toward the photochromic coating during the coat curing process is manipulated in such fashion, the level and depth of cure of photochromic coatings is also improved when curing compositions which contain a relatively high proportion of photochromic compounds which activate by exposure to short wavelengths versus the proportion of photochromic compounds which activate by exposure to longer wavelengths.

After the formation of an at least partially cured photochromic coating layer on the casting surface of one or both mold members, the mold members may be assembled to form a mold assembly by positioning a gasket, tape or other means between the mold members. The combination of the two molds and gasket form a mold assembly having a cavity defined by the two mold members. The casting surfaces, and therefore the photochromic coating, may be disposed on the surface of the formed mold cavity.

It is also possible to apply the photochromic coating to a mold surface, assemble the mold into a mold assembly prior to at least partially reacting the coating and subsequently react the coating prior to filling the mold cavity with the lens forming composition. This method preferably utilizes coating compositions that possess high enough viscosities such that no significant flow of the coating over the surface of the mold will occur between coating application and curing of the coat.

After the mold assembly has been constructed, a lens forming composition may be disposed within the mold assembly. An edge of the gasket may be displaced to insert the lens forming composition into the mold cavity. Alternatively, the gasket may include a fill port that will allow the introduction of the lens forming composition without having to displace the gasket. The lens forming composition includes a photoinitiator and a monomer that may be cured using activating light and/or heat. Examples of lens forming compositions that may be used are described in U.S. Pat. No. 6,632,535 to Buazza et al., which is incorporated herein by reference. When disposed within the mold cavity, the lens forming composition, in some embodiments, is in contact with the photochromic coating formed on the casting surface of one or both molds.

The mold assembly, filled with a lens forming composition, may then be cured by applying activating light, in the presence or absence of heat, to produce a polymeric lens. The polymeric lens may be removed from the mold assembly after curing. In some embodiments, the polymeric lens may be subjected to an annealing process by heating the polymeric lens. The formed polymeric lens may be in the form of a blank, semi-finished or finished lens that includes a photochromic coating layer adhering to outer surface of the lens.

In another embodiment, a hardcoat layer may first be applied to the casting face of a mold member prior to the formation of a photochromic coating layer. Specifically, a polymerizable hardcoat coating composition is applied to the casting face of a mold used to form an eyeglass lens. Hardcoat compositions and hardcoat layers have been previously described. For example, hardcoat layer may be a nanocomposite coating layer. In an embodiment, the hardcoat layer does not include any photochromic compounds. The hardcoat coating composition may be at least partially cured using light and/or heat to form a hardcoat layer. The hardcoat layer protects an underlying photochromic coating layer from chemical and/or physical damage. After the hardcoat layer has been formed, a photochromic coating composition that includes at least one photochromic compound is applied to the hardcoat layer of a mold used to form an eyeglass lens. The applied photochromic coating composition is at least partially cured to form a photochromic coating layer on the previously formed hardcoat layer. After forming the photochromic coating layer, the mold assembly is then filled with a lens forming composition and the lens forming composition cured with activating light and/or heat. The lens forming composition is then polymerized, resulting in a semi-finished lens blank or finished lens that includes a photochromic coating layer adhering to an outer surface of the lens and a hardcoat layer disposed upon the photochromic coating layer. In this fashion, other properties such as abrasion resistance may be imparted to the resultant eyeglass lens.

The hardcoat layer may be formed by applying a hardcoat coating composition to a mold member. In one embodiment, the hardcoat coating composition includes nanoparticles. The hardcoat coating composition may include one or more monomers and one or more initiators. The hardcoat coating layer may have a thickness ranging from at least about 15 μm, or ranging from about 10 μm to about 100 μm, from about 15 μm to about 30 μm, or from about 20 μm to about 25 μm.

Photopolymerizable monomers and/or oligomers for the hardcoat coating composition may be selected from a broad range of materials including, but not limited to monoacrylates, diacrylates, multiacrylates, bisallyl carbonates, vinyl containing monomers, epoxy acrylates, and the like. In some embodiments, monomers used in the protective coating composition include polyacrylate monomers (e.g., monomers that include two or more acrylate groups). One class of polyacrylate monomers that may be used includes aromatic containing polyethylenic polyether functional monomers. Specific examples of polyacrylate monomers that may be used in the protective coating composition include, without limitation: dipentaerythritol pentaacrylate (SR-399), ethoxylated₄ bisphenol A dimethacrylate (SR-540), ethoxylated₂ bisphenol A dimethacrylate (SR-348), tris (2 hydroxyethyl) isocyanurate triacrylate (SR-368), polyethylene glycol (400) diacrylate (SR-344), trimethylopropane triacrylate (SR-351), ethoxylated₄ bisphenol A diacrylate (SR-601), ethoxylated₁₀ bisphenol A dimethacrylate (SR480), ethoxylated₃ trimethylopropane triacrylate (SR454), ethoxylated₄ pentaerithritol tetraacrylate (SR-494), tridecyl acrylate (SR-489), 3-(trimethoxysilyl) propyl methacrylate (PMATMS), 3-glycidoxypropyltrimethoxysilane (GMPTMS), tetraethylene glycol diacrylate (SR-268), neopentyl glycol diacrylate (SR-247), isobornyl methacrylate (SR-243), tripropylene glycol diacrylate (SR-306), diethylene glycol dimethacrylate (SR-231), 2 (2-ethoxyethoxy) ethylacrylate (SR-256), aromatic monoacrylate (CN-131), vinyl containing monomers such as vinyl acetate and 1-vinyl-2 pyrrolidone, epoxy acrylates such as CN 104 and CN 120, and various urethane acrylates such as CN-962, CN-964, CN-980, and CN-965.

In some embodiments, monomers that include one or more nanoparticles may be used in the protective coating composition. In one embodiment, a monomer may be mixed with nanoparticles as described above. In one embodiment, silica treated polymerizable monomers may be used alone or in combination with other silica treated, or non-silica treated, monomers to form a hardcoat layer. Silica treated monomers are commercially available from Hans Chemie, sold under the name of Nanocryl.®

The hardcoat coating composition may also include one or more photoinitiators. Examples of photoinitiators that may be used include α-hydroxy ketones, α-diketones, acylphosphine oxides, and bis-acylphosphine oxide initiators.

Hardcoat coating layers may have a Bayer Ratio of at least about 5, between about 5 and about 15, or between about 7 and about 12. Bayer Ratio was measured using the protocol described in Colts Laboratory test number L-11-10-06 which is incorporated herein by reference. Hardcoat coating layers may have a thickness of at least about 5 μm, at least about 15 μm, or between about 15 μm to about 30 μm.

After applying the hardcoat coating composition to the mold member, activating light and/or heat may be directed at the mold member to at least partially cure the hardcoat coating composition. In some embodiments, the hardcoat coating composition may be completely cured. The activating light may be directed toward either surface (i.e., the casting or non-casting faces) of the mold to cure the hardcoat coating composition. Generally, activating light sources with, at least, a spectral emission in the 200 nm to 450 nm range may be used for curing. Examples of light sources include, but are not limited to conventional mercury vapor lamps, photostrobe lamps, LED light sources, and germicidal lamps.

In another embodiment, the photochromic coating layer may be formed either directly on the casting surface of the mold or on the aforementioned hardcoat layer in two or more subsequent application steps. Specifically, multiple applications of photochromic coating compositions, producing multiple photochromic coating layers, may be applied. The photochromic compounds and/or monomers used form each photochromic coating layer may be the same or different. In one embodiment, a first photochromic coating layer that includes one or more photochromic compounds may be formed on the casting surface of the mold or on a hardcoat layer applied to the casting surface of the mold. A second photochromic coating layer may be formed on the first photochromic coating layer. The second photochromic coating layer may include one or more photochromic compounds that are activated upon exposure to light at a higher wavelength than the wavelength(s) of light that activates the photochromic compounds in the first photochromic coating layer. In one embodiment, the photochromic compounds in the first photochromic coating layer may be activated at wavelengths of light between about 300 and about 350 nm (e.g., 320 nm). Photochromic compounds in the second photochromic coating layer may be activated at wavelengths of light between about 350 nm and 400 nm (e.g., 380 μm).

In yet another embodiment, an inner coating layer may be subsequently applied to the photochromic coating layer. In this fashion, the photochromic containing coating layer may be substantially separated from the lens forming composition by the inner coating layer. Separating the photochromic coating layer from the lens forming composition may protect the photochromic coating layer from degradation by one or more components of the lens forming composition. For example, in some lens forming compositions, polymerization initiators may degrade the photochromic compounds in the photochromic coating layer during curing of the lens forming composition.

In an alternate embodiment, a photochromic coating may be formed on a surface of a lens using an out of mold coating process. In one embodiment, a semi-finished photochromic lens blank or finished photochromic lens is prepared by applying a photochromic coating composition to a surface of the lens. This applied photochromic coating composition is cured such that the formed photochromic coating layer will remain substantially intact on the surface of the lens. In some embodiments, an organic solvent may be added to the photochromic coating composition to reduce the viscosity of the coating composition and allow easier application of the coating composition to a formed lens. In some embodiments, a hardcoat layer may be formed on the photochromic coating layer.

In order to achieve commercially desirable photochromic performance characteristics, for example low activated visible light transmittance, the in-mold photochromic coating usually contains a high concentration of photochromic compounds relative to in-body photochromic lens forming compositions (i.e., placing photochromic compounds in the lens forming composition, rather than coating an outer surface of the lens). For the purposes of this application, the terms visible light transmittance and luminous transmittance are used interchangeably. This requirement creates challenges in two primary ways. The first is that many photochromic compounds exhibit limited solubility in many liquid monomers and it may be difficult to achieve a high enough concentration of photochromic compound in the polymerizable monomer composition to realize low activated visible light transmittance in the resultant lens. The second challenge is that photochromic coating compositions tend to darken when being cured by photopolymerization methods and, therefore, tend to block the light required by the photoinitiator to initiate the photopolymerization reaction. This blocking of light may create problems with respect to depth of cure. Generally, the application of the initial curing light dose is conducted by directing the curing light directly toward the coated mold surface. However, when a transparent glass mold is used, the coat curing light dose may also be applied to the opposite non-coated mold surface, either by itself or in combination with coat curing light dose applied from the direction of the coated mold face. Enough energy may be transmitted through the mold to effect curing of the photochromic coating. This is one method of overcoming depth of cure issues.

Related to this curability issue, is that photochromic compounds may tend to degrade when exposed to high doses of radiation during the photochromic coating polymerization process. By design of the monomer system, photoinitiator system, the curing light source, and curing process of the photochromic containing in-mold coating, a lens product with desirable photochromic performance properties may be produced.

It may be difficult to provide a highly cured photochromic coating without significant degradation of the photochromic compounds. The in-mold method addresses this problem by conducting the curing of the coating in two stages. The first stage is curing the photochromic coating on the mold. It is generally preferred that the photochromic coating be dosed with just enough curing radiation to bring the coating layer to a level of cure where it will not be significantly affected by contact with the liquid lens forming composition during the subsequent lens casting process, i.e. wash away and/or swell and form optical distortions. This state may be described as a dry gel state. The second stage occurs during the lens casting process. After the coated mold is assembled into the mold assembly and the cavity filled with the lens forming composition and the polymerization of the lens forming composition initiated, the coating composition will further react and cure without significant degradation of the photochromic compound molecules. It is believed that this occurs primarily because the coating is being further cured in an anaerobic environment during the lens casting stage of the process and oxygen inhibition of the reaction is overcome in this fashion.

Photochromic lens performance may be defined by a number of different attributes. They include the lenses' visible light transmittance and color in both its unactivated and activated states, the rate at which it switches between these states, and the dependency of these attributes on the temperature of the lens.

Activating the photochromic compounds in a photochromic lens and thus causing the darkening of the lens may be accomplished by a variety of methods. Most preferably this is accomplished by exposing the lens to natural sunlight; this gives the best estimation of the performance of the lens in its intended environment Natural sunlight may not be available, for example, on cloudy days or at night, and artificial light sources are used in the laboratory environment to darken a photochromic lens. There are a variety of artificial light sources that emit wavelengths of light that will cause the activation of a photochromic lens. These include for example, fluorescent black light sources, xenon lamps, mercury vapor lamps and the like.

There is a relationship between the activated visible light transmittance of a lens produced by this method and the photochromic compound containing coatings' thickness and photochromic concentration. Equivalent activated visible light transmittance can be achieved in a thinner coating with a high photochromic compound concentration or with a thicker coating with a lower photochromic compound concentration. Generally, the preferred coating thicknesses range from 1-micron to 150-microns although photochromic coatings up 500 microns have been formed. The coating thickness may be controlled by means well-known in the art including viscosity manipulation, spin speed, spin-off time etc.

The photochromic compound concentrations of these coatings are required to be quite high to achieve low activated luminous transmittance for lenses formed by this method, relative to in-body photochromic lens forming compositions; 0.2%-4.0% vs. 10 ppm to 2,000 ppm or less, for example. A particular monomer will have a certain saturation point for a particular photochromic compound. This saturation point may be below the photochromic compound concentration level required to provide the desired photochromic performance. A monomer that has a higher photochromic compound saturation point may not be fast reacting enough to fulfill curability criteria. Mixtures of various faster reacting monomers may be used with suitable adjustments to the photoinitiator system to provide a photochromic coating composition that balances photochromic compound concentration, curability, and coating thickness to provide a coating with improved photochromic attributes.

In one embodiment, the coating applied to the mold may be well enough cured prior to assembly of the mold set so as to be substantially unaffected by the liquid lens forming composition dispensed into the cavity. In one embodiment, the photochromic coating may reach this level of cure throughout its thickness, not just on its surface or optical distortions may occur from swelling of the coat by the lens forming composition. This may be difficult in some cases because the photochromic compounds will tend to darken when exposed to the curing radiation, preventing the curing radiation from penetrating deep enough into the coating film to react it properly. The use of amine type co-initiators is particularly advantageous to overcome this difficulty. The photoinitiator identity and concentration also impacts the curing efficiency for a particular monomer/photochromic compound system.

In one embodiment, it is possible to form an organic photochromic eyeglass lens by a method wherein a liquid protective layer (e.g., a hardcoat composition) is first applied to the casting surface of an eyeglass lens mold and at least partially cured prior to the application and at least partial curing of a liquid photochromic coating composition. In this fashion, the organic photochromic eyeglass lens prepared by using such a mold can be rendered abrasion resistant. An example of such an embodiment is described below.

### EXAMPLE 4

### PCC-8441 Photochromic Coating with HC-7314-2 Hardcoat

In an embodiment, a particularly preferred photochromic compound containing coating composition referred to as PCC-8441 Photochromic Coating was prepared comprising the following materials by weight:

| | |
|---|---|
| 45.25% | SR-399 |
| 45.16% | HiRi II |
| 7.54% | CN-386 |
| 0.35% | Irgacure 819 |
| 1.7% | CR-173 |

The PCC-8441 coating was prepared by the following method. All components were mixed as received from the supplier without any filtration or purification. A photochromic compound containing stock solution was prepared by placing 312.9 grams of HiRi II in a glass beaker. The material was progressively heated in a microwave oven to approximately 270° F., periodically removing the beaker from the oven and stirring the material to maintain a uniform temperature. In this case, the material was removed four times and its temperature was measured at 170° F., 220° F., 250° F., and 270° F. When the HiRi II was at a temperature of about 255° F. to 265° F., 14.47 grams of CR-173 was added to the HiRi II and stirred until completely dissolved. The material was then placed in an opaque bottle and allowed to cool to room temperature, then sealed and stored. The photochromic compound stock solution comprised 95.58% HiRi II and 4.42% CR-173 by weight. Stock solutions of up to 10% by weight of CR-173 have been successfully prepared by this method, e.g. there was no re-crystallization of the CR-173 at room temperature.

Next, a photoinitiator stock solution was prepared by the following method. 240 grams of HiRi II was placed in a glass beaker and was progressively heated to approximately 170° F. to 200° F. in a microwave oven. The beaker was shielded from light and 10 grams of Irgacure 819 was added to the beaker and the contents stirred until the Irgacure 819 was completely dissolved. The material was then transferred to an opaque bottle and stored. The photoinitiator stock solution comprised 96.0% HiRi II and 4.0% Irgacure 819 by weight.

Next, 342.8 grams of SR-399 was placed in a glass beaker and warmed in a microwave to approximately 130° F. to 150° F. 57.2 grams of CN 386 was added to the beaker and the mixture stirred until well mixed. The mixture was transferred to an opaque bottle and stored. This solution comprised 85.7% SR-399 and 14.3% CN-386 by weight.

The final PCC-8441 composition was prepared by warming 220.25 grams of the photochromic containing stock solution to approximately 120° F. to 130° F. in a glass beaker. 50.17 grams of the photoinitiator stock solution was then added to this and mixed well. Finally, 302.4 grams of the SR-399/CN 386 stock solution which was heated to 120° F. to 130° F. was then added to the beaker and mixed well to form the final PCC-8441 composition.

The preparation of the final composition and the preparation of the photoinitiator stock solution may be conducted in an area in which there are no wavelengths of light present which the photoinitiator will react to and initiate prepolymerization or polymerization of the composition. In this case, preparation of the compositions was conducted in a room equipped with yellow lights.

A hardcoat coating composition referred to as HC-7314-2 Hardcoat was prepared comprising the following materials by weight:

| | |
|---|---|
| 69.95% | SR-344 |
| 10% | SR-399 |
| 10% | SR-494 |
| 8.5% | XP-2357 |
| 1.55% | Darocur 1173 |

The HC 7314-2 coating was prepared by the following method at room temperature in a room equipped with yellow lights. All components were mixed as received from the supplier without any filtration or purification. First, 444.4 grams of SR-344 was added to a glass beaker. To this 54.0 grams of XP 2357 was stirred in and mixed well. Next, 63.53 grams of SR494 and 63.53 grams of SR-399 were added and mixed well. Finally, 9.85 grams of Darocur 1173 was added and mixed well. The final composition was transferred to an opaque container and stored.

An eyeglass lens containing the in-mold PCC 8441 photochromic coating and the in-mold HC 7314-2 hardcoat was prepared by the following method. A concave (front) 6.00D single vision glass mold was cleaned by soaking it in a mixture of water, lauryl sulfate and sodium hydroxide for one minute. The mold was removed from this solution, scrubbed, and rinsed thoroughly under running tap water. The mold was sprayed with isopropyl alcohol, place on the spin stage of a Q-2100R unit, commercially available from Optical Dynamics Corporation of Louisville, Ky. The mold was allowed to spin dry and the spin was then stopped. Approximately 2.3 grams of the aforementioned HC-7314-2 Hardcoat composition was dispensed onto the center of the glass mold while the mold was not rotating. The mold was then spun for ten seconds at 850 rpm causing the hardcoating composition to spread over the casting surface of the mold and the excess composition to be spun off the edge of the mold. The rotation was stopped and the mold and the spin stage was then removed from the Q-2100R unit and the stage and mold was placed in a holder on the countertop which held the mold in a horizontal orientation with the coated mold surface facing upward. A White Lightning X-3200 photostrobe equipped with a quartz glass xenon lamp, commercially available from Paul C. Buff Inc. of Nashville, Tenn. was placed over the mold such that the distance between the plane of the quartz lamp and the plane of the edge of the mold was approximately 30 mm-35 mm and the mold was centered relative to the quartz lamp using the lamps' circular reflector as an alignment guide. The coating was then exposed to one flash of the strobe lamp at a 50% power setting, causing the coating to be cured to dryness. It is believed that the resultant coating thickness was approximately 22 microns, based upon curve fitting measurement methods of the coatings' reflectance spectra between 800 and 900 nm wavelength range using apparatus and software commercially available from Filmetrics Inc. of San Diego, Calif. The mold was next removed from the stage and placed on a scale and the scale was tared. Approximately 2.5 grams of the PCC 8441 Photochromic Coating was then dispensed onto the center of the glass mold. The mold was then returned to the spin stage in a Q-2100R unit and spun for 10 seconds at 600 rpm causing the coating composition to spread evenly over the previously hardcoated mold surface and the excess composition to be spun off the edge of the mold. The photochromic coated mold was then placed into the counter top holder in the same orientation described previously and the coated mold surface was exposed to four flashes from the strobe lamp at the 50% power setting, causing the photochromic coating to be cured to dryness. The mold was returned to the tared scale, weighed, and approximately 1.1 gram of the PCC 8441 coating was found to be remaining on the mold. It is believed that the resultant photochromic film thickness is approximately 100 microns based upon computations using the weight of the photochromic composition remaining on the mold, the surface area of the mold, and the density of the composition. The coated mold was then assembled into a gasket along with a 6.00D convex (back) mold to form an eyeglass lens mold assembly. The mold assembly was placed on the countertop with the non-casting surface of the front mold facing upward and the mold assembly was exposed to one flash from the strobe lamp. It is believed that this step may help to further react the regions of the photochromic coating proximate the casting surface of the mold and also help cure the photochromic coating on the edge of the mold proximate the gasket wall and improve the seal between the mold and gasket. The cavity of the mold assembly was then filled with OMB-99 Lens Monomer, commercially available from Optical Dynamics Corporation of Louisville, Ky. and the eyeglass lens monomer was polymerized using the conventional Q-2100R lens casting process as described in U.S. Pat. No. 6,712,331 which is incorporated herein by reference.

After the lens polymerization process was completed, the resultant eyeglass lens was removed from the mold assembly, cleaned, annealed for ten minutes at 100° C., and allowed to return to room temperature.

The adhesion of the hardcoat layer to the photochromic coating layer and the adhesion of the photochromic layer to the eyeglass lens was tested using a crosshatch adhesion tape pull method wherein a crosshatch pattern is scribed with a razor blade through the coating layers to the lens polymer and a series of three tape pulls using Scotch Brand #600 tape over the crosshatched area was conducted. No coating adhesion loss effects were observed.

The lens was left in the dark for twelve hours and its unactivated luminous transmittance measured found to be approximately 87.5% using a Byk Gardner HazeGard Plus instrument.

The lens was then placed in a photochromic testing apparatus wherein temperature controlled air is blown over the lens at a flow rate of approximately 4.0 to 5.0 m/second while the lens is being exposed to sunlight. The apparatus was adjusted such that the angle of the sun to the lens was approximately perpendicular. The temperature of the air moving over the lens was then varied over a range, causing the lens temperature to also vary. Luminous transmittance measurements were taken at various air temperatures using the aforementioned Byk Gardner HazeGard Plus apparatus by removing the lenses from their fixtures and quickly taking measurements before the lenses began to deactivate. Usually these measurements are completed within five seconds of removal from the photochromic testing apparatus. It is noted that there maybe some inaccuracy in these measurements because of the lag time between removal and measurement, particularly at higher temperatures as the deactivation rates tend to increase greatly at higher temperatures. For reference purposes, two commercially available lens products were simultaneously tested, e.g. they were placed in the tester along with the test lenses and exposed to the same temperature and irradiance conditions at the same time as the test lenses. The results of this test are shown in FIG. 1. As can be seen, it is possible to form a photochromic lens by the method of the current invention with activated luminous transmittance performance similar to commercially available products.

Additional examples of photochromic-coated lenses are given in Tables 1-14. The activated luminous transmittance data provided for the lenses described in Tables 1-14 were taken using a Byk Gardner HazeGard Plus instrument after the lenses had been exposed for two minutes to the radiation of three Sylvania F15-T8 350BL lamps mounted in a fixture driven by a Mercron lamp driver and adjusted to provide an intensity of approximately 2.8 mW/cm² as measured with a International Light IL-1400 radiometer equipped with an XRL-340B detector at the plane of the lens being tested.

TABLE 1

| | Composition by Weight % | | | | | | |
|---|---|---|---|---|---|---|---|
| | Formulation ID # | | | | | | |
| | Component | 844-A | 844-A | 844-B | 844-C | 844-D | 844-E |
| Monomers | SR-399 | 98.68 | 98.68 | 85.38 | | | |
| | HiRi II | | | | | | 97.95 |
| Photoinitiators | Irgacure 819 | 0.12 | 0.12 | 0.12 | 0.35 | 1.22 | 0.35 |
| Coinitiator | CN-386 | | | 13.3 | 98.41 | 97.54 | |
| Photochromic | CR-173 | 1.2 | 1.2 | 1.2 | 1.24 | 1.24 | 1.7 |
| Remarks | Coat Curing Dose | 2 @ | 4 @ | 3 @ | 20 @ | 20 @ | 20 @ |
| | (Casting Surface) # | ½ power | ½ power | ½ power | ½ power | ½ power | ½ power |
| | Flashes - Power | | | | | | |
| | Coat Curing Dose | 2 @ | 2 @ | 2 @ | | | |
| | (Noncasting | ½ power | ½ power | ½ power | | | |
| | Surface) # Flashes - | | | | | | |
| | Power | | | | | | |
| | Coating | Dry | Frosty, | Good | No cure | No cure | No cure |
| | Appearance | surface, | coating | | | | |
| | | liquid gel | cracked | | | | |
| | | inside | | | | | |
| | Unactivated | | 85 | 88.9 | | | |
| | Transmittance (%) | | | | | | |
| | Activated | | 17 | 17.3 | | | |
| | Transmittance (%) | | | | | | |
| | Coat Thickness | | >200 | ≧100 | | | |
| | (μm) | | | | | | |
| | Other | | Coating | Coating | | | |
| | | | adhesion | adhesion | | | |
| | | | good | good | | | |

TABLE 2

| | Composition by Weight % | | | | | | |
|---|---|---|---|---|---|---|---|
| | Formulation ID # | | | | | | |
| | Component | 844-F | 844-G | 844-H | 8441 | 81041 | 81042 |
| Monomers | SR-399 | | 99.56 | 99.48 | 45.25 | | |
| | SR-540 | | | | | 98.2 | 88.36 |
| | HiRi II | 88.82 | | | 45.16 | | |
| Photoinitiators | Irgacure 819 | 0.35 | 0.04 | 0.12 | 0.35 | 0.59 | 0.53 |
| Coinitiator | CN-386 | | | | | | 10.0 |
| Photochromic | CR-173 | 1.7 | 0.4 | 0.4 | 1.7 | 1.21 | 1.11 |
| Remarks | Coat Curing Dose | 20 @ | 4 @ | 1 @ | 4 @ | 20 @ | 15 @ |
| | (Casting Surface) # | ½ power | ½ power | ½ power | ½ power | ½ power | ½ power |
| | Flashes - Power | | | | | | |
| | Coat Curing Dose | | 4 @ | 1 @ | 2 @ | 5 @ | 5 @ |
| | (Noncasting | | ½ power | ½ power | ½ power | ½ power | ½ power |
| | Surface) # Flashes - | | | | | | |
| | Power | | | | | | |
| | Coating | No cure | Poor | OK | Good | Tacky gel | Tacky gel |
| | Appearance | | wrinkled | | | | |
| | Unactivated | | 88 | 83.8 | 87.1 | 87.4 | 89.1 |
| | Transmittance (%) | | | | | | |
| | Activated | | 13.4 | 19.6 | 13.7 | 34.7 | 24.8 |
| | Transmittance (%) | | | | | | |
| | Coat Thickness | | >230 | ≧230 | 100+/− | 90 | 70 |
| | (μm) | | | | | | |
| | Other | | Coating | Coating | Coating | Slow fading | Fast |
| | | | adhesion | adhesion | adhesion | not | activation |
| | | | good | good | good | fingernail | and fade, |
| | | | | | | scratchable | fingernail |
| | | | | | | | scratchable |

TABLE 3

| | Composition by Weight % | | | | | | |
|---|---|---|---|---|---|---|---|
| | Formulation ID # | | | | | | |
| | Component | 81043 | 8534 | 8544 | 8841 | 42941 | 42942 |
| Monomers | SR-399 | 49.34 | 47.25 | 32.17 | 36.22 | 66.94 | 63.93 |
| | SR-540 | 49.1 | 41.21 | 52.65 | 49.7 | 32.24 | 30.79 |
| Photoinitiators | Irgacure 819 | 0.355 | 0.35 | 0.343 | 0.352 | 0.11 | 0.105 |
| Coinitiator | CN-384 | | | | | | 2.25 |
| | CN-386 | | 10.0 | 13.34 | 12.3 | | 2.25 |
| Photochromics | CR-173 | 1.205 | 1.2 | 1.5 | 1.43 | 0.706 | 0.674 |
| Remarks | Coat Curing Dose | 4 @ | 4 @ | 4 @ | 4 @ | 2 @ | 2 @ |
| | (Casting Surface) # | ½ power | ½ power | ½ power | ½ power | full | full |
| | Flashes - Power | | | | | power | power |
| | Coat Curing Dose | 2 @ | 2 @ | 2 @ | 2 @ | | |
| | (Noncasting | ½ power | ½ power | ½ power | ½ power | | |
| | Surface) # Flashes - | | | | | | |
| | Power | | | | | | |
| | Coating | Good | Good | Good | Good | Good | Good |
| | Appearance | | | | | | |
| | Unactivated | 85.4 | 88.2 | 88.7 | 88.1 | 89.5 | 89.6 |
| | Transmittance (%) | | | | | | |
| | Activated | 16.0 | 15.5 | 14.9 | 13.8 | 16.6 | 17.1 |
| | Transmittance (%) | | | | | | |
| | Coat Thickness | 150 | 100 | 85 | 85 | 100 | 100 |
| | (μm) | | | | | | |
| | Other | | | Fast | | | |
| | | | | fading | | | |

TABLE 4

| | Composition by Weight % | | | | | | |
|---|---|---|---|---|---|---|---|
| | Formulation ID # | | | | | | |
| | Component | 42943 | 42944 | 4134-PP | 4134-SG | 4134-VB | 4134-VY |
| Monomers | SR-399 | 68.7 | 66.39 | 65.4 | 65.4 | 65.4 | 65.4 |
| | SR-540 | 28.9 | 30.76 | 29.26 | 29.16 | 29.16 | 29.16 |
| Photoinitiators | Irgacure 819 | 0.127 | 0.118 | 0.101 | 0.101 | 0.101 | 0.101 |
| | Darocur 1173 | 0.1 | 0.044 | 0.136 | 0.136 | 0.136 | 0.136 |
| Coinitiator | CN-384 | 2.25 | 1.0 | 2.35 | 2.35 | 2.35 | 2.35 |
| | CN-386 | 2.25 | 1.0 | 2.35 | 2.35 | 2.35 | 2.35 |
| Photochromics | CR-173 | 0.637 | 0.675 | | | | |
| | Variacrol Blue D | | | | | 0.5 | |
| | Variacrol Yellow | | | | | | 0.5 |
| | Palatinate Purple | | | 0.4 | | | |
| | Sea Green | | | | 0.5 | | |
| Remarks | Coat Curing Dose | 1 @ | 2 @ | 1 @ | 1 @ | 1 @ | 1 @ |
| | (Casting Surface) # | full power | full | full | full | full | full |
| | Flashes - Power | | power | power | power | power | power |
| | Coat Curing Dose | | | | | | |
| | (Noncasting | | | | | | |
| | Surface) # Flashes - | | | | | | |
| | Power | | | | | | |
| | Coating | Good | Good | Good | Good | Good | Good |
| | Appearance | | | | | | |
| | Unactivated | 89.5 | 88.8 | 85.3 | 88.0 | 84.3 | 90.0 |
| | Transmittance (%) | | | | | | |
| | Activated | 17.3 | 13.6 | 31.5 | 34.5 | 46.6 | 78.0 |
| | Transmittance (%) | | | | | | |
| | Coat Thickness | 100 | >100 | | | | |
| | (μm) | | | | | | |

TABLE 5

| | Composition by Weight % | | | | | | |
|---|---|---|---|---|---|---|---|
| | Formulation ID # | | | | | | |
| | Component | 4134-BR | 4134-PR | 4134-A | 4134-B | 4134-49 | 4154-10 |
| Monomers | SR-399 | 65.4 | 65.4 | 65.4 | 65.4 | 65.4 | 65.4 |
| | SR-540 | 29.16 | 29.16 | 28.66 | 28.96 | 28.96 | 28.96 |
| Photoinitiators | Irgacure 819 | 0.101 | 0.101 | 0.101 | 0.101 | 0.101 | 0.101 |
| | Darocur 1173 | 0.136 | 0.136 | 0.136 | 0.136 | 0.136 | 0.136 |
| Coinitiator | CN-384 | 2.35 | 2.35 | 2.35 | 2.35 | 2.35 | 2.35 |
| | CN-386 | 2.35 | 2.35 | 2.35 | 2.35 | 2.35 | 2.35 |
| Photochromics | Berry Red | 0.5 | | | | | |
| | Plum Red | | 0.5 | | | | |
| | CR-173 | | | 1.0 | 0.7 | | |
| | CR-49 | | | | | 0.7 | |
| | Corning Grey | | | | | | 0.5 |
| Remarks | Coat Curing Dose | 1 @ | 1 @ | 1 @ | 1 @ | 1 @ | 1 @ |
| | (Casting Surface) # | full power | full | full | full | full | full |
| | Flashes - Power | | power | power | power | power | power |
| | Coat Curing Dose | | | | | | |
| | (Noncasting | | | | | | |
| | Surface) # Flashes - | | | | | | |
| | Power | | | | | | |
| | Coating | Good | Good | Depth of | OK | OK | Good |
| | Appearance | | | cure issue | | | |
| | Unactivated | 89.6 | 84.8 | 88.9 | 89.6 | 86.6 | 87.1 |
| | Transmittance (%) | | | | | | |
| | Activated | 25.6 | 24.5 | 15.8 | 18.4 | 10.3 | 15.5 |
| | Transmittance (%) | | | | | | |

TABLE 6

| | Composition by Weight % | | | | | | |
|---|---|---|---|---|---|---|---|
| | Formulation ID # | | | | | | |
| | Component | 4154-11 | 4244-2 | 494-6A | 494-6B | 4114-4A | 4114-4B |
| Monomers | SR-399 | 65.4 | 63.5 | 58.98 | 58.98 | 62.36 | 62.36 |
| | SR-540 | 29.11 | 25.81 | 39.55 | 39.55 | 33.2 | 33.2 |
| | SR-247 | | 5.0 | | | | |
| Photoinitiators | Irgacure 819 | 0.101 | 0.101 | 0.16 | 0.16 | 0.081 | 0.081 |
| | Darocur 1173 | 0.136 | 0.136 | | | 0.162 | 0.162 |
| | Irgacure 184 | | | 0.321 | 0.321 | | |
| | Benzophenone | | | 0.318 | 0.318 | | |
| Coinitiator | CN-384 | 2.35 | 2.35 | | | 1.62 | 1.62 |
| | CN-386 | 2.35 | 2.35 | | | 1.62 | 1.62 |
| Photochromics | CR-49 | | | | | 0.24 | 0.24 |
| | Corning Grey | | 0.75 | | | 0.60 | 0.60 |
| | Corning Brown | 0.55 | | | | | |
| | Variacrol Blue D | | | 0.06 | 0.06 | 0.01 | 0.01 |
| | Variacrol Yellow | | | 0.082 | 0.082 | 0.014 | 0.014 |
| | Berry Red | | | 0.168 | 0.168 | 0.029 | 0.029 |
| | Palatinate Purple | | | 0.0345 | 0.0345 | 0.006 | 0.006 |
| | Corn Yellow | | | 0.0686 | 0.0686 | 0.012 | 0.012 |
| | Sea Green | | | 0.0725 | 0.0725 | 0.013 | 0.013 |
| | Plum Red | | | 0.1 | 0.1 | 0.0175 | 0.0175 |
| | Oxford Blue | | | 0.09 | 0.09 | 0.0157 | 0.0157 |
| Remarks | Coat Curing Dose | 1 @ | 1 @ | Cured w/ | Cured w/ | 1 @ | 2 @ |
| | (Casting Surface) # | full power | full | UVEXS | UVEXS | full | full |
| | Flashes - Power | | power | mercury | mercury | power | power |
| | | | | vapor | vapor | | |
| | | | | lamp | lamp | | |
| | | | | 1 slow | 4 slow | | |
| | | | | pass | passes | | |
| | Coating | OK | OK | Tacky | Tacky | Tacky | Dry |
| | Appearance | | | | | | |
| | Unactivated | 85.3 | 87.0 | 86.0 | 83.9 | 84.7 | 86.6 |
| | Transmittance (%) | | | | | | |
| | Activated | 13.4 | 10.6 | 32.9 | 30.8 | 13.1 | 19.1 |
| | Transmittance (%) | | | | | | |

TABLE 7

| | Composition by Weight % | | | | | | |
|---|---|---|---|---|---|---|---|
| | Formulation ID # | | | | | | |
| | Component | 4124-17 | 4124-18 | 574-1A | 574-1B | 594-4A | 594-4B |
| Monomers | SR-399 | 68.51 | 66.91 | 65.68 | 65.68 | 73 | 73 |
| | SR-540 | 25.33 | 27.0 | 28.15 | 28.15 | 3.52 | 3.52 |
| | SR-423 | | | | | 18.44 | 18.44 |
| Photoinitiators | Irgacure 819 | 0.08 | 0.147 | 0.22 | 0.22 | 0.25 | 0.25 |
| | Darocur 1173 | 0.16 | 0.155 | | | | |
| Coinitiators | CN-384 | 2.58 | 2.52 | | | | |
| | CN-386 | 2.58 | 2.52 | 5.0 | 5.0 | 3.68 | 3.68 |
| Photochromics | CR-173 | | 0.339 | 0.95 | 0.95 | 1.1 | 1.1 |
| | CR-49 | 0.347 | 0.281 | | | | |
| | Corning Grey | 0.288 | | | | | |
| | Variacrol Yellow | 0.0277 | 0.027 | | | | |
| | Plum Red | 0.097 | 0.095 | | | | |
| Remarks | Coat Curing Dose | 1 @ | 1 @ | 2 @ | 1 @ | 1 @ | 1 @ |
| | (Casting Surface) # | full power | full | ½ power | ¾ power | ¾ power | ¾ power |
| | Flashes - Power | | power | | | | |
| | Coating | OK, | Dry | OK | OK | OK | OK |
| | Appearance | Tacky | | | | | |
| | Unactivated | 86.8 | 86.3 | 87.7 | 89.7 | 89.7 | 90.2 |
| | Transmittance (%) | | | | | | |
| | Activated | 13.9 | 13.4 | 13.9 | 20.9 | 19.6 | 22.3 |
| | Transmittance (%) | | | | | | |
| | Coat Thickness | | | 160 | 55 | 65 | 40 |
| | (μm) | | | | | | |

TABLE 8

| | Composition by Weight % | | | | | | |
|---|---|---|---|---|---|---|---|
| | Formulation ID # | | | | | | |
| | Component | 5104-6A | 5104-6B | 5124-8A | 5124-8B | 5144-3 | 5144-4 |
| Monomers | SR-399 | 61.37 | 61.37 | 59.47 | 59.47 | 31.75 | 30.16 |
| | SR-540 | 24.69 | 24.69 | 6.56 | 6.56 | | |
| | SR-351 | 9.8 | 9.8 | | | | |
| | HiRi II | | | 29.47 | 29.47 | 66.78 | 64.41 |
| Photoinitiators | Irgacure 819 | 0.173 | 0.173 | 0.093 | 0.093 | 0.23 | 0.20 |
| Coinitiator | CN-386 | 3.36 | 3.36 | 4.05 | 4.05 | | 4.02 |
| Photochromics | CR-173 | 0.06 | 0.06 | 0.36 | 0.36 | 1.248 | 1.212 |
| Remarks | Coat Curing Dose | 2 @ | 2 @ | 1 @ | 1 @ | 2 @ | 2 @ |
| | (Casting Surface) | ¾ power | ¾ power | full | full | ¾ power | ¾ power |
| | # Flashes - Power | | | power | power | | |
| | | | | per layer | | | |
| | Coating | OK | OK | OK | OK | OK | OK |
| | Appearance | | | | | | |
| | Unactivated | 89.8 | 90.3 | 88.7 | 90.4 | 87.7 | 89.0 |
| | Transmittance (%) | | | | | | |
| | Activated | 19.0 | 23.8 | 12.9 | 24.9 | 16.0 | 18.8 |
| | Transmittance (%) | | | | | | |
| | Coat Thickness | 100 | 65 | 200 | 100 | 70 | 55 |
| | (μm) | | | (100 per | | | |
| | | | | layer) | | | |
| | Other | | | 2 layers | 1 layer | Yellow | Clear |
| | | | | applied | applied | unactivated | unactivated |
| | | | | | | color | color |

TABLE 9

| | Composition by Weight % | | | | | | |
|---|---|---|---|---|---|---|---|
| | Formulation ID # | | | | | | |
| | Component | 5264-1 | 665-1 | 684-16 | 684-11 | 644-2 | 6144-1 |
| Monomers | SR-399 | 58.5 | 30.0 | 31.8 | 39.1 | 55.6 | |
| | SR-540 | 3.32 | | | | 16.75 | |
| | SR-368 | | 16.0 | 8.7 | 7.35 | 24.08 | |
| | SR-344 | | | 19.5 | 7.2 | | 38.7 |
| | SR-351 | | | | 11.1 | | |
| | HiRi II | 33.03 | 48.5 | 34.27 | 29.88 | | |
| Photoinitiators | Irgacure 819 | 0.116 | 0.20 | 0.169 | 0.124 | 0.10 | 0.312 |
| Coinitiators | CN-386 | 4.24 | 4.0 | 3.21 | 4.0 | 2.99 | 4.89 |
| Photochromics | CR-173 | 0.55 | 1.3 | 2.25 | 1.25 | 0.493 | 2.2 |
| | Berry Red | 0.05 | | | | | |
| | Grey 306 | 0.025 | | | | | |
| Remarks | Coat Curing Dose | 1 @ ¾ | 2 @ ½ | 4 @ ¾ | 3 @ ¾ | 2 @ ½ | 3 @ ¾ |
| | (Casting Surface) # | power | power | power | power | power | power |
| | Flashes - Power | | | | | | |
| | Coat Curing Dose | | 1 @ ½ | | | 1 @ ½ | 1 @ ¾ |
| | (Noncasting | | power | | | power | power |
| | Surface) # Flashes - | | | | | | |
| | Power | | | | | | |
| | Coating | OK | OK | OK | OK | OK | OK |
| | Appearance | | | | | | |
| | Unactivated | 88.3 | 87.5 | 88.0 | 87.2 | 89.5 | 88.8 |
| | Transmittance (%) | | | | | | |
| | Activated | 16.7 | 12.5 | 13.8 | 13.5 | 15.9 | 19.2 |
| | Transmittance (%) | | | | | | |
| | Coat Thickness | 130 | 120 | 55 | 120 | 160 | 55 |
| | (μm) | | | | | | |

TABLE 10

| | Composition by Weight % | | | | | | |
|---|---|---|---|---|---|---|---|
| | Formulation ID # | | | | | | |
| | Component | 6144-2 | 6144-4 | 6174-2 | 6174-3 | 6184-8 | 6174-8 |
| Monomers | SR-399 | 58.56 | 40.0 | 48.0 | 46.3 | 37.05 | 23.96 |
| | SR-368 | | 15.0 | | | | |
| | SR-344 | 32.52 | 20.0 | 8.6 | 3.8 | 24.26 | |
| | SR-601 | | | 15.0 | 43.7 | | |
| | SR-306 | | | 22.61 | | | |
| | CN-964 | | | | | | 17.0 |
| | CN-965 | | | | | 33.38 | |
| | HiRi II | | 19.0 | | | | 53.1 |
| Photoinitiators | Irgacure 819 | 0.173 | 0.203 | 0.173 | 0.2 | 0.2 | 0.2 |
| Coinitiators | CN-386 | 6.8 | 3.99 | 4.17 | 4.0 | 3.42 | 4.0 |
| Photochromics | CR-173 | 2.2 | 1.81 | 1.435 | 2.0 | 1.7 | 1.7 |
| Remarks | Coat Curing Dose | 3 @ ¾ | 2 @ ¾ | 2 @ ¾ | 2 @ ¾ | 3 @ ¾ | 4 @ ¾ |
| | (Casting Surface) # | power | power | power | power | power | power |
| | Flashes - Power | | | | | | |
| | Coat Curing Dose | 1 @ ¾ | 1 @ ¾ | 1 @ ¾ | 1 @ ¾ | | |
| | (Noncasting | power | power | power | power | | |
| | Surface) # Flashes - | | | | | | |
| | Power | | | | | | |
| | Coating | OK | OK | OK | OK | OK | OK |
| | Appearance | | | | | | |
| | Unactivated | 89.1 | 87.8 | 89.5 | 85.7 | 88.2 | 86.9 |
| | Transmittance (%) | | | | | | |
| | Activated | 21.6 | 13.6 | 16.2 | 13.7 | 12.7 | 12.0 |
| | Transmittance (%) | | | | | | |
| | Coat Thickness | 65 | <100 | 80 | 155 | 110 | 100 |
| | (μm) | | | | | | |

TABLE 11

| | Composition by Weight % | | | | | | |
|---|---|---|---|---|---|---|---|
| | Formulation ID # | | | | | | |
| | Component | 6184-4 | 6224-9 | 6244-9 | 6244-11 | PCC-8 | 454-D |
| Monomers | SR-399 | 30.26 | 65.03 | 40.4 | 40.93 | 33.13 | 58.8 |
| | SR-540 | | | | | 6.32 | 32.75 |
| | SR-368 | | | 13.1 | 9.33 | | |
| | SR-344 | | 16.33 | 10.1 | 12.91 | | |
| | SR-454 | | | | | 25.52 | |
| | SR-268 | | 13.0 | 6.6 | 5.3 | | |
| | SR-306 | 34.07 | | | | | |
| | CN-104 | | | | | 31.59 | |
| | CN-262 | 30.26 | | | | | |
| | HiRi II | | | 24.3 | 21.95 | | |
| Photoinitiators | Irgacure 819 | 0.2 | 0.16 | 0.231 | 0.175 | 0.414 | 0.143 |
| Coinitiators | CN-384 | | 0.8 | | | | |
| | CN-386 | 4.0 | 3.2 | 3.73 | 4.85 | | |
| Photochromics | CR-173 | 1.21 | 1.49 | 1.54 | 1.55 | 0.41 | |
| | Variacrol Blue D | | | | | | 0.878 |
| Additives | HMDSO | | | | | | 5.0 |
| | Tinuvin 770 | | | | | 2.49 | |
| | Tinuvin 292 | | | | 3.0 | | |
| Remarks | Coat Curing Dose | 2 @ | 3 @ | 2 @ | 2 @ | 1 @ | 1 @ |
| | (Casting Surface) # | ¾ power | ½ power | ½ power | ½ power | full power | full |
| | Flashes - Power | | | | | | power |
| | Coating | OK | OK | OK | OK | OK | Hazy |
| | Appearance | | | | | | |
| | Unactivated | 88.9 | 87.8 | 87.2 | 88.3 | 88.3 | 85.3 |
| | Transmittance (%) | | | | | | |
| | Activated | 16.4 | 16.8 | 12.3 | 12.0 | 59 | 41 |
| | Transmittance (%) | | | | | | |
| | Coat Thickness | 100 | 55 | 105 | 90 | | |
| | (μm) | | | | | | |
| | Other | | | | | Weak | |
| | | | | | | activated | |
| | | | | | | transmittance | |

TABLE 12

| | Composition by Weight % | | | | | | |
|---|---|---|---|---|---|---|---|
| | Formulation ID # | | | | | | |
| | Component | 434-PC1 | 434-PC2 | 434-PC3 | 434-PC4 | PC-454 | PC-464 |
| Monomers | SR-399 | | | | | 65.3 | 67.0 |
| | SR-540 | 0.923 | 1.01 | | | 24.3 | 24.94 |
| | SR-494 | | | | | 3.54 | |
| | SR-344 | 67.2 | 71.3 | | | | |
| | SR-351 | 20.67 | 22.62 | | | | |
| | SR-256 | 9.14 | 2.63 | | | 6.27 | |
| | CN-131 | | | 24.2 | 23.0 | | |
| | CN-980 | | | 74.22 | 70.51 | | |
| | PMATMS | | | | | | 6.93 |
| Photoinitiators | Irgacure 819 | 1.03 | 0.307 | 0.423 | 0.4 | 0.142 | 0.152 |
| Coinitiators | CN-384 | 0.44 | 0.48 | | 2.5 | | |
| | CN-386 | 0.44 | 0.48 | | 2.5 | | |
| Photochromics | CR-173 | 0.168 | 1.21 | 1.15 | 1.09 | | |
| | CR-49 | | | | | | 0.991 |
| | Palatinate Purple | | | | | 0.14 | |
| | Sea Green | | | | | 0.19 | |
| | Plum Red | | | | | 0.19 | |
| Remarks | Coat Curing Dose | 1 @ | 6 @ | 12 @ | 12 @ | 1 @ | 1 @ |
| | (Casting Surface) # | full power | full power | full | full | full | full power |
| | Flashes - Power | | | power | power | power | |
| | Coating | | | OK | OK | OK | OK |
| | Appearance | | | | | | |
| | Unactivated | Dead | Dead | 85.6 | 85 | 87.3 | 86.7 |
| | Transmittance (%) | | | | | | |
| | Activated | No | No | 19.9 | 13.6 | 42.6 | 11.0 |
| | Transmittance (%) | activation | activation | | | | |
| | Coat Thickness | | | | | | |
| | (μm) | | | | | | |
| | Other | | | | | | |

TABLE 13

| | Composition by Weight % | | | | |
|---|---|---|---|---|---|
| | Formulation ID # | | | | |
| | Component | 484-7A | 484-7B | 484-4 | 734-5 |
| Monomers | SR-399 | 49.6 | 49.6 | 59.57 | 7.5 |
| | SR-540 | 44.12 | 44.12 | 32.57 | |
| | SR-489 | | | 6.67 | |
| | GMPTMS | 5.0 | 5.0 | | |
| | HiRi II | | | | 75.67 |
| Photoinitiators | Irgacure 819 | 0.249 | 0.249 | 0.15 | 0.5 |
| | Darocur 1173 | | | | |
| Coinitiators | CN-384 | | | | 7.0 |
| Photochromics | Corning Grey | 1.04 | 1.04 | | |
| | Corning Brown | | | 1.02 | |
| Remarks | Coat Curing Dose | 1 @ | 2 @ | 2 @ | 3 @ |
| | (Casting Surface) | full power | full power | ½ power | ½ power |
| | # Flashes - Power | | | | |
| | Coat Curing Dose | | | | 2 @ |
| | (Noncasting Surface) | | | | ½ power |
| | # Flashes - Power | | | | |
| | Coating Appearance | OK | OK | OK | Still liquid |
| | Unactivated | 86.4 | 86.4 | 85.7 | 85 |
| | Transmittance (%) | | | | |
| | Activated Transmittance | 15.7 | 15.7 | 13.3 | 16.3 |
| | (%) | | | | |
| | Coat Thickness (μm) | | | | 60 |
| | Other | Clear | Yellow | | Hazy, |
| | | | | | scratchable |
| | | | | | w/fingernail |

TABLE 14

| | Composition by Weight % | | | | | | |
|---|---|---|---|---|---|---|---|
| | Formulation ID # | | | | | | |
| | Component | 894-1 | 894-2 | 894-3 | 894-4 | 894-5 | 894-6 |
| Monomers | SR-399 | 52.95 | 35.3 | 37.4 | 49.26 | 44.41 | 39 |
| | SR-540 | 37.86 | 52.86 | 47.8 | 37.0 | 42.12 | 48.25 |
| Photoinitiators | Irgacure 819 | 0.12 | 0.204 | 0.188 | 0.187 | 0.246 | 0.261 |
| | Darocur 1173 | 0.074 | 0.05 | 0.025 | 0.0125 | 0.0136 | 0.012 |
| Coinitiator | CN-384 | 1.15 | 0.76 | 0.38 | 0.19 | 0.21 | 0.19 |
| | CN-386 | 7.25 | 9.73 | 13.0 | 12.4 | 11.85 | 9.48 |
| Photochromics | CR-173 | | 0.7 | 0.7 | 0.7 | 0.922 | 0.986 |
| | Variacrol Yellow | 0.075 | 0.05 | 0.025 | 0.0125 | 0.0187 | 0.015 |
| | Berry Red | 0.20 | 0.133 | 0.067 | 0.033 | 0.05 | 0.04 |
| | Palatinate Purple | 0.0325 | 0.022 | 0.0108 | 0.0054 | 0.0081 | 0.0065 |
| | Corn Yellow | 0.075 | 0.05 | 0.025 | 0.0125 | 0.0187 | 0.015 |
| | Sea Green | 0.1 | 0.067 | 0.033 | 0.0165 | 0.025 | 0.02 |
| | Plum Red | 0.12 | 0.08 | 0.04 | 0.02 | 0.03 | 0.1 |
| Remarks | Coat Curing Dose | 4 @ | 4 @ | 4 @ | 4 @ | 4 @ | 4 @ |
| | (Casting Surface) # | ½ power | ½ power | ½ power | ½ power | ½ power | ½ power |
| | Flashes - Power | | | | | | |
| | Coat Curing Dose | 2 @ | 2 @ | 2 @ | 2 @ | 2 @ | 2 @ |
| | (Noncasting | 1/2 power | ½ power | ½ power | ½ power | ½ power | ½ power |
| | Surface) # Flashes - | | | | | | |
| | Power | | | | | | |
| | Coating | Good | Good | Good | Good | Good | Good |
| | Appearance | | | | | | |
| | Unactivated | 87.6 | 87.2 | 88.5 | 89.1 | 88.7 | 87.2 |
| | Transmittance (%) | | | | | | |
| | Activated | 24.5 | 15.6 | 17.1 | 18.5 | 17.1 | 16.1 |
| | Transmittance (%) | | | | | | |
| | Coat Thickness | 110 | 125 | 110 | 100 | 95 | 110 |
| | (μm) | | | | | | |

In another embodiment, a series of coating layers may be formed on a substrate that impart scratch resistance (e.g., a hardcoat layer), photochromic properties, and antireflective properties. In one embodiment, a hardcoat layer, a photochromic layer and an antireflective layer may be formed on a substrate. A stack of these three types of coating layers may be placed on a substrate (e.g., an eyeglass lens) using either an in-mold process or an out-of-mold process.

In an in-mold process, a plurality of coating layers may be formed on the casting surface of a mold member. In one embodiment, antireflective coating layer(s) are formed on the casting surface of a mold member. A hardcoat layer is then formed on the antireflective coating layer. Finally, a photochromic layer is formed on the hardcoat layer. Each layer is at least partially cured after it is applied to the substrate.

In an out of mold process, the coating layers are placed directly onto the substrate. In one embodiment, a photochromic layer is formed on the outer surface of the lens. On top of the photochromic layer, a hardcoat layer may be formed. Finally, one or more antireflective coating layers may be formed on the hardcoat layer.

Using either of these processes, coated lenses may be formed on a substrate.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1-52. (canceled)

53. A method of forming a lens, comprising:
applying one or more antireflective coating compositions to a casting face of a mold member, at least one of the antireflective coating compositions comprising nanomaterials, one or more initiators, and one or more monomers;
assembling a mold assembly, the mold assembly comprising the coated mold member, wherein the mold assembly comprises a mold cavity at least partially defined by the coated mold member;
placing a liquid lens forming composition in the mold cavity, the liquid lens forming composition comprising one or more monomers and one or more initiators;
curing the lens forming composition to form a lens; and
demolding the formed lens from the mold assembly, wherein the formed lens comprises one or more antireflective coating layers on an outer surface of the lens, and wherein each of the antireflective coating layers has a thickness of less than about 500 nm, and wherein an outer antireflective coating layer has an index of refraction that is less than the index of refraction of the formed lens.

54. The method of claim 53, further comprising at least partially curing one or more of the antireflective coating compositions to form one or more antireflective coating layers on the casting face of the mold member.

55-59. (canceled)

60. The method of claim 53, wherein the nanomaterials comprise one or more oxides and/or nitrides of elements from Columns 2-15 of the Periodic Table.

61. The method of claim 53, wherein the nanomaterials comprise one or more oxides and/or nitrides of silicon, cerium, titanium and/or aluminum.

62. The method of claim 53, wherein the nanomaterials comprise cerium oxide.

63. The method of claim 53, wherein the nanomaterials comprise silica.

64. The method of claim 53, wherein the nanomaterials comprise alumina.

65. The method of claim 53, wherein the nanomaterials comprise titania.

66. The method of claim 53, wherein the one or more monomers in one or more antireflective coating compositions comprise monoacrylates, diacrylates, multiacrylates or mixtures thereof.

67-74. (canceled)

75. The method of claim 53, wherein the one or more initiators in one or more antireflective coating compositions comprise acylphosphine oxides, bis-acylphosphine oxides or mixtures thereof.

76. The method of claim 53, wherein one or more antireflective coating compositions comprises a mixture of one or more α-hydroxy ketones initiators and one or more phosphine oxide initiators.

77. (canceled)

78. The method of claim 53, wherein one or more antireflective coating compositions further comprise one or more co-initiators.

79-82. (canceled)

83. The method of claim 53, wherein the one or more monomers in the lens forming composition comprise aromatic containing polyethylenic polyether functional monomers.

84-89. (canceled)

90. The method of claim 53, wherein the lens forming composition further comprises one or more co-initiators.

91-92. (canceled)

93. The method of claim 53, wherein the lens forming composition further comprises one or more activating light absorbing compounds.

94. The method of claim 53, wherein the lens forming composition further comprises one or more photochromic compounds.

95-106. (canceled)

107. The method of claim 53, wherein the formed lens is an eyeglass lens.

108-121. (canceled)

122. A method of forming an antireflective coating on a lens, comprising:
applying one or more antireflective coating compositions to a lens, at least one of the antireflective coating compositions comprising nanomaterials, one or more initiators, and one or more monomers;
at least partially curing the antireflective coating composition to form one or more antireflective coating layers on the lens, wherein each of the antireflective coating layers has a thickness of less than about 500 nm, and wherein an outer antireflective coating layer has an index of refraction that is less than the index of refraction of the formed lens.

123-361. (canceled)
